(19) United States
(12) Patent Application Publication
(10) Pub. No.: US 2008/0012987 A1
(43) Pub. Date: Jan. 17, 2008

(54) Image data providing apparatus, image display apparatus, image display system, method for controlling image data providing apparatus, method for controlling image display apparatus, control program, and recording medium

(75) Inventors: Masafumi Hirata, Tokyo (JP); Soichi Nitta, Narashino-Shi (JP); Tatsuo Sudo, Chiba-Shi (JP); Azusa Umemoto, Kizugawa-Shi (JP); Aya Enatsu, Chiba-Shi (JP); Masafumi Takahashi, Sakura-shi (JP); Takuya Kinoshita, Chiba-Shi (JP); Kiyotaka Kashito, Kobe-Shi (JP); Katsuo Doi, Sakurai-shi (JP); Tetsuya Matsuyama, Ichikawa-Shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/822,023

(22) Filed: Jun. 29, 2007

Related U.S. Application Data
(60) Provisional application No. 60/833,254, filed on Jul. 26, 2006.

(30) Foreign Application Priority Data
Jun. 30, 2006 (JP) 182724/2006
Jun. 26, 2007 (JP) 168098/2007

(51) Int. Cl. H04N 5/445

(52) U.S. Cl. 348/563; 348/E05.099

(57) ABSTRACT

An album managing server of the present invention includes: a display-target ID obtaining section to obtain, from a display data request message to request display target data that is to be displayed on a television, a display-target ID of the display target data that is requested; a status determining section to determine a status of the display target data that is identified by the display-target ID; a status information extracting section to generate status information for displaying, on the television, the status of the display target data thus determined; and a display control information generating section to generate display control information to define a position, on the television, of the status information. Accordingly, the image display apparatus is supplied with status information on display target data to be displayed on the image display apparatus, whereby the convenience of users improves.

This nonprovisional application claims the benefit under 35 U.S.C. §119(e) of U.S. Provisional Application No. 60/833,254 filed on Jul. 26, 2006, and claims priority under 35 U.S.C. §119(a) of Patent Applications No. 182724/2006 filed in Japan on Jun. 30, 2006, and No. ******/200* filed in Japan on ______, the entire contents of which are hereby incorporated by reference.

### FIELD OF THE INVENTION

The present invention relates to an image display apparatus to display an image, and an image data providing apparatus to provide an image to be displayed on the image display apparatus.

### BACKGROUND OF THE INVENTION

As digital cameras have become widespread, handling pictures in the form of image data has become popular. This has made a new way to enjoy pictures common, in addition to a conventional way to enjoy pictures by seeing developed pictures. Specifically, pictures are recorded in the form of image data, and the image data is displayed on an image display apparatus to be enjoyed.

Further, use of networks such as the Internet enables image display apparatuses to display pictures stored in server apparatuses (image data generating apparatus) located in remote areas. This, for example, allows a picture uploaded on a server apparatus to be displayed on plural image display apparatuses so that plural users can enjoy the same picture.

The following describes how a picture stored in a server apparatus in a remote area is displayed on an image display apparatus that is a client. The image display apparatus sends a request for the picture to the server apparatus via a network. In response to the request, the server apparatus provides the picture to the image display apparatus, and the image display apparatus displays the picture thus supplied.

If this display target data (pictures in the present case) requested by the image display apparatus does not exist on the server apparatus, the server apparatus displays a message (404 NOT FOUND) indicating that this requested display target data does not exist. This is the same in a conventional case of requesting for a web page stored in a server apparatus connected to the Internet.

For example Publicly-known Document 1 (Japanese Patent Application Publication No. 2006-53765 (Published on Feb. 23, 2006)) discloses a network MFP (multi functional peripheral) that transmits an error message (“404 (Not Found) of HTTP) to a client terminal when a requested web page is not stored in the network MFP.

This conventional configuration, however, causes the following problems.

Specifically, the error message (404 NOT FOUND) transmitted from the network MFP of Publicly-known Document 1 to the client terminal only notifies the client terminal that the requested web page (display target data) is not obtainable because it does not exist in the MFP. In other words, when the requested web page does not exist, no status information on a status of the display target data that does not exist is provided to the client terminal. Specifically, the client terminal is not notified why the web page does not exist, from when the web page is in this state, until when the web page stays in the state, or the like. Users of the client terminal therefore are not informed why this desired web page does not exist, and thus are unable to take appropriate actions to obtain the desired web page. This has caused a problem that the convenience of users deteriorates.

This problem is not particular to the case of requesting the server apparatuses for pictures or WebPages. The same problem may arise in a case of requesting for any data that is display target data and can be stored in the server apparatus, which data includes any data handled in the form of images or data of control information for displaying the images, even if the data is in the form of a text, a drawing, or a graph. The same problem may also arise in a case of requesting for an image set (file/album) of gathered images (pictures). Further, the problem is not particular to the case in which the error message (404 NOT FOUND) is displayed. The same problem would also arise in any server apparatuses that only provide clients with error codes other than “404 NOT FOUND”.

### SUMMARY OF THE INVENTION

The present invention has as an object to realize an image data providing apparatus, an image display apparatus, an image display system, a method for controlling the image data providing apparatus, a method for controlling the image display apparatus, a control program, and a recording medium, all of which improve the convenience of users of the image display apparatus by providing the image display apparatus with status information on display target data to be displayed on the image display apparatus.

To attain the above object, an image data providing apparatus (album managing server 1) in accordance with the present invention includes: a display target ID obtaining section 21 (identification information obtaining means) for obtaining, from a display-target request message, identification information on display target data requested, the display-target request message requesting the display target data that is to be displayed on an image display apparatus; a status determining section 30 (status determining means) for determining a status of the display target data that is stored in a display-target information storage section and identified by the identification information obtained by the display target ID obtaining section 21; a status information extracting section 42 (status information generating means) for generating status information for displaying, on the image display apparatus, the status of the display target data, which status is determined by the status determining section 30; and a display control information generating section 44 (display control information generating means) for generating display control information to define a position, on the image display apparatus, of the status information generated by the status information extracting section 42.

To solve the above problems, an image data providing apparatus in accordance with the present invention includes: a first step of obtaining, from a display-target request message, identification information on display target data requested, the display-target request message requesting the display target data that is to be displayed on an image display apparatus; a second step of determining a status of the display target data identified by the identification information obtained in the first step; a third step of generating status information for displaying, on the image display apparatus, the status of the display target data, which status is determined in the second step; and a fourth step of generating display control information to define a position, on the image display apparatus, of the status information generated in the third step.

With this configuration and method, the display target ID obtaining section 21 obtains the identification information contained in the display-target request message received by the image data providing apparatus, whereby the display target data to be displayed on the image display apparatus is identified. The status determining section 30 determines a status of the display target data thus identified, which display target data is stored in the display-target information storage section.

The status information extracting section 42 generates, responsive to a determination result supplied by the status determining section 30, the status information for displaying, on the image display apparatus, the status of the display target data. The status information generated by the status information extracting section 42 indicates the status of the display target data thus identified.

Then, the display control information generating section 44 generates the display control information to define the position of the status information, generated by the status information extracting section 42, on the image display apparatus.

Consequently, the status information is generated to display, on the image display apparatus, the status of the display target data that is to be displayed on the image display apparatus, and the display control information is generated to define the position of the status information on the image display apparatus.

When the status information thus generated and the display control information thus generated are processed in the image display apparatus, the status information is displayed on the image display apparatus in accordance with the display control information. The status information indicates the status of the display target data that is to be displayed on the image display apparatus. Accordingly, the image display apparatus displays the status of the display target data, to be displayed on the image display apparatus, so as to allow the users of the image display apparatus to see the status of the display target data.

This allows the users to know the status of the display target data to be displayed on the image display apparatus, so that the convenience of the users of the image display apparatus improves.

To attain the above object, an image display apparatus according to the present invention includes: a message generating section 75 (message generating means) for generating a display-target request message that requests display target data and contains identification information on the display target data that is to be displayed on the image display apparatus; a transmitting section to transmit the display-target request message to an image data providing apparatus; a receiving section to receive, from the image data providing apparatus in response to the display-target request message,: status information for displaying, on the image display apparatus, a status of the display target data; and display control information to define a position, on the image display apparatus, of the status information; a display control section 64 (display control means) for controlling a display section so that the display section displays the status information in accordance with the display control information.

To solve the above problems, a method for controlling an image display apparatus in accordance with the present invention includes: a first step of generating a display-target request message that requests display target data and contains identification information on the display target data that is to be displayed on the image display apparatus; a second step of transmitting, to an image data providing apparatus, the display-target request message generated in the first step; a third step of receiving, from the image data providing apparatus in response to the display-target request message,: status information for displaying, on the image display apparatus, a status of the display target data; and display control information to define a position, on the image display apparatus, of the status information; and a fourth step of controlling a display section so that the display section displays the status information in accordance with the display control information.

With this configuration and method, the image display apparatus generates the display-target request message to make a request to the image data providing apparatus for display target data to be displayed on the image display apparatus. The image display apparatus transmits the display-target request message to the image data providing apparatus via the transmitting section.

Then, the receiving section receives, in response to the display-target request message, the status information and the display control information that are generated in the image data providing apparatus.

The display control section 64 controls the display section so that the status information thus received is displayed on the display section in accordance with the display control information.

Accordingly, the image display apparatus displays the status of the display target data that the image display apparatus has requested, whereby the status is shown to the users of the image display apparatus.

This allows the user to know the status of the display target data that the user has requested via the image display apparatus, so that the convenience of the users of the image display apparatus improves.

To attain the above object, an image display apparatus according to the present invention includes the image data providing apparatus and the image display apparatus. The image data providing apparatus transmits status information and display control information to the image display apparatus. The status information is contained in a display-target request message received from the image display apparatus. The status information is utilized to identify, basing on identification information on display target data, the display target data requested, and to display, on the image display apparatus, a status of the display target data thus identified. The display control information is utilized to define a position, on the image display apparatus, of the status information. The image display apparatus displays, in accordance with the display control information, the status information obtained from the image data providing apparatus.

With this configuration, in response to the request, from the image display apparatus to the image data providing apparatus, for the display target data to be displayed on the image display apparatus, the image data providing apparatus provides the image display apparatus with the status information, which is to display the status of the display target data on the image display apparatus, and the display control information to define the position of the status information. The status information indicates the status of the display target data requested.

The image display apparatus is then able to display the status information in accordance with the display control information, which status information indicates the status of the display target data that the image display apparatus requests.

This allows the image display apparatus to display, for the users of the image display apparatus to see, the status of the display target data that the image display apparatus requests. The users can therefore know the status of the display target data requested via the image display apparatus. This makes it possible to improve the convenience of the users of the image display apparatus.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing a configuration of a main part of an album managing server in accordance with an embodiment of the present invention.

FIG. 2 is a block diagram showing a schematic configuration of a network album system in accordance with an embodiment of the present invention.

FIG. 3 is a sequence diagram showing a flow of processes to be performed by respective apparatuses in the network album system in accordance with an embodiment of the present invention.

FIG. 4(a) shows an exemplary album history screen to be displayed on the television.

FIG. 4(b) shows an exemplary album ID input screen to be displayed on the television.

FIG. 4(c) shows an exemplary album-picture display screen to be displayed on the television.

FIG. 5 is a figure schematically showing a data structure of a display data request message to be received from a television.

FIG. 6 is a figure showing exemplary album information stored in an album information storage section of the album managing server.

FIG. 7 is a figure showing an exemplary pattern data table stored in a pattern data storage section of the album managing server.

FIG. 8 is a figure showing an exemplary status table in which status information stored in the status information storage section of the album managing server is managed.

FIG. 9 is a figure showing an example of a picture table for each album stored in a display target data storage section of the album managing server.

FIG. 10 is a figure schematically showing an example of a pattern data 170 (left) identified by the pattern data specifying section, and an example of display control information 180 (right) that the display control information generating section generates by filling the contents into the pattern data.

FIG. 11 is a figure showing a concrete example of a layout definition information 181 in which contents have been filled.

FIG. 12 is a flowchart showing a flow of display data providing process performed in the album managing server.

FIG. 13 is a flowchart showing a flow of display data providing process performed in the album managing server.

FIG. 14 is a figure showing exemplary ways in which information on a status of an album is displayed on a television that receives, from the album managing server, display data containing status information.

FIG. 15 is a block diagram showing a configuration of a main part of a television in accordance with an embodiment of the present invention.

FIG. 16 is a figure showing an example of an album history table stored in an album ID storage section of the television.

FIG. 17 is a figure showing an example of a status information table stored in a status information storage section of the television.

FIG. 18 is a figure showing an example of an attribute information table stored in an attribute information storage section of the television.

FIG. 19 is a flowchart showing a flow of a flow of processes in requesting and displaying display data, which is performed in the television.

FIG. 20 is a flowchart showing a flow of a flow of processes in requesting and displaying display data, which is performed in the television.

FIG. 21 is a figure showing a configuration of a main part of a television including a display data storage section constituted of a nonvolatile memory device.

FIG. 22 is a figure showing an example of a display data table for managing display data that is stored in a display data storage section and is obtained from album managing server.

FIG. 23 is a flowchart showing a flow of a flow of processes in requesting and displaying display data, which is performed in the television shown in FIG. 21.

FIG. 24 is a flowchart showing a flow of processes in requesting and displaying display data, which is performed in the television shown in FIG. 21.

FIG. 25-is a figure schematically showing picture display data that constitutes display data in accordance with the present embodiment.

FIG. 26 is a figure showing a concrete example of the layout definition information 164 shown in FIG. 25.

FIG. 27 is a figure showing an example of picture information in a picture table, which picture information is to be stored in the display target data storage section.

FIG. 28 is a figure showing an example of a status table, stored in the status information storage section, to manage the status information.

FIG. 29 is a flowchart showing a flow of processes in providing display data, which is performed in an album managing server of the present embodiment.

FIG. 30 is a flowchart showing a flow of processes in requesting and displaying display data, which is performed in a television of the present embodiment.

FIG. 31 is a figure showing a concrete example of display control information contained in an error dialog display data.

FIG. 32 is a figure showing a concrete example of an error dialog display screen displayed on a display section by a display data processing section of the television in accordance with the display control information shown in FIG. 31.

FIG. 33 is a figure showing a sample of an error dialog display screen containing a GUI screen with which a user selects to where the user desires to make a transition next.

FIG. 34 shows an exemplary Internet browser to be displayed on the television, and an exemplary source of link information displayed on the browser.

FIG. 35 shows an exemplary album history table stored in the album ID storage section of the television, in accordance with another embodiment of the present invention.

FIG. 36 is a block diagram showing a configuration of the main part of the television, in accordance with another embodiment of the present invention.

FIG. 37 schematically shows a configuration of data of the display data request message generated by the display data request processing section of the television, in accordance with another embodiment of the present invention.

FIG. 38 is a block diagram showing a configuration of a main part of the album managing server, in accordance with another embodiment of the present invention.

FIG. 39(a) shows an exemplary album history screen in an event that the display data re-obtained by the television is displayed on the television.

FIG. 39(b) shows other examples of operation guidance displayed on the album history screen.

FIG. 40 is a flowchart showing a flow of processes in updating the album history by the album history managing section of the television, in accordance with another embodiment of the present invention.

FIG. 41 is a flowchart showing a flow of processes in updating the album history by the album history managing section of the television, in accordance with another embodiment of the present invention.

FIG. 42 shows a concrete example of operational function definition information that defines operation of the television to re-obtain the album history screen.

FIG. 43 shows a concrete example of operational function definition information that defines operation of the television to re-obtain the album history screen.

FIG. 44 is a block diagram showing a configuration of a main part of the television, in accordance with another embodiment of the present invention.

FIG. 45 is a flowchart showing a flow of processes performed by the television while the album ID input screen is displayed.

FIG. 46 shows an exemplary album ID input screen displayed on the television, in accordance with another embodiment of the present invention.

FIG. 47 shows another exemplary message displayed on the album ID input screen.

FIG. 48 shows another exemplary display control information that defines operations for discriminating the number of digits of the album ID input.

FIG. 49 is a flowchart showing another exemplary processes performed by the television while the album ID input screen is displayed.

FIG. 50 shows another exemplary message displayed on the album ID input screen.

FIG. 51 is a flowchart showing another exemplary processes performed by the television while the album ID input screen is displayed.

### DESCRIPTION OF THE EMBODIMENTS

### Embodiment 1

The following describes an embodiment of the present invention, with reference to figures. In the present embodiment, an exemplary case is discussed in which a network album system employs an image data providing apparatus of the present invention and an image display apparatus of the present invention. The network album system is to display pictures. In the network album system, an album (picture (image) or a set of pictures) is uploaded from a communication terminal apparatus, such as a PC, to an album managing server via a communications network, such as the Internet. An image display apparatus having a communication function obtains the pictures in the album stored on the album managing server, and displays the pictures. More specifically, the image data providing apparatus generates display data that indicates information to be displayed on the image display apparatus. The display data is generated for each screen of the image display apparatus. The image data providing apparatus provides the display data to the image display apparatus. The image display apparatus then becomes able to display the pictures in the album that the image display apparatus requests, in such a manner that the pictures are displayed in display size and layout intended by the image data providing apparatus.

In the present embodiment, a television connected to the Internet and having a communication function is discussed as the image display apparatus of the present invention. Further, the album managing server is discussed as the image data providing apparatus of the present invention, which album managing server manages the album (and pictures) uploaded from the communication terminal apparatuses, generates display data for the television to display the pictures in the album, and provides the display data to the television when requested by the television. The television displays the pictures in the album in accordance with the display data.

In the following description, the display data includes display control information and display target data. The display control information defines ways to display the display target data (e.g. album, picture, text data) on the image display apparatus. Concrete examples of the display data include: display data for displaying one picture; display data for displaying plural images in slideshow; and display data for displaying plural pictures, contained in the album, in thumbnail. Besides the display data for displaying albums and pictures, the following are also included in the examples of the display data: data for displaying GUI (graphical user interface) screens with which users operate the television; and data for displaying album browse history information on the albums browsed by the users in the past with the television. Any information to be displayed on the screen of the image display apparatus is called display data.

[Summary of Network Album System]

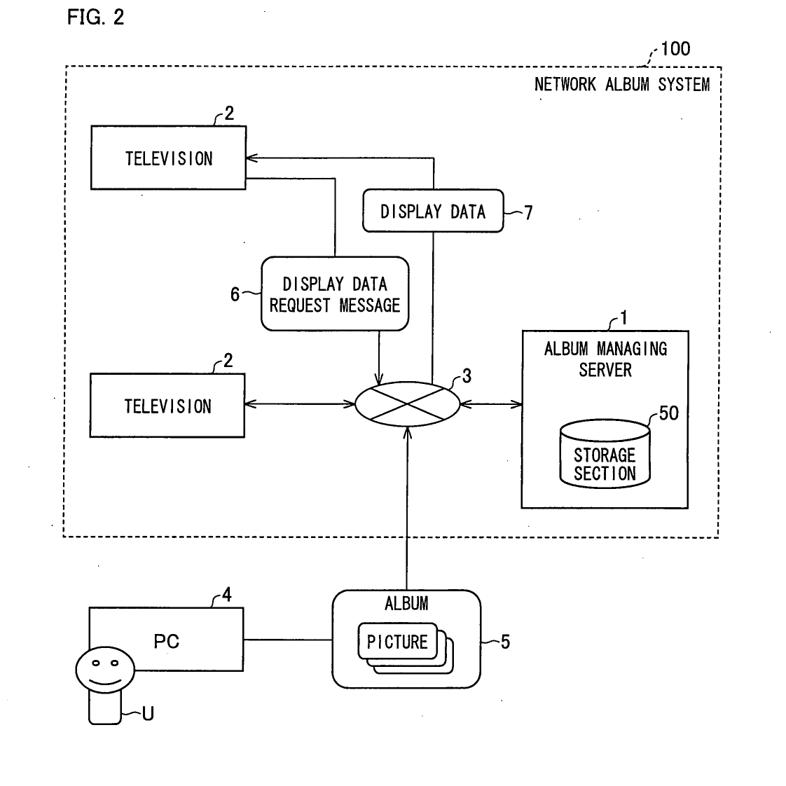

FIG. 2 is a block diagram showing a schematic configuration of a network album system (image display system) 100 in accordance with the present invention. As shown in FIG. 2, the network album system 100 includes an album managing server (image data providing apparatus) 1 and at least one television (image display apparatus) 2. These apparatuses are connected so as to be able to communicate with each other via an Internet 3.

The album managing server 1 manages an album including at least one picture (set of pictures). The album managing server 1 includes a storage section 50 in which the album is stored. An album 5 (or pictures) is transmitted to the album managing server 1 via the Internet 3. The album 5 is transmitted to the album managing server 1 by, for example, an owner U of the pictures with the use of a communication terminal apparatus, such as a computer (PC) 4. The album 5 is then stored in the storage section 50. The communication terminal apparatus is not limited to the PC 4 shown in FIG. 2, as long as it has a function to transmit the albums and pictures of the owner U to the album managing server 1. Besides the PCs, televisions with the function to communicate, mobile phones, and PDAs (personal digital assistant) may be employed as the communication terminal apparatuses.

Each of the albums stored in the storage section 50 is associated with an album ID (identification information) for each of the albums to be identified uniquely. When the album ID is designated, all the pictures (set of pictures) contained in the album are selected. Further, each of the pictures contained in the album is associated with a picture ID (identification information) for each of the picture to be identified uniquely. Accordingly, when the album ID and the picture ID are designated, one picture is selected.

In the present embodiment, when the album ID is designated, the whole set of pictures, which set is constituted of at least one picture, contained in the album is identified. Further, when the album ID and the picture ID are designated, one picture is identified.

The album managing server 1 receives a display data request message (display-target request message) 6 from the television 2. The album managing server 1 has a function to generate display data 7 and a function to provide the display data 7 to the television in response to the display data request message 6. The display data 7 indicates information to be displayed on the image display apparatus. As described above, in the present embodiment, the display data contains at least the display control information for the television, and the display-target (data of albums and pictures, data of components, i.e. operational buttons, of GUI screens). The display control information is one or plural scripts for generating image screens. The scripts define: how the pictures are to be displayed on the image display apparatus, e.g. which pictures are to be displayed at which area in what size; at which area the components, such as buttons, of the GUI screens are to be positioned; and which text data is to be displayed at which area and in what size. More specifically, the display data contains: layout definition information to define a display layout of the pictures (or components of GUI screens); and display target specifying information to identify the pictures (components) and to associate these identified pictures (components) with display positions defined by the layout definition information. Further, the display control information contains text data of basic information of the album, and text data of status information to indicate a status of the album to the users.

Receiving the display data, the television 2 becomes able to display one or plural pictures (components) contained in the display data, or text data such as status information, in accordance with the display control information. The scripts for generating display screens may be generated for each way of displaying. The display control information may contain a plurality of scripts for generating display screens. Exemplary scripts for generating display screens include: scripts for generating screens displayed in the form of a thumbnail view to display plural pictures in thumbnail; scripts for generating image display screens to display the pictures in the album one by one in slideshow; and scripts for generating GUI screens.

The scripts for generating display screens may be configured with text data written in XML (extensible Markup Language), for example. In this case, the layout definition information may be written in SVG (Scalable Vector Graphics), for example.

Respective scripts for generating display screens may contain detailed operation definition information to define operation of the television 2. The detailed operation definition information defines a detail of predetermined behavior that the television 2 should behave in a manner responsive to an event (e.g.: a predetermined period of time has passed; a predetermined operations starts/ends; display data is received; and a user makes an input via a key) occurred in the television 2.

Exemplary detailed operation definition information includes: status transition definition information that defines which display data (display screen) is displayed (requested and obtained) next when what event occurs; and operational function definition information that defines a predetermined process (e.g. management of the album history table, rotation of images, changes in colors, changes in text data, printing, reproduction of moving images and sound) of a photo application function, which processes are to be performed by the television 2 with respect to the display data being displayed. For example, if a process to be performed by the television 2 when a user makes an input via a key is defined, scripts are written on the operational function definition information in such a manner that a type of a key of a remote control to operate the television 2 is associated with a detail of a process to be performed.

The detailed operation definition information may be written in, for example, MTD (Message Template Definition) based on XML. The status definition information written in MTD is transmitted from the album managing server 1 to the television 2. The detailed operation definition information is either filled in the above-described respective scripts for generating display screens, which scripts are XML data, and then transmitted to the television 2, or transmitted to the television 2 as a script independent of those scripts for generating display screens.

The album managing server 1 receives, from the television 2, the display data request message 6 to request the display data. The display data request message 6 thus received contains a display screen requested by the television 2, and instruction information that designates an album (picture) to be displayed. In accordance with the instruction information contained in the display data request message 6, the album managing server 1 generates the display data 7 containing a display-target requested by the television 2, and provides the display data 7 to the television 2.

On the basis of the display data provided by the album managing server 1, the television 2 displays this display target data contained in the display data. The television displays the display target data in accordance with the display control information also contained in the display data. The television 2 transmits, to the album managing server 1, a message requesting the display data for displaying a screen desired to be displayed. In other words, the television 2 transmits the display data request message 6 to the album managing server 1. Thereafter, the television 2 receives the display data 7 from the album managing server 1. Then, the television 2 displays the display-target in accordance with the display control information contained in the display data 7.

Details of the display data request message 6 and the display data 7 will be described below.

As shown in FIG. 2, the storage section 50 to manage the albums may be included in the album managing server 1, or may be provided outside of the album managing server 1. In the case in which the storage section 50 is provided outside of the album managing server 1, the storage section 50 is provided in such a manner that it is possible to connect the album managing server 1 and the PC 4 to the storage section 50 via the Internet 3.

[Processes in Network Album System]

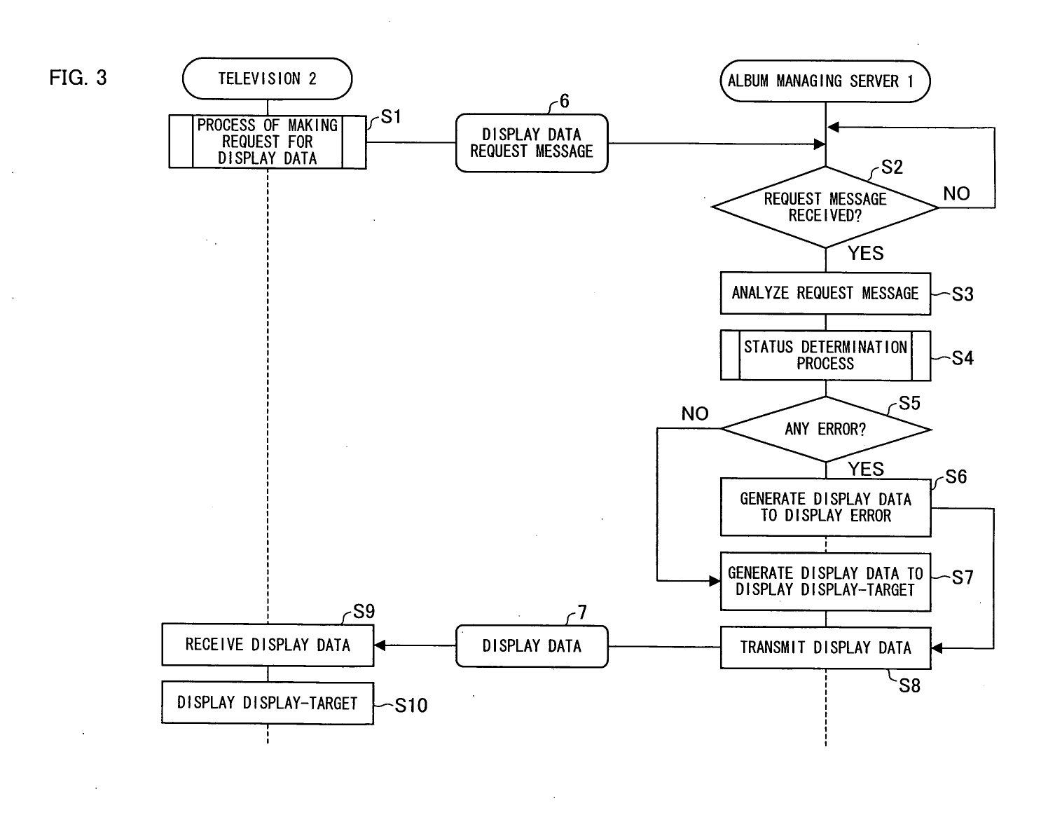

FIG. 3 is a sequence diagram showing a flow of processes in respective apparatuses in a network album system 100 in accordance with an embodiment of the present invention.

The television 2 carries out, at a predetermined timing, a display-data request process to request the album managing server 1 for display data to display a predetermined screen (S1). As a result, the display data request message 6 is transmitted to the album managing server 1.

The predetermined timing is, for example, the timing when an input of an instruction signal to display a screen is received from a user, or the timing when an application to utilize the network album system is activated so that the television 2 starts displaying an initial screen.

When receiving the display data request message 6 from the television 2 (YES in S2), the album managing server 1 analyzes the display data request message 6 thus received (S3).

When display target data to be displayed on the television 2 is identified as a result of that analysis carried out in S3, the album managing server 1 carries out a status determination process to determine a status of the display target data thus identified (S4).

Then, if the album managing server 1 determines as a result of the status determination process carried out in S4 that the display target data requested by the television 2 cannot be supplied due to any error (YES in S5), then display data for error display is generated. The display data for error display is generated to display status information (i.e. error message) that indicates a current status of the display target data requested (S6).

On the other hand, if the album managing server 1 determines that the display target data can be supplied in a normal manner (NO in S5), then the album managing server 1 generates the display control information that defines how the display target data is to be displayed, and combines the display control information data with the display target data, thereby generating display data for displaying the display target data (S7).

The album managing server 1 transmits the display data 7 generated in S6 or S7 to the television 2 in response to the display data request message 6 (S8).

The television 2 receives the display data 7 from the album managing server 1 (S9). In accordance with the display control information, the television 2 displays display data (e.g. album, picture) contained in the display data 7 (S10).

The following describes in detail a configuration of the album managing server 1, which carries out the processes in S2 to S8. In the following description, the album managing server 1 is to provide, in the form of the display data 7, three types of display screens of the television 2 in the network album system 100 of the present embodiment.

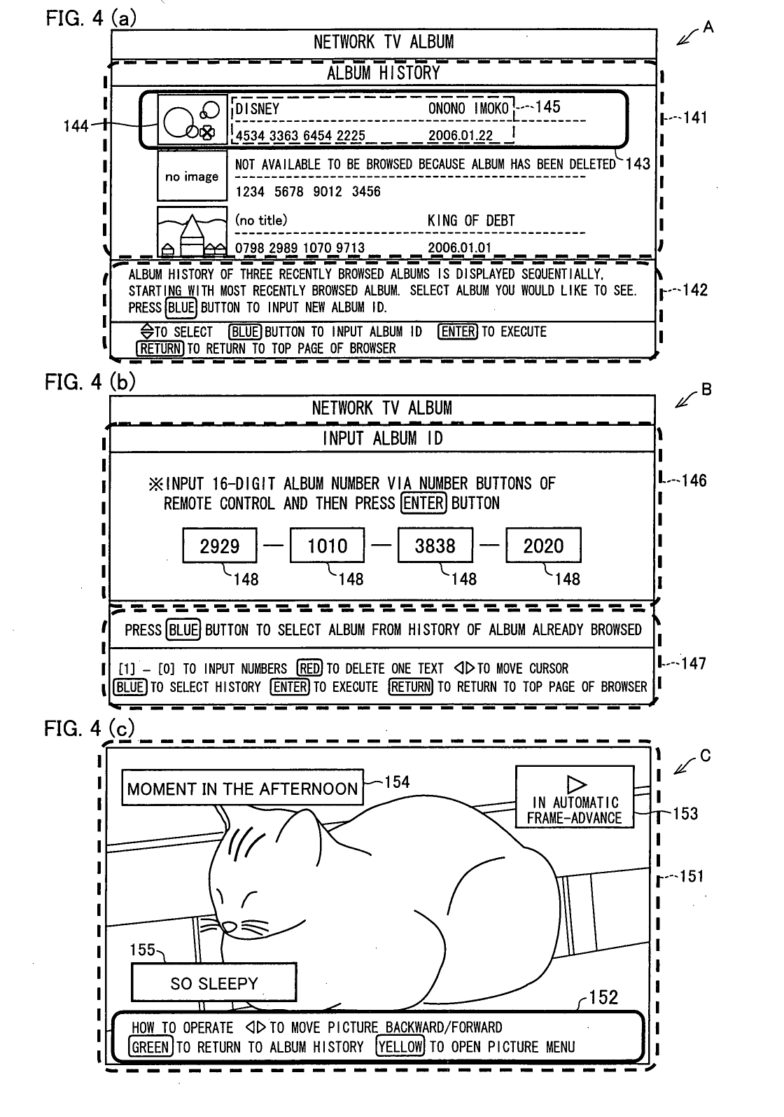

FIGS. 4(a) to 4(c) are diagrams each showing an exemplary display screen provided, in the form of the display data 7, by the album managing server 1 according to the present embodiment and displayed on the television 2.

(1) Display Screen A (Album History Screen)

FIG. 4(a) is a figure showing an exemplary album history screen to be displayed on the television 2. The album history screen displays information on the albums on the album managing server 1, to which albums the television 2 accessed in the past via the Internet 3. A user selects an album displayed on the album history screen by operating an operational section of the television 2 to request the album managing server 1 for display data to display the pictures in the album, thereby making the television 2 display the pictures in the album.

In the present embodiment, history information on the latest three albums among the albums accessed in the past is displayed. This is an exemplary case.

The album history screen provided by the album managing server 1 in the present embodiment contains a first area 141, where a history of browsed albums is displayed, and a second area 142, where information is displayed on operations performed on the television 2 via the album history screen. This is an exemplary case. The first area 141 includes three album information display areas 143. A representative image 144 of the album and basic information 145 (e.g. the title of the album, the name of the creator, the date of creation, the number of pictures) on the album are displayed in the respective album information display areas 143.

(2) Display Screen B (Album ID Input Screen)

FIG. 4(b) is a figure showing an exemplary album ID input screen displayed on the television 2. A user manually inputs the album ID of a desired album with the operational section via the album ID input screen. With the album ID input screen being displayed, the user, for example, inputs the album ID (this album ID is constituted of, for example, 16-digit numbers) of an album that the user desires to see by use of a ten-key provided to the operational section, and then presses the enter button, whereby a request for the display data to display the album of the album ID thus input is made to the album managing server 1.

In the present embodiment, the album ID input screen includes a first area 146 to display GUI for input of the album ID, and a second area 147 to display information on operations of the television 2 in the album ID input screen. This is an exemplary case. In the present embodiment, while looking at numbers displayed in a text box 148 in the first area 146, a user presses the ten-keys of the operational section to input four numbers in each of the four text boxes 148. Then, the user, for example, presses the enter button to determine a series of numbers in the text box 148 as a desired album ID and to enter the numbers into the television 2.

The album ID may be anything as long as all of the albums managed by the album managing server 1 are identified uniquely with the album ID, but it is especially preferable that the album ID is constituted of numbers only.

As also shown in FIG. 4(b), in the present embodiment, the album ID to identify the album is expressed solely with numbers. With this configuration, when the user needs to designate the album ID by manual input, the user only needs to input directly the numbers with the use of the ten-keys. The configuration of the operational section of the television 2 is thus simplified, having only the ten-keys. Input operation is simplified, compared to a case in which the album ID is input using Japanese characters, Chinese characters, or alphabets, so that the convenience of the users improves.

(3) Display Screen C (Album-Picture Display Screen)

FIG. 4(c) is a figure showing an exemplary album-picture display screen to be displayed on the television 2. The album-picture display screen is a screen to display a set of pictures contained in the album requested by the television 2, which set is constituted of at least one picture. Ways to display the pictures in the album are not particularly limited here. Exemplary ways include: a thumbnail display screen to simultaneously display a plurality of pictures contained in an album; and a slideshow display screen to display a plurality of pictures one by one and continuously. FIG. 4(c) shows a slideshow display screen as an exemplary album-picture display screen.

In the present embodiment, the album-picture display screen includes: a first area 151 to display a picture of an album throughout the screen; a second area 152 to display information on operations of the television 2 in the album-picture display screen, which information is superposed on the first area 151; a third area 153 to display a report on operations performed on the album; a fourth area 154 in which a title of the album is displayed; and a fifth area 155 to display comments made on the pictures by an author. This is an exemplary case.

The pictures are displayed on the album-picture display screen so that the users can enjoy the pictures contained in the desired album and shown in the form of slideshow, thumbnail, and the like.

In order that the respective display screens shown in FIGS. 4(a) to (c) are displayed on the television 2, the display data 7 generated by the album managing server 1 includes: predetermined display target data (e.g. pictures to be displayed, images of operational buttons, error message); and display control information to define a position of display-target, i.e. the display-target is to be displayed at which position and at what size. In response to the display data request message 6 from the television 2, the album managing server 1 generates the display data 7 to display a display screen requested by the television 2, and supplies the display data 7 to the television 2. The television 2 is then able to display any of the display screens A to C in accordance with the display data 7 supplied from the album managing server 1.

The types of the display screens and layouts of the screens discussed above are merely examples to describe the present invention, and the configurations of the album managing server 1 and the television 2 of the present invention are not limited thereto. The album managing server 1 of the present invention may provide display data of a display screen other than those discussed above, or display data in which the display screens discussed above are defined with other layout. The album managing server 1 of the present invention may provide one type of a display screen. The television 2 of the present invention is able to display various display screens, including display screens other than those discussed above.

[Configuration of Album Managing Server]

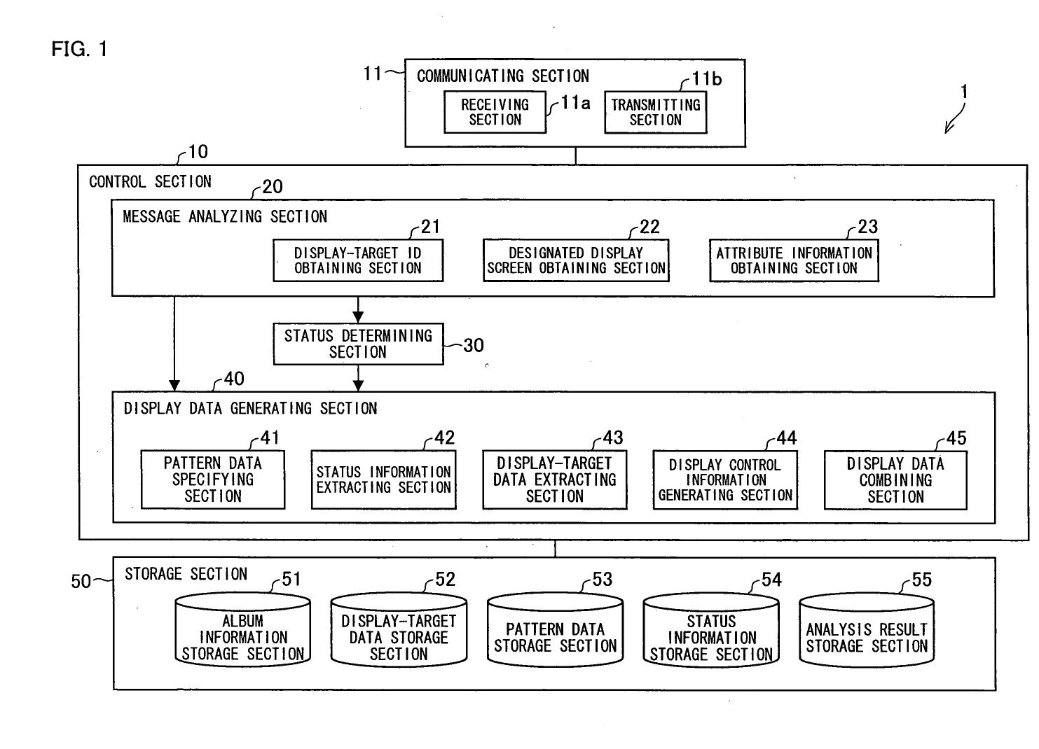

FIG. 1 is a block diagram showing a configuration of a main part of the album managing server 1 in accordance with an embodiment of the present invention. As shown in FIG. 1, the album managing server 1 includes a communicating section 11, a control section 10 to control overall the album managing server 1, and a storage section 50.

The control section 10 controls various operations of respective sections included in the album managing server 1. The control section 10 includes inside a message analyzing section 20, a status determining section 30, and a display data generating section 40. The control section 10 reads various control programs stored in the storage section 50, controls the respective sections in the album managing server 1 of the present invention, determines a status of display target data, and carries out various processes of generating display data.

The storage section 50 stores a control program to be executed by the control section 10, an OS program, and various data that the control section 10 reads out when carrying out various processes of determining the status or generating display data. The storage section 50 is configured with a nonvolatile memory device such as a hard disk. The various data is stored in various storage sections inside of the storage section 50, respectively. Specifically, the various data is stored in an album information storage section (display-target information storage section) 51, a display target data storage section (display-target information storage section) 52, a pattern data storage section 53, a status information storage section 54, and an analysis result storage section 55.

The communicating section 1 1 communicates, via the Internet 3, with respective apparatuses outside of the album managing server 1 and in the network album system 100. The communicating section 11 includes inside a receiving section 11a and a transmitting section 11b.

Concretely, the receiving section 11a receives the display data request message 6 transmitted from the television 2. The display data request message 6 received via the receiving section 11a is transmitted to the message analyzing section 20 of the control section 10 via an input/output control section, which is not illustrated. The transmitting section 11b transmits the display data 7 generated in response to a request from the television 2. The transmitting section 11b transmits, to the television 2 that makes the request, the display data 7 transmitted from the display data generating section 40.

In a case in which the respective sections of the storage section 50 are provided outside of the album managing server 1, when generating the display data 7, the communicating section 11 is connected to the storage section 50 to request the display target data, i.e. the album 5 (or picture) which is to become the display target, or status information on each display target data to carry out the status determination process, thereby obtaining various information from the storage section 50.

The message analyzing section 20 of the control section 10 analyzes the display data request message 6 received by the receiving section 11a. The message analyzing section 20 includes a display-target ID obtaining section (identification information obtaining means) 21, a designated display screen obtaining section 22, and an attribute information obtaining section 23.

The display-target ID obtaining section 21 obtains information to identify display target data that is to be displayed, which information is contained in the display data request message 6. In the present embodiment, the album ID to identify an album when, for example, the display data for displaying the album is contained in the display data request message 6. The display-target ID obtaining section 21 obtains the album ID contained in the display data request message 6 to identify the album requested.

The designated display screen obtaining section 22 obtains display screen designation information indicating the type of the display screen, which information is contained in the display data request message 6. As described above, in the present embodiment, the album managing server 1 provides plural types of display screens. Therefore, the display data request message 6 contains display screen designation information that indicates which type of the display screen the television 2 is requesting. The designated display screen obtaining section 22 obtains the display screen designation information, which is contained in the display data request message 6, to identify the display screen designated.

If there is only one type of the display screen to be generated in the album managing server 1, the designated display screen obtaining section 22 does not necessarily have to be provided.

The attribute information obtaining section 23 obtains apparatus information on the television 2 that has sent the message, or user information on the user of the television 2, both of which informations are contained in the display data request message 6. The apparatus information and the user information thus obtained are utilized by the album managing server 1 in determination to generate suitable display data. For example, if the user information contains information on the age of the user, and if the display target data that can to be provided differs in a manner that depends on the age, the album managing server 1 is able to select the display target data to be contained in the display data, in a manner responsive to the information on age, which information is obtained by the attribute information obtaining section 23. Further, if the display target data is requested that is allowed to be provided only for a limited range of age, and if the age of the user does not satisfy the condition, the album managing server 1 is able to carry out a process of generating the display data containing an error message, instead of generating the display data containing the display target data.

If the display data is generated in the album managing server 1 without using the apparatus information or the user information, the attribute information obtaining section 23 does not necessarily have to be provided.

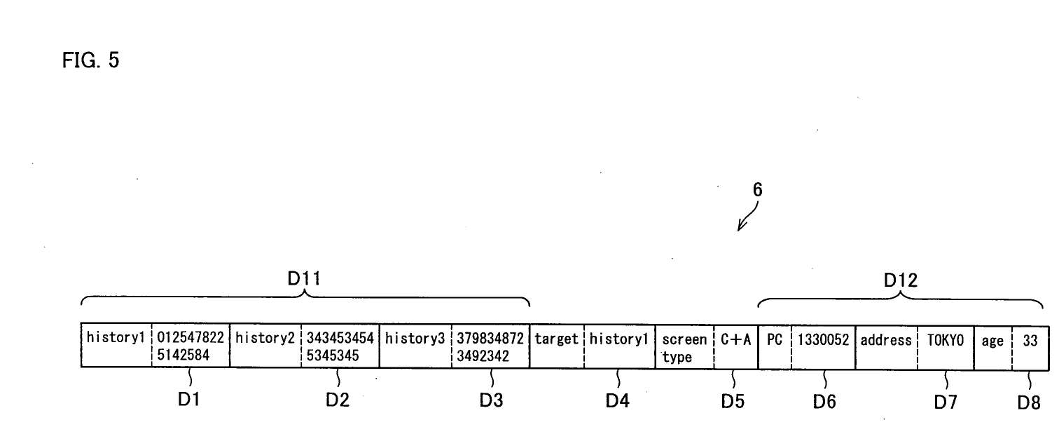

FIG. 5 is a figure schematically showing a configuration of data of the display data request message 6 supplied from the television 2.

In the case shown in FIG. 5, the display data request message 6 is constituted of eight pieces of data, as a collective set of data, surrounded by the continuous line. In one data shown in FIG. 5, a string of characters shown on the left hand side indicates a data name. A string of characters shown on the right hand side indicates contents of the data to which the data name is provided. Although FIG. 5 shows the contents of each data are indicated as the strings of characters, the type of each data is not limited to that shown in FIG. 5. Any type of data may be selected that is suitable for contents, a capacity, and an intended use of each data.

Data D1 indicates the album ID of the album to be displayed on the album information display area 143 that is in an upper section of the first area 141, when the display data request message 6 is to request the display screen A shown in FIG. 4(a). Data D2 indicates the album ID of the album to be displayed on the album information display area 143 that is in a middle section. Data D3 indicates the album ID of the album to be displayed on the album information display area 143 that is in a lower section.

Data D4 is information that indicates which one of data D1 to D3 is the album containing the picture to be displayed in the first area 151 when the display screen C shown in FIG. 4(c) is to be requested. In the case shown in FIG. 5, “history 1” is stored in the data D4. Thus, the display data request message 6 is to request the display screen C to display the picture in the album that has the album ID “0125478225142584” and is stored in the data D1 (history 1). If the album ID is manually input in the television 2 and therefore differs from any of the data D1 to D3, this manually input album ID is stored directly in the data D4.

The data D5 indicates information on the type of the display screen, among the display screens shown in FIGS. 4(a) to 4(c), that the display data request message 6 designates. In the case shown in FIG. 5, “C+A” is stored in the data D5, and thus the display data request message 6 is to request the display screens C and A. As the foregoing describes the display data request message 6 is configured as a request message to designate plural types of display screens. When receiving the display data request message 6 to request such plural types of display screens, the album managing server 1 not only prepare data to display the display screen designated, but also generates transition definition information in which control instructions for transitions among the plural display screens are filled, and generates the display data 7 containing the transition definition information.

Data D6 indicates apparatus information on the television 2 that generates and sends the display data request message 6. In the case shown in FIG. 5, an apparatus ID is stored to identify the television 2. This allows the album managing server 1 to identify from where the display data request message 6 is sent, and therefore to identify to where the display data 7 thus generated is to be sent. The apparatus ID may be anything, as long as the apparatus ID allows the album managing server 1 to uniquely identify the respective apparatuses (television 2) in the network album system 100 that are to receive the display data. The apparatus ID may be given individually by the album managing server 1 each time the television 2 is registered. Alternatively, IP addresses, MAC addresses, or product serial numbers may be used as the apparatus ID.

Further, the apparatus information is not limited to the apparatus ID. For example, the display data request message 6 may contain specification information (e.g. screen size, resolution) on the television 2, in addition to the apparatus information. This allows the album managing server 1 to generate the display data 7 in conformity with the specification of the apparatus that sends the request.

User information on the user of the television 2 is stored in data D7 and data D8. In the case shown in FIG. 5, the data D7 indicates information on a current address of the user of the television 2. The data D8 indicates information on the age of the user of the television 2.

Accordingly, the album managing server 1 is able to make the display data 7 contain regional contents responsive to the information on current address, or is able to select, on the basis of the age of the user, the display target to be contained in the display data 7, for example.

When necessary, respective sections of the message analyzing section 20 obtain data contained in the display data request message 6 shown in FIG. 5. Specifically, the display-target ID obtaining section 21 obtains the data D1 to D4. The designated display screen obtaining section 22 obtains the data D5. The attribute information obtaining section 23 obtains the data D6 to D8.

Nothing needs to be stored in the data D1 to D4 in the display data request message 6 that is to be generated in a case in which only the display screen B shown in FIG. 4(b) is to be requested, or in a case in which no album history is retained in the television 2 that sends the request.

The display data request message 6 is configured with the eight pieces of data, but is not limited to this configuration. The display data request message 6 is configured so as to contain information that needs to be supplied from the television 2, in a manner responsive to the types and layouts of the display screens that the album managing server 1 provides.

In the case shown in FIG. 5, the display data request message 6 is indicated as one record. The configuration of data of the display data request message 6, however, is not limited to what is shown in FIG. 5. The configuration of the data of the display data request message 6 may be any configurations including a list or a tree, as long as pieces of data necessary for the album managing server 1 to generate the display data 7 are linked together so that all of the pieces of data are gathered collectively.

Various pieces of data obtained by the respective sections of the message analyzing section 20 are stored in the analysis result storage section 55 of the storage section 50, and read out by the status determining section (status determining means) 30 or the display data generating section 40 when necessary. The status determining section and the display data generating section 40 are described below.

The status determining section 30 of the control section 10 determines the status of the display target data (album in the preset case) requested by the display data request message 6. The display target data is identified by the display-target ID (album ID in the preset case) obtained by the display-target ID obtaining section 21.

More specifically, on the basis of the album ID, the status determining section 30 extracts, from the album information storage section 51 to store information on the albums, album information (display target information) on the album. Then, the status determining section 30 determines the status of the album on the basis of the album information thus extracted, and outputs a result of this determination as a status determination result. The status determination result is information that indicates the status of the album. More specifically, the status determination result is information that indicates a status in regard to browsability of the album, i.e. whether or not the album is available to be provided in a normal manner, and why the album is not available to be provided when the album is not available.

The status determination result that is output from the status determining section 30 is transmitted to the display data generating section 40 to be utilized for the display data generating section 40 to generate appropriate display data.

The following describes in detail functions of the status determining section 30, using concrete examples of the album information stored in the album information storage section 51.

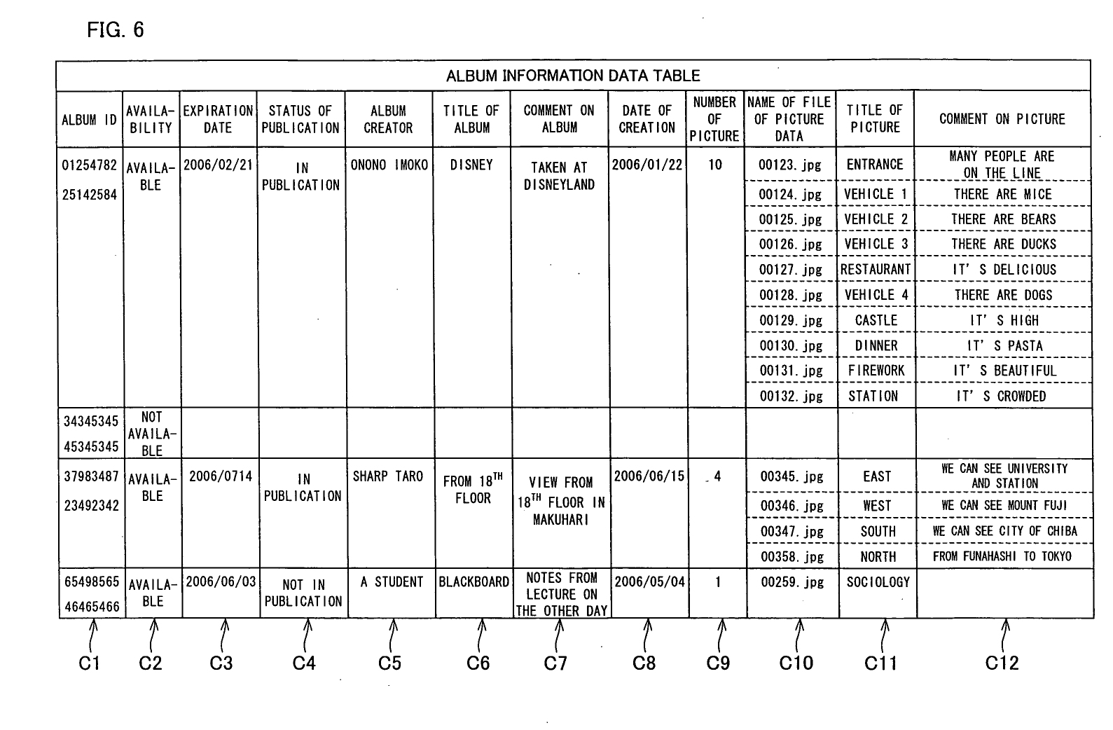

FIG. 6 is a figure showing exemplary album information stored in the album information storage section 51. In the case shown in FIG. 6, the album information is stored, as a record, for each album and associated with the album ID. Each album information is managed in the form of a table.

A column C1 (data name “album ID”) indicates the album ID to identify the album. On the basis of the album ID, the status determining section 30 obtains the album information on the album identified as the display target data.

A column C2 (data name “availability”) indicates whether or not the album identified by the album ID is available to be used. If this availability data indicates “not available”, it implies that the album was managed by the album managing server 1, but contents of the album no longer exists (because the contents have been deleted or the like) and will not be restored in the future.

The status determining section 30 determines whether or not the album is available to be used by determining whether the availability data indicates “available” or “not available”. An additional column may be provided to store a date from when the album becomes not available (e.g. date of deletion). This allows the status determining section 30 to determine that the album becomes not available and from when the album is not available.

A column C3 (data name “expiration date”) indicates a date on which the publication period set to the album expires. When receiving the request for the album, the status determining section 30 obtains a current date (from, for example, a clock section (not illustrated) built in the album managing server 1) to determine whether or not the current date thus obtained is after the expiration date. If the current date is after the expiration date, the status determining section 30 obtains the expiration date and transmits the expiration date to the display data generating section 40. The publication period to be set to the album may be arbitrarily set by the album creator, or may be set automatically and uniformly by the album managing server 1.

A column C4 (data name “status of publication”) indicates information on whether or not publication of the album is set to be allowed. In the present embodiment, the album managing server 1 is configured in such a manner that the album creator arbitrarily sets whether or not to allow the album to be published.

The status determining section 30 determines whether or not the album is available to be used by determining whether publication status data indicates “in publication” or “not in publication”.

Columns C5 to C9 indicate basic information on the album. The column C5 indicates an album creator who created the album. The column C6 indicates a title of the album. The column C7 indicates comments on the album, which comments are registered by the album creator. The column C8 indicates a date of creation on which the album was created. The column C9 (data name “number of pictures (image presence/absence information)”) indicates the number of pictures contained in the album. The display data generating section 40 obtains those informations, when necessary, to generate the display data for displaying the album.

The status determining section 30 determines whether the album contains a picture by referring to the data on the number of pictures to determine whether the data is a NULL value or 0 (zero), or whether the data is 1 or greater.

A column C10 (data name “picture ID (image presence/absence information)”) indicates a picture ID to identify one or more pictures contained in the album. The picture ID may be anything, as long as each of the one or more pictures contained in one album is identifiable by the picture ID. In the case shown in FIG. 6, a file name of the picture (“**.jpg”) is directly handled as the picture ID.

The album managing server 1 may assign the picture ID to each of the pictures individually. The status determining section 30 may determine that the album contains no data by detecting not a single picture ID is associated with the column C10 of the picture ID data.

A column C11 indicates a picture title that is given to each picture by the album creator. A column C12 indicates comments on pictures, each of which comments is provided to each of the pictures by the album creator. In generating the display data for displaying the pictures, the display data generating section 40 obtains those pieces of information when necessary.

Although the foregoing describes that the album information has a table configuration constituted of 12 columns, the configuration of the data of the album information of the present invention is not limited what described above. The album information is configured suitably so as to contain information necessary for the album managing server 1 to determine the status of the album. For example, to set an age limitation on people to be allowed to observe, an additional column is provided to store a condition of ages of people who are allowed to browse.

In the case shown in FIG. 6, plural pieces of album information are shown in table structure as gathered plural records, but the configuration of the data of the album information is not limited to what shown in the figure. The album information may have any data configuration, as long as the information of each of the columns is stored in such a way as to be associated with the album ID so as to allow the status determining section 30 to determine the status of the respective albums one by one.

As described above, the status determining section 30 refers to the album information storage section 51 to determine the status of the album identified as the display target data, and supplies a result of this status determination to the display data generating section 40.

The display data generating section 40 of the control section 10 generates the display data in response to the display data request message 6. The display data is generated on the basis of the result of the analysis carried out by the message analyzing section 20, and the result of the status determination carried out by the status determining section 30.

More specifically, the display data 7 in response to the display data request message 6 is generated by (1) selecting a pattern data to serve as a template of the display control information for displaying the display screen designated, (2) filling, into the pattern data selected, contents, i.e. text data and display target specifying information to identify the display target data, such as requested albums, pictures, and components, to generate the display control information, and (3) combining the display target data and the display control information (and other additional information, if any).

When the status determining section 30 determines that the display data requested is not available to be provided, the display data generating section 40 generates, instead of generating display data (normal display data) for displaying the display target data requested, display data 7 (error display data) to display the status information indicating that the display target data is not available to be provided, and in what state the display target data is.

To carry out the process of generating the display data (normal display data or error display data), the display data generating section 40 includes a pattern data specifying section 41, a status information extracting section (status information generating means) 42, a display target data extracting section 43, a display control information generating section (display control information generating means) 44, and a display data combining section 45.

The pattern data specifying section 41 selects the pattern data for displaying the display screen designated, in a manner responsive to the display screen designation information obtained by the designated display screen obtaining section 22. The pattern data specifying section 41 refers to the pattern data storage section 53 to identify the pattern data that serves as the template of the display screen requested, on the basis of the pattern ID that is contained in the display screen designation information and is to identify the display screen.

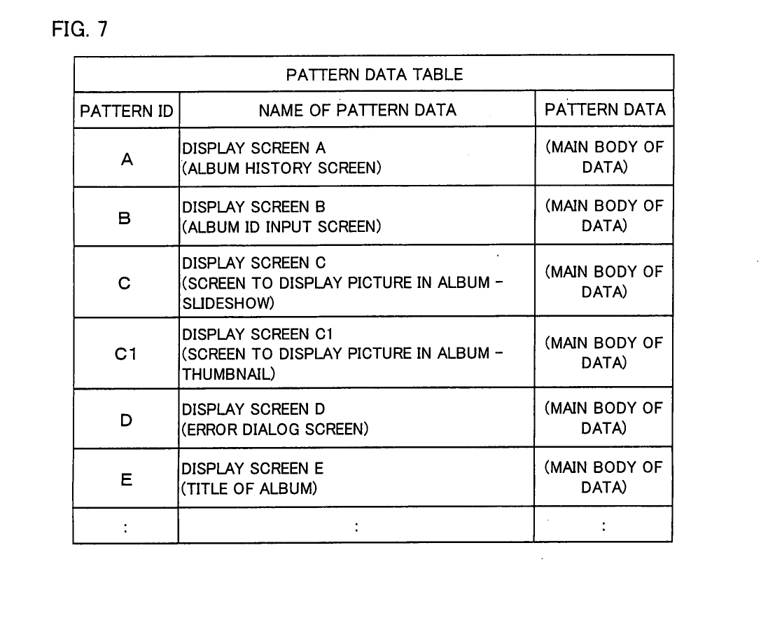

FIG. 7 is a figure showing an exemplary pattern data table stored in the pattern data storage section 53. In the case shown in FIG. 7, templates of the display screens of plural types including the display screens A to C (FIGS. 4(a) to 4(c)) are stored in such a way as to be associated with the pattern ID.

In the case shown in FIG. 5, the display screens A and C are identified as the display screen designation information. Accordingly, the pattern data specifying section 41 refers to the pattern data storage section 53 shown in FIG. 7 to identify the following pattern data: pattern data, identified by pattern ID “A”, for generating the album history screen; and pattern data, identified by pattern ID “C”, for generating the album-picture display screen (slideshow screen).

The pattern data contains pattern information (or combinations of the pattern information) on the scripts for generating display screens, which pattern information includes standard layout definition information. In other words, the pattern data is a template for the display control information. If information (display target specifying information) that actually identifies the display target data (album, picture) is to say the contents, the pattern data corresponds to a container before the contents are filled.

The pattern data identified by the pattern data specifying section 41 is combined with the contents described above, whereby the display control information is generated.

The status information extracting section 42 extracts, from the status information storage section 54, status information corresponding to a status determination result that the status determining section 30 supplies.

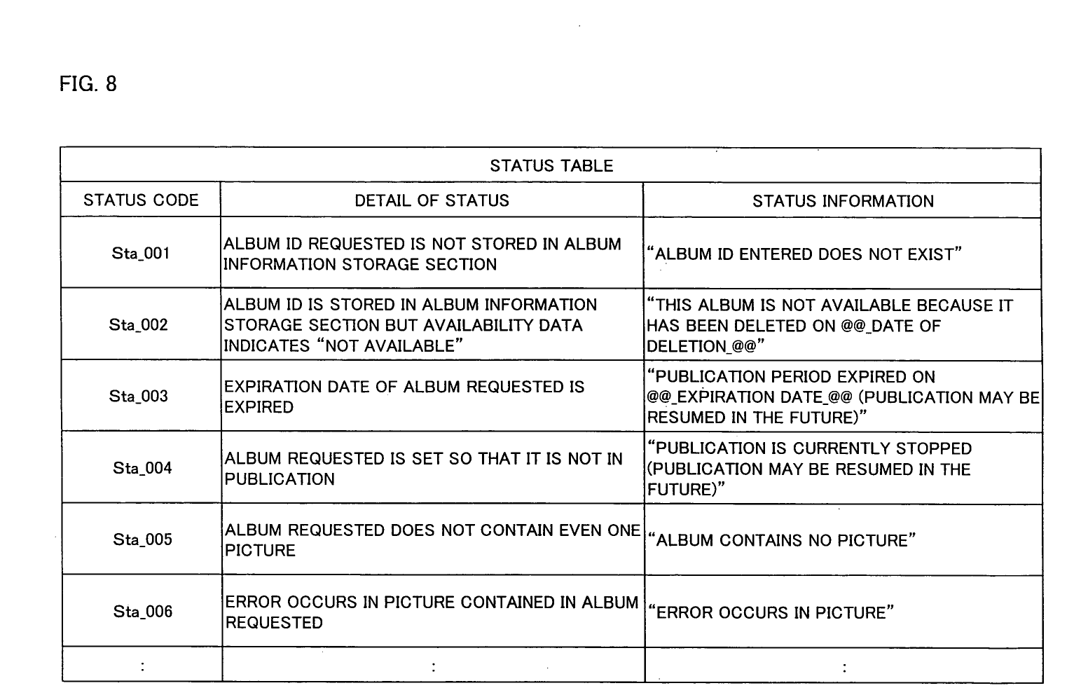

FIG. 8 is a figure showing an exemplary status table in which the status information storage section 54 is to be stored and the status information is to be managed. In the status table shown in FIG. 8, one state of the album is configured as one record. Status codes to uniquely identify various types of statuses of the album, and the status information to show the users the detail of the status of the album and the status, in association with the status code.

For example, assume that the album ID of the album requested is not stored in the album information storage section 51, so that the status determining section 30 outputs status code “Sta_{—}001” as the status determination result for the album to indicate the status of the album “ALBUM ID REQUESTED IS NOT STORED IN ALBUM INFORMATION STORAGE SECTION”.

The status information extracting section 42 extracts text data of the status information “ALBUM ID ENTERED DOES NOT EXIST” on the basis of the status code “Sta_{—}001” that is output by the status determining section 30.

The status information extracted by the status information extracting section 42 on the basis of the status determination result of the status determining section 30 is filled into the pattern data, whereby the display control information is generated. The display control information containing the status information is provided to the television 2 so that the television 2 becomes able to display the status information.

The status information may be determined by extraction of fixed text data, or may be dynamically determined by designation of parameters. For example in the case shown in FIG. 8, the status information of status code “Sta_{—}003” contains parameters written in the form of “@@_(parameter name)_@@”.

The status determining section 30 refers to the album information storage section 51. If detecting that the expiration date of the album requested is already expired, then the status determining section 30 outputs status code “Sta_{—}003” and the expiration date data (e.g. “Feb. 1, 2006”) of the album.

In accordance with the status code, the status information extracting section 42 extracts the status information shown in FIG. 8 and replaces the parameter of “@@_expiration date_@@” contained in the status information extracted, with the data on expiration date “Feb. 1, 2006” supplied from the status determining section 30, whereby the status information is completed.

Accordingly, an instruction to display, instead of the album, text data “PUBLICATION PERIOD EXPIRED ON Feb. 1, 2006 (PUBLICATION MAY BE RESUMED IN THE FUTURE)” is written in the display control information to be sent back to the television 2 requesting the album.

Although the foregoing description discusses the status information stored in the form of the text data, the data format of the status information is not limited to what described above, as long as the format indicates the information on the status of the album to the users. For example, the status information may be stored in the form of an image file with icons, drawings, and/or images of texts. In this case, the status information is handled as the display target data, in the same manner as the pictures, and the display target specifying information to identify the display target data is filled into the pattern data, whereby the display control information is generated.

The display target data extracting section 43 extracts, from the display target data storage section 52, the display target data identified by the album ID obtained by the display-target ID obtaining section 21.

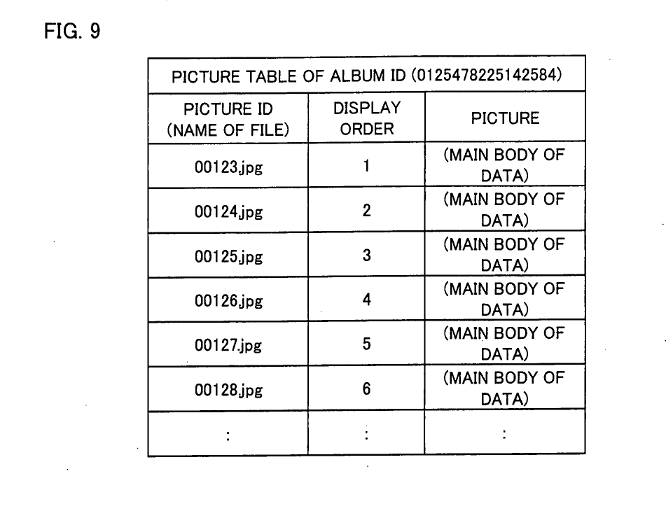

FIG. 9 shows an exemplary picture table for each table, which picture table is stored in the display target data storage section 52, in which the display target data is to be stored. Although FIG. 9 shows, as an exemplary display target data table, the picture table that indicates a list of the pictures contained in the album of the album ID “0125478225142584”, the picture table is not the only display target data table that is to be stored in the display target data storage section 52. In the display target data storage section 52, the picture table is prepared for each of the albums managed in the album information storage section 51. The display target data extracting section 43 is configured in such a way as to refer, on the basis of the album ID obtained by the display-target ID obtaining section 21, to the picture table associated with the album. Further, only the picture table to manage the pictures is indicated in the case shown in FIG. 9, but this is not to limit the display target data table. For example a component image table may be stored in the display target data storage section 52 to manage images of components such as operational buttons.

As shown in FIG. 9, the picture table to manage the pictures of the album is configured in such a manner that one record is configured for each picture. In the picture table, the picture ID (or file name of the pictures) to uniquely identify the pictures in the album, a display order of the pictures, and a main body of data of the pictures are stored. Each of the display order and the main body of the data of the pictures is associated with the picture ID. The display order of the pictures indicates an order in displaying a plurality of pictures. The display order is referred to in order to determine, for example, a position and an order of the pictures displayed in thumbnail view, or a sliding order of the pictures displayed in slideshow.

If the display-target ID obtaining section 21 identifies that the album requested is the album of the album ID “0125478225142584”, the display target data extracting section 43 refers to the picture table (FIG. 9) stored in the display target data storage section 52, and identifies and extracts pictures from “00123.jpg” to “00132.jpg (FIG. 6)” as the display target data.

In the present embodiment, the display target data extracting section 43 may selectively extract the display target data necessary in accordance with the display screen designation information of the designated display screen obtaining section 22.

More concretely, for example, the display target data extracting section 43 needs to extract all pictures in the album only when the designated display screen obtaining section 22 identifies the display screen C or the display screen C1 as the display screen designation information.

Further, if the display screen designation information indicates the display screen A, the album history screen only needs a piece of a small-size image of a representative image. Accordingly, the display target data extracting section 43 extracts one picture from the picture table, which picture is the first one in the display order. The display target data extracting section 43 enlarges (or reduces) the picture so that the picture fits the size of a display on the album history screen. Then, the display target data extracting section 43 outputs the picture.

The display target data extracted and output by the display target data extracting section 43 is provided to the display control information generating section 44 and to the display data combining section 45.

The display target data extracting section 43 may extract additional information, such as basic information on the album, from the album information storage section 51 in a manner responsive to the display screen designated. Images of components, such as operational buttons, may be extracted from the display target data storage section 52 as additional information. Concretely, which additional information is to be extracted is described for each pattern data selected. In accordance with this description, suitable additional information is extracted from the album information storage section 51 or from the display target data storage section 52.

Examples of the additional information include: icons and descriptive texts to display, in a tabulated list, commands that the user can enter; album titles; information on attributes of pictures; operational information that indicates a history of processes carried out to the pictures; names of sites that provide network album services; and information on copyrights. The additional information, however, is not limited to the foregoing examples.

As described above, the additional information extracted by the display target data extracting section 43 is filled in the pattern data selected, and constitutes a part of the display control information.

The display control information generating section 44 filled, into the pattern data identified by the pattern data specifying section 41, the status information extracted or generated by the status information extracting section 42, the display target specifying information to identify the display target data extracted by the display target data extracting section 43, and the additional information extracted by the display target data extracting section 43, thereby generating the display control information responsive to the request of the display data request message 6.

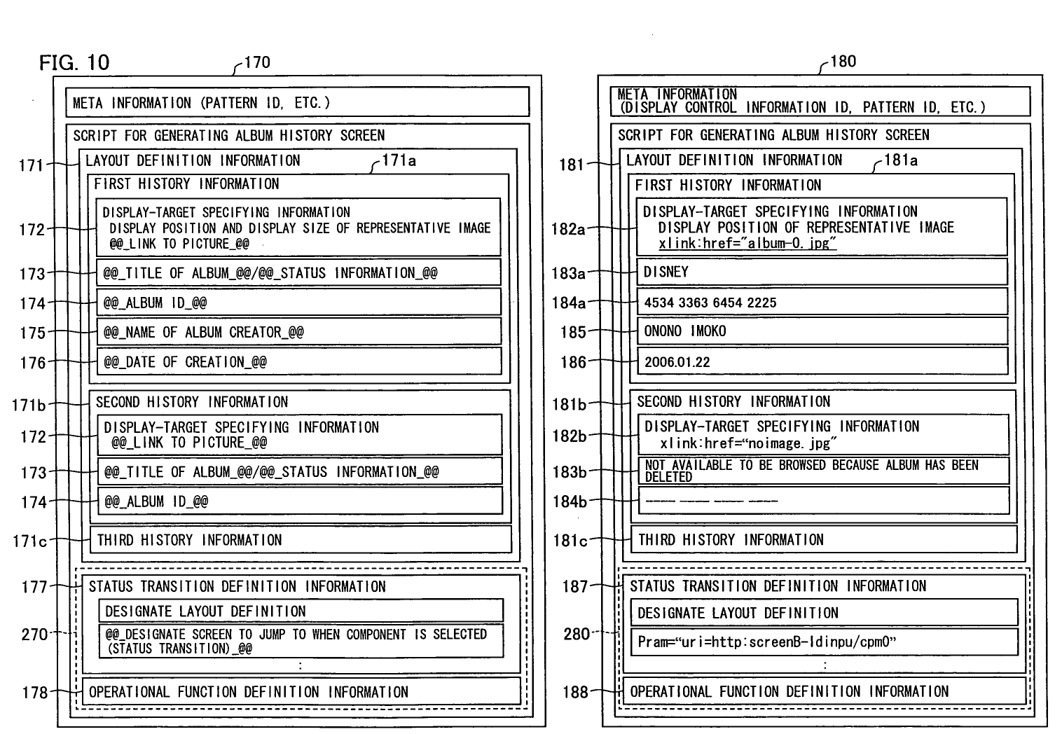

FIG. 10 is a figure schematically showing exemplary pattern data (on the left) identified by the pattern data specifying section 41, and exemplary display control information (on the right) that the display control information generating section 44 generates by filling the contents (e.g. status information/display target specifying information/additional information) into the pattern data. The pattern data and the display control information that are shown in FIG. 10 contain scripts for generating the album history screen to generate the display screen A (album history screen).

As described above, the pattern data 170 identified is a “container” before contents (e.g. status information, display target specifying information, additional information) are filled, containing only template information. The contents of the pattern data 170 are indicated as strings of characters “@@_(parameter name)_@@” as shown in FIG. 10. The display control information generating section 44 replaces the contents with actual values after the status information extracting section 42 identifies the status information, and after the display target data extracting section 43 identifies the display target data and the additional information.

To display three pieces of history information on the album, the layout definition information 171 on the pattern data contains three pieces of information to define a position of each history information on the respective albums. Specifically, the layout definition information 171 contains first history information 171a, second history information 171b, and third history information 171c.

In the following description, only the configuration of the first history information 171a is described in detail. The rest of the history information has the same configuration as that of the first history information 171a. Therefore, description thereof is omitted.

The first history information 171a contains, further, display target specifying information 172, a title or status information 173, an album ID 174, an album creator 175, and a date of creation 176.

The display control information generating section 44 first determines, on the basis of the status determination result of the status determining section 30, whether to carry out a filling process to display the display target data in a normal manner, or carry out the process of filling to display the status information as the error message. This determination is carried out for each display target data (album in the present case).

(1) Filling Process to Display the Display Target Data in a Normal Manner

The display control information generating section 44 refers to the display target data that is output by the display target data extracting section 43, generates information on a link to the display target data, and fills the information thus generated into the display target specifying information 172. The information on the link to the display target data is filled, whereby the display target specifying information 182a is generated.

Then, the display control information generating section 44 fills, into the title or status information 173, the album title extracted from the album information storage section 51 by the display target data extracting section 43. In the present embodiment, if the album is available to be provided in a normal manner, the album title is filled into the title or status information 173.

Then, the display control information generating section 44 fills the rest of the first history information 171a. Specifically, in the same manner as described above, the display control information generating section 44 fills the album ID into the album ID 174, the album creator into the album creator 175, and the date of creation into the date of creation 176. All of the album ID, the album creator, and the date of creation are extracted from the album information storage section 51 by the display target data extracting section 43. Consequently, first history information 181a is completed to display the history information on the album, containing the display target specifying information 182a, the title 183a, the album ID 184a, the album creator 185, and the date of creation 186.

(2) Filling Process to Display the Status Information as the Error Message

If the status determination result indicates that the album is not available to be provided to where the request comes from, the display control information generating section 44 carries out the filling process to display the status information, instead of carrying out the filing process to display the history information on the album. The status information in this case indicates, to the users, that the album cannot be provided because it is in what state.

The following describes a case in which second information 181b is generated from the second history information 171b shown in FIG. 10. The display control information generating section 44 fills, into the display target specifying information 172, the display target specifying information to identify an image (picture ID “noimage.jpg”) indicating that there is no image, instead of a representative image of the album, whereby the display target specifying information 182b is generated. The “noimage.jpg” is extracted from the display target data storage section 52 by the display target data extracting section 43 in a manner responsive to the result of the determination of the status determining section 30.

The display control information generating section 44 fills, into the title or status information 173, the status information extracted from the status information storage section 54 by the status information extracting section 42. In the present embodiment, if the album is not available to be provided, the status information (in this case, “ALBUM ID ENTERED DOES NOT EXIST”), instead of the album title, is filled into the title or status information 173. Consequently, the status information 183b is generated to indicate the error message to the users.

The display control information generating section 44 fills, into the album ID 174, information (e.g. “--- --- --- ---”) to indicate that the album ID is empty, instead of filling in the album ID. This is because the status determining section 30 detects the status of the album as being “Sta_{—}001”, that is, the status determining section 30 detects that the album ID requested is not stored in the album information storage section, so that there is no album ID information to be indicated. If the album is likely to be published in the future, the album ID being managed is filled in.

In the foregoing manner, the album ID 184b is generated, and the second history information 181b is completed that contains the display target specifying information 182b, the status information 183b, and the album ID 184b.

The foregoing process of filling is carried out repeatedly on each album that is the display-target, whereby the contents are filled into the pattern data. The third history information 181c is generated by carrying out any of the foregoing processes of filling on the third history information 171c. Accordingly, the contents are filled into the layout definition information 171 so that the layout definition information 181 is generated, whereby the display control information is completed.

The foregoing describes that the layout definition information 181 is generated on the basis of the layout definition information 171, but the way to generate the layout definition information 181 is not limited to the foregoing way. If the pattern data contains the detailed operation definition information 270 (status transition definition information 177 and operational function definition information 178), suitably selected contents are filled into the detailed operation definition information 270 to generate the detailed operation definition information 280. Here, the status transition definition information 187 defines to which screen a transition is to be made from the album history screen displayed with the scripts for generating the album history screen, when a particular component is pressed. Further, the operational function definition information 188 defines how the television 2 should operate when which event occurs while displaying the album history screen.

As described above, the display control information generating section 44 fills the contents into the pattern data 170 to generate the display control information 180. The display control information 180 is generated in a manner responsive to the contents of the display data request message 6. The display control information 180 is to display, on the television 2, the album requested by the television 2 that sends the display data request message 6, in layout of the display screen requested.

Objects to be filled in are not limited to those mentioned above. For example, a background image, which is stored as the additional information, in displaying the album may be filled in.

The display data combining section 45 combines the display control information generated by the display control information generating section 44 with the display target data (e.g. picture, component image) identified by the display target specifying information of the display control information, thereby generating the display data to display the album on the television 2.

The display data thus generated contains the display target data requested, and the display control information to define the position of the display target data or the position of the status information on the television 2. Receiving the display data, the television 2 is able to display, in a predetermined layout, the pictures or the status information contained in the album, in accordance with the display control information.

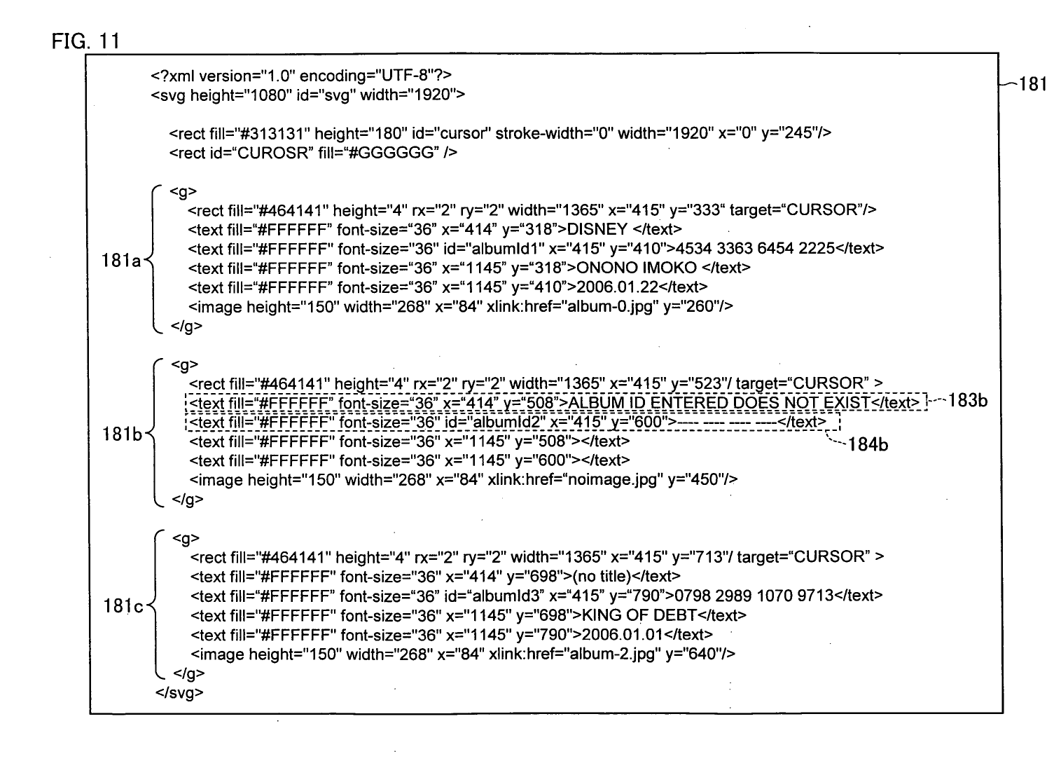

FIG. 11 is a figure showing a concrete example of the layout definition information 181 after the contents are filled. As described above, information on actual contents is filled into the “@@_(parameter name)_@@” of the pattern data 170, whereby the layout definition information 181 of the display control information is completed.

The descriptions between <g> and </g> each indicate the first history information 181a to the third history information 181c. The album that is supposed to be displayed in the second history information 181b is determined by the status determining section 30 that the album is not available to be provided. Therefore, instead of the album title, the status information 183b is filled in the title or status information 173. The album ID is not extracted, so that the string of characters (album ID 184b) is filled in the album ID 174 to indicate that the album ID does not exist.

[Processes in Album Managing Server]

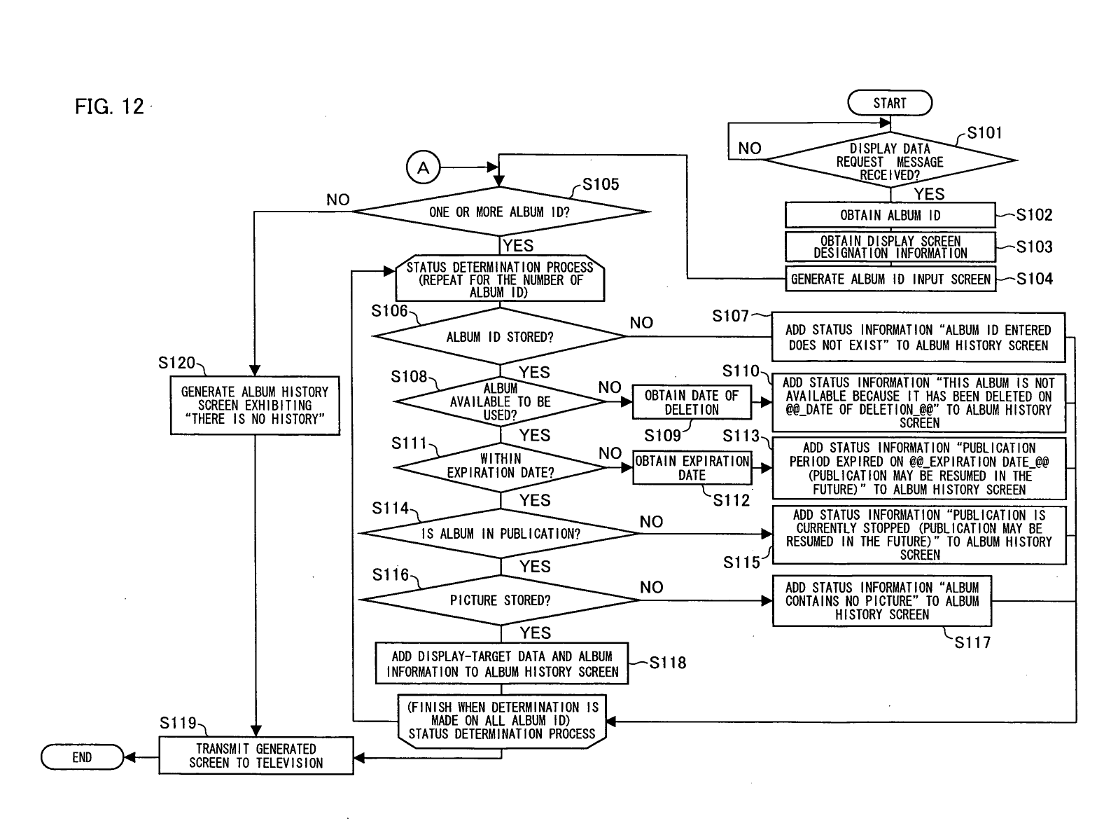

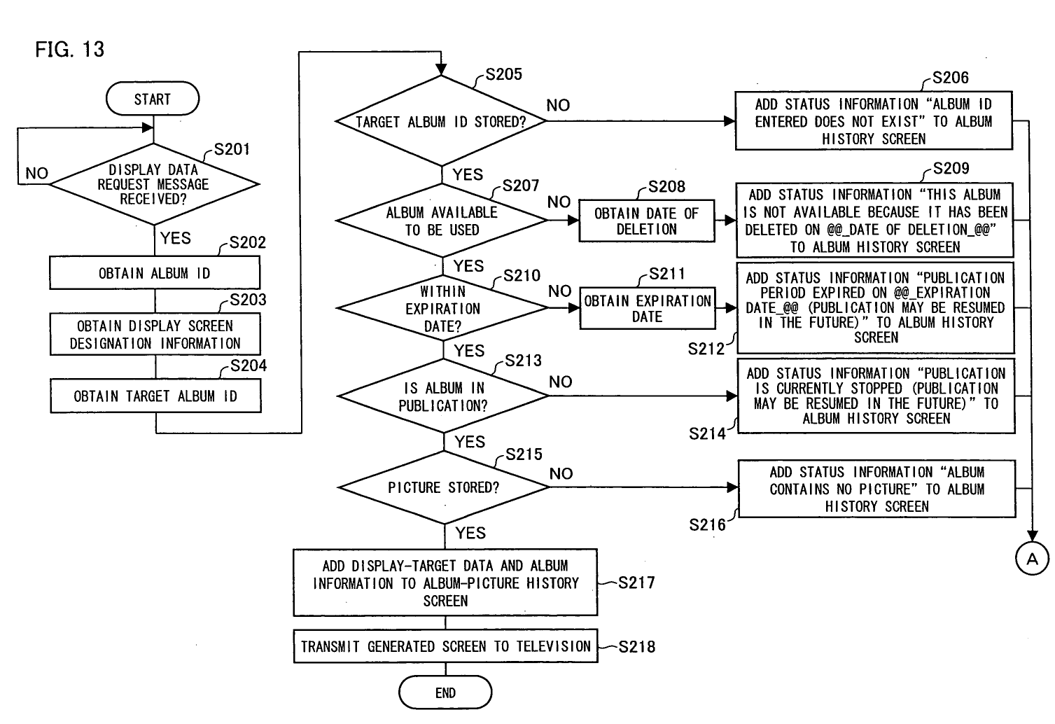

The following describes a flow of processes in the album managing server 1, with reference to FIGS. 12 and 13.

FIG. 12 is a flowchart showing a flow of processes of providing display data in the album managing server 1. The album managing server 1 receives the display data request message 6 from the television 2 (FIG. 2). In the case shown in FIG. 12, the display data request message 6 (FIG. 5) that contains three album IDs and information to designate the display screens A and B is received from the television 2.

When the receiving section 11a (FIG. 1) of the album managing server 1 receives the display data request message 6 from the television 2 (YES in S101), the message analyzing section 20 analyzes the display data request message 6 thus received.

The display-target ID obtaining section 21 obtains those three album IDs contained in the display data request message 6 (S102). If the data D4 shown in FIG. 5 contains no data, nothing is obtained from the data D4.

The designated display screen obtaining section 22 obtains information that designates the type of the display screen requested by the television 2, which information is contained in the display data request message 6 (S103). In the present case, the display screens A and B are obtained as the display screen designation information.

On the basis that the display screen B is obtained, the display data generating section 40 generates the scripts for generating the album ID input screen (S104).

If it is determined as a result of the analysis carried out by the display-target ID obtaining section 21 that there is at least one album ID obtained (YES in S105), the status determining section 30 carries out, on all the albums identified by the album IDs obtained, the status determination process shown in S4 in FIG. 3. Three album IDs are obtained in the present case, so that the status determination process is carried out for three times.

On the basis of the album ID obtained, the status determining section 30 refers to the album information on the album, which album information is stored in the album information storage section 51. If it is detected that the album ID is not stored in the album information storage section 51 (NO in S106), the status code (Sta_001) that corresponds to the status thus detected is output. The status information extracting section 42 extracts the status information (“ALBUM ID ENTERED DOES NOT EXIST”) that corresponds to the status code. Then, the display control information generating section 44 fills the status information into the scripts for generating the album history screen (S107).

If it is detected that the album ID is stored, and that the availability data on the album indicates “not available” (YES in S106, NO in S108), the status determining section 30 detects that the album is never available again to be used owing to deletion of the album or the like, and outputs a status code (Sta_002) that corresponds to the status thus detected. In response thereto, the status information extracting section 42 obtains, from the status determining section 30, data of “date of deletion” stored in the album information storage section 51 in association with the album ID (S109). Then, the status information extracting section 42 extracts the status information (“THIS ALBUM IS NOT AVAILABLE BECAUSE IT HAS BEEN DELETED ON @@_DATE OF DELETION_@@”) corresponding to the status code, and replaces this parameter part with the date of deletion that is obtained, whereby the status information is completed. The display control information generating section 44 fills the status information thus completed into the scripts for generating the album history screen (S110).

Further, the status determining section 30 refers to the album information storage section 51. If detecting that the date on which the album is requested is after the expiration date on publication of the album (YES in S108, NO in S111), then the status determining section 30 detects this status in which the expiration date of the album is expired, and outputs a status code (Sta_003) that corresponds to the status. The status information extracting section 42 obtains, from the status determining section 30, date of “expiration date” that is associated with the album ID (S112). Then, the status information extracting section 42 extracts status information (” PUBLICATION PERIOD EXPIRED ON @@_EXPIRATION DATE_@@ (PUBLICATION MAY BE RESUMED IN THE FUTURE)”) that corresponds to the status code, and replaces this parameter part with that obtained value of the expiration date, whereby the status information is completed. The display control information generating section 44 fills the status information thus completed into the script for generating the album history screen (S113).

Further, the status determining section 30 refers to the album information storage section 51. If detecting that the album creator sets the album so as not to be in publication (YES in S111, NO in S114), the status determining section 30 detects this status in which the album is not in publication, and outputs a status code (Sta_004) that corresponds to the status. The status information extracting section 42 extracts the status information (“PUBLICATION IS CURRENTLY STOPPED (PUBLICATION MAY BE RESUMED IN THE FUTURE)”) that corresponds to the status code. The display control information generating section 44 fills the status information into the script for generating the album history screen (S115).

Further, the status determining section 30 refers to the album information storage section 51 to retrieve the picture ID associated with the album ID obtained. If detecting that the album does not contain even one picture (YES in S114, NO in S116), then the status determining section 30 outputs a status code (Sta_005) that corresponds to this status thus detected. The status information extracting section 42 extracts the status information (“ALBUM CONTAINS NO PICTURE”) that corresponds to the status code. The display control information generating section 44 fills the status information into the script for generating the album history screen (S117).

On the other hand, if the status determining section 30 determines, on the contrary to the foregoing determination, that the album is available to be provided without any problem (YES in S116), then the display target data extracting section 43 identifies a picture as the display target data on the basis of the album ID. At this time, the album history screen is generated. Therefore, the first picture in display order among the pictures contained in the album is extracted from the display target data storage section 52 as a representative image (display target data). Further, necessary album information is obtained from the album information storage section 51. The display control information generating section 44 fills the display target specifying information for identifying the display target data, basic information on the album, and the like into the script for generating the album history screen, whereby the display control information is completed (S118). The foregoing status determination process is repeated for every album ID obtained.

On the other hand, if even one album ID is not obtained from the display data request message 6 as a result of the analysis of the display-target ID obtaining section 21 (NO in S105), then the display data generating section 40 generates the script for generating the album history screen for display the album history screen on which the message of “THERE IS NO HISTORY INFORMATION (ON THIS ALBUM)” is displayed.

Lastly, the display control information generating section 44 transmits, to the television 2 having made the request, the display data 7 containing: the display control information that contains all generated script for generating display screens; and all display target data extracted by the display target data extracting section 43 through the respective processes described above (S119).

FIG. 13 is a flowchart showing a flow of processes of providing the display data in the album managing server 1. In the case shown in FIG. 13, the display data request message 6 is received from the television 2, which display data request message 6 contains: three album IDs; information to designate the display screen C; and information to designate, among the three album IDs, a target to be displayed on the display screen C.

When the receiving section 11a (FIG. 1) of the album managing server 1 receives the display data request message 6 from the television 2 (YES in S201), the message analyzing section 20 analyzes the display data request message 6 received.

The display-target ID obtaining section 21 obtains three album IDS contained in the display data request message 6 (S202).

The designated display screen obtaining section 22 obtains the information, contained in the display data request message 6, on the type of the display screen requested by the television 2 (S203). In the present case, the display screen C is obtained as the display screen designation information.

At this time, the display screen designation information indicates the display screen C, so that the display-target ID obtaining section 21 obtains, from the data D4 shown in FIG. 5, the information on a target album ID (S204).

Then, the status determining section 30 carries out the status determination process on the album identified by the target album ID obtained. Here, the status determination process is carried out on the first album ID among those three album IDs (S205 to S216). Details of the status determination process from S205 to S216 are same as the status determination process from S106 to S117 shown in FIG. 12. Therefore, description thereof is omitted.

If the status determining section 30 determines, as a result of the status determination processes of S205 to S216, that the target album is not available to be provided, then the display data generating section 40 generates, instead of generating the display data on the display screen C to display the album, the display data on the album history screen in regard to those three albums identified in S202.

More specifically, the status information extracting section 42 extracts suitable status information in a manner responsive to the status code that the status determining section 30 provides. The display control information generating section 44 generates, instead of generating the album information, the first history information 181a (FIG. 10) containing the status information on the album.

Then, the status determining section 30 moves to the processes of generating the display screen A, which processes are shown in FIG. 12, and executes the status determination process on the remaining two albums. The display control information generating section 44 generates, for the remaining two albums, the second history information 181b and the third history information 181c that are responsive to the status determination result of the status determining section 30, whereby the script for generating the album history screen is completed.

On the other hand, if the status determining section 30 determines, as a result of the status determination processes of S205 to S216, that the target album is available to be provided (YES in S215), then the display target data extracting section 43 extracts, from the display target data storage section 52, the pictures (display target data) contained in the target album, and extracts necessary album information from the album information storage section 51. The display control information generating section 44 fills this contents extracted by the display target data extracting section into the pattern data identified in the manner as described above, thereby generating the display control information for displaying the display screen C. Then, the display data combining section 45 combines the display target data extracted by the display target data extracting section 43 and the display control information together to generate the display data to display the album-picture display screen (S217). The transmitting section 11b (FIG. 1) transmits this generated display data of the display screen C (album-picture display screen) to the television 2, which has requested the display data request message 6 (S218).

As the foregoing describes, when the target album is not available to be provided, the album managing server 1 provides, instead of providing the display data to display the album-picture display screen to display the target album, the television 2 with the display data to display the album history screen containing the status information that indicates to the users why the album is not available to be provided.

The television 2 can therefore obtain, when the album the television 2 has requested is not obtainable, not only information indicating that the album is not obtainable, but also the status information indicating in what status the album is, and indicate to the users those information thus obtained.

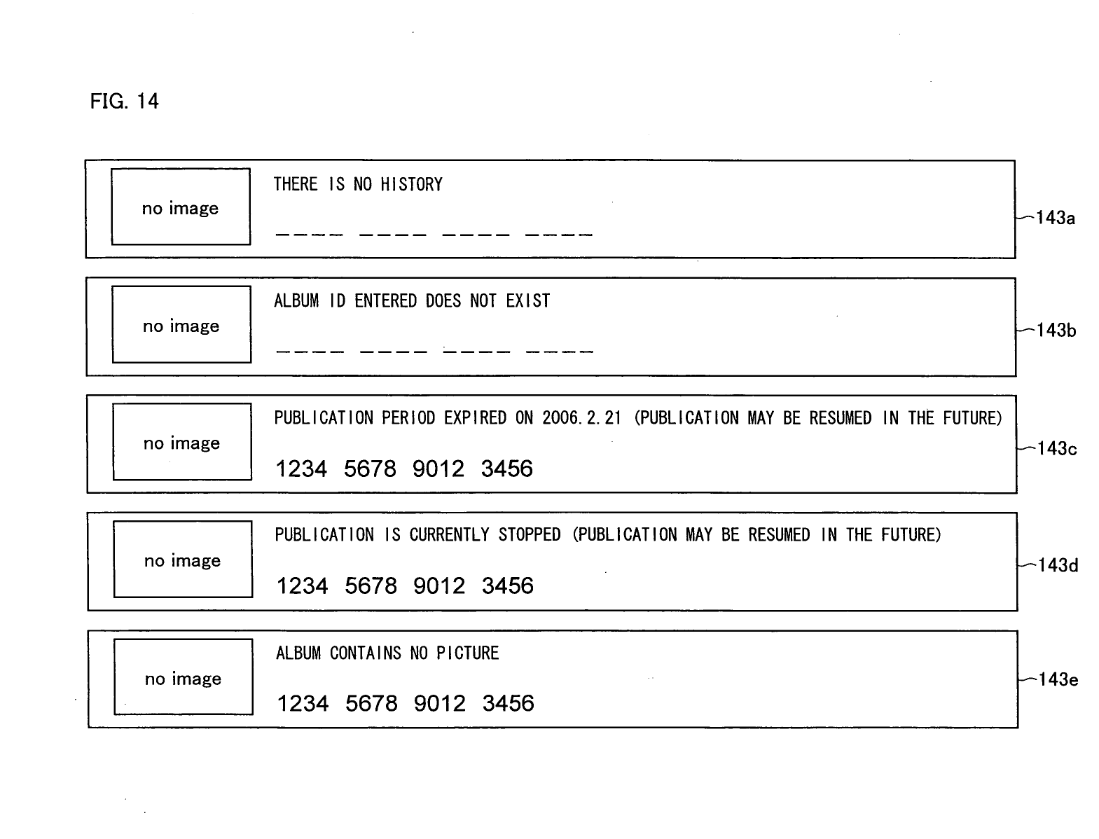

FIG. 14 shows an example of how the status information on the album is displayed on the television 2 having received, from the album managing server 1, the display data containing the status information. Album information display areas 143a to 143e show variations on how the status information on the album is displayed in the album information display area 143 in the display screen A shown in FIG. 4(a), instead of a display of the album information.

The album information display area 143a is to be generated in S120 (FIG. 12) when the album ID is not identified. If all of three album IDs requested via the display data request message 6 are empty, the album information display area 143a is filled into the album information display area 143 in the first area 141 (FIG. 4(a)). If only one or two of the album IDs are identified, the display control information generating section 44 may generate display control information for the album information display area 143a to be displayed in the rest of the areas in which no album is identified.

The album information display area 143b is to be generated in S107 (FIG. 12) or in S206 (FIG. 13) when the status determining section 30 determines that the album ID identified is not stored in the album information storage section 51. The status information, as described above, is filled that is extracted from the status information storage section 54 by the status information extracting section 42 and is responsive to the status of the album, which status is determined by the status determining section 30.

The album information display area 143c is to be generated in S113 (FIG. 12) or in S212 (FIG. 13) when the status determining section 30 determines that the expiration date on publication of the album of the album ID identified is expired.

The album information display area 143d is to be generated in S115 (FIG. 12) or in S214 (FIG. 13) when the status determining section 30 determines that the album of the album ID identified is set so as to be not in publication.

The album information display area 143e is to be generated in S117 (FIG. 12) or in S216 (FIG. 13) when the status determining section 30 determines that the album of the album ID identified does not contain even one picture.

Thus, when receiving the display data 7 containing the status information from the album managing server 1, the television 2 displays, on the basis of the display control information contained in the display data 7, the album history screen on which the status information is displayed. This allows the users to know why the users cannot browse a desired album when the desired album is not available to be browsed, so that the convenience of the users improves.

The following describes the details of the television 2 that generates the display data request message 6, provides the request for data on the display screen to the album managing server 1, and displays, in accordance with the display data generated by the album managing server 1, the album with the display screen that the television 2 requests.

[Configuration of Television]

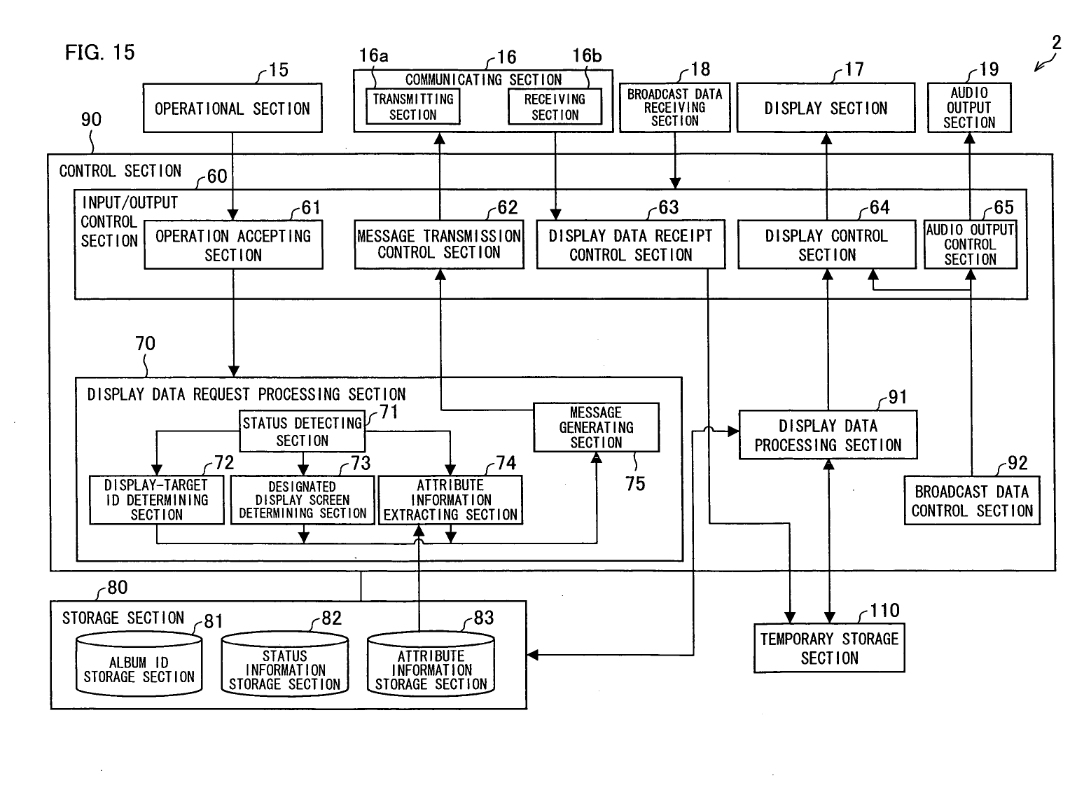

FIG. 15 is a block diagram showing a configuration of a main part of the television 2 in accordance with an embodiment of the present invention. As described in FIG. 2, the television 2 transmits the display data request message 6 to the album managing server 1, obtains the display data 7, and displays the display data. As shown in FIG. 15, the television 2 includes an operational section 15, a communicating section 16, a display section 17, a broadcast data receiving section 18, an audio output section 19, a control section 90 to control the television 2 overall, a storage section 80, and a temporary storage section 110.

The control section 90 controls various operations of the respective sections included in the television 2. The control section 90 includes inside an input/output control section 60, a display data request processing section 70 to generate the display data request message 6, a display data processing section (display data processing means) 91 to process the display data 7 received, and a broadcast data control section 92 to control the broadcast data receiving section 18 and extract audio data and visual data from the broadcast data received. The control section 90 reads out various programs stored in the storage section 80 to control the respective sections of the television 2 of the present invention and to carry out various processes to display the albums.

The storage section 80 stores: a control program and an OS program that are to be executed by the control section 90; a photo application program for carrying out various processes of the control section 90 to process the display data to display the album; and various data to be read out when the various processes are carried out. The storage section 80 is configured with a nonvolatile memory device such as a flash memory. The various data are respectively stored in various storage sections inside of the storage section 80. Specifically, the various data are stored in an album ID storage section 81, a status information storage section 82, and an attribute information storage section 83. The broadcast data received is stored in a broad data storage section, which is not illustrated, of the storage section 80.

The temporary storage section 110 is utilized in temporarily storing a work area to process programs and various data. In the present embodiment, the temporary storage section 110 is also utilized in temporarily storing the display data 7 obtained from the album managing server 1. The temporary storage section 110 is realized by a volatile memory such as a RAM (random access memory). Various information (e.g. numbers in album ID) supplied by the users via the operational section 15 may be temporarily stored in the temporary storage section 110.

The communicating section 16 communicates, via a communications network, with respective apparatuses outside of the television 2 and in the network album system 100. The communicating section 16 includes inside a transmitting section 16a and a receiving section 16b.

Concretely, the transmitting section 16a transmits, to the album managing server 1, the display data request message 6 generated by the display data request processing section 70. The receiving section 16b receives the display data 7 (FIG. 2) supplied from the album managing server 1. The display data 7 received via the receiving section 16b is temporarily stored in the temporary storage section 110. The display data 7 is read out by the input/output control section 60 or the display data processing section 91 when necessary.

The display section 17 displays various data stored in the television 2, which data includes display data processed by the display data processing section 91. The display section 17 is configured with a display apparatus such as an LCD (liquid crystal display), a PDP (plasma display panel), and a CRT (cathode-ray tube) display.

The operational section 15 is used by users to input an instruction signal to operate the television 2. The operational section 15 is configured with, for example, a remote controller to operate the television 2 remotely, an operational button provided to the television 2, or a mouse or a keyboard connected to the television 2 with or without a wire. The instruction signal supplied by the user via the operational section 15 is transmitted to the respective sections of the control section 90 via the input/output control section 60. The foregoing allows the user to operate the television 2.

The broadcast data receiving section 18 receives broadcast data (audio data or visual data of TV programs, or information such as electronic program guide) transmitted from broadcasting stations via broadcasting waves. The broadcast data receiving section 18 is configured with a tuner, a demodulating section, a TS (transport stream) decoder, and the like. The broadcast data received by the broadcast data receiving section 18 is decoded and then stored in a broadcast data storage section (not illustrated) of the storage section 80 via the input/output control section 60.

The audio output section 19 is realized as a speaker to output audio data contained in the broadcast data.

The input/output control section 60 controls input and output of information between (i) the respective sections (operational section 15, communicating section 16, display section 17, broadcast data receiving section 18, audio output section 19) of the television 2 and (ii) the display data request processing section 70, the display data processing section 91, or the broadcast data control section 92 in the control section 90. The input/output control section 60 includes an operation accepting section 61, a message transmission control section 62, a display data receipt control section 63, a display control section (display control means) 64, and an audio output control section 65.

The operation accepting section 61 receives the instruction signal supplied by the user via the operational section 15, and transmits this instruction to the respective sections of the display data request processing section 70. Specifically, when the user supplies, via the operational section 15, the television 2 with an instruction signal (instruction signal to display a display screen) to display a desired display screen, an instruction signal to generate the display data request message 6 is transmitted to the display data request processing section 70.

The message transmission control section 62 controls the transmitting section 16a of the communicating section 16 so that the transmitting section 16a transmits the display data request message 6 generated by the display data request processing section 70. The display data receipt control section 63 receives the display data 7 that the receiving section 16b of the communicating section 16 receives from the album managing server 1. The display data 7 is stored in the temporary storage section 110 by the display data receipt control section 63.

The display control section 64 controls the display section 17 so that various data stored in the storage section 80 are displayed on the display section 17. The display control section 64 reads out the display data stored in the temporary storage section 110, and causes the display target data contained in the display data to be displayed in accordance with the display control information also contained in the display data. More specifically, the display data processing section 91 analyzes the display control information, and the display section 17 displays the pictures or the status information in accordance with a result of this analysis (e.g. coordination information on an initial point to position the display target data, display target specifying information to identify the display target data associated with the coordinate information, status information in which text data is filled).

Alternatively, visual data contained in the broadcast data is obtained from the broadcast data control section 92, and supplied to the display section 17. By this way, the visual data among the broadcast data received by the television 2 is provided to the users The audio output control section 65 controls the audio output section 19 so as to output only audio data, among the broadcast data stored in the storage section 80. The audio data is obtained from the broadcast data control section 92, and supplied to the audio output section 19. By this way, the audio data among the broadcast data received by the television 2 is provided to the user.

The broadcast data receiving section 18, the audio output section 19, the audio output control section 65, and the broadcast data control section 92 are configurations in the case in which the image display apparatus of the present invention is applied to the television 2. Therefore, those sections are not to limit the configurations of the image display apparatus of the present invention. If the image display apparatus is not to be realized by the television 2, the image display apparatus does not necessarily have to include those sections.

The display data request processing section 70 generates the display data request message 6. The display data request processing section 70 generates the display data request message 6 responsive to an operational status of the television 2 and/or a signal of an instruction from the user to display a display screen.

The display data request processing section 70 includes a status detecting section 71, a display-target ID determining section 72, a designated display screen determining section 73, an attribute information extracting section 74, and a message generating section (message generating means) 75.

The status detecting section 71 detects a predetermined operation status of the television 2, and controls respective sections of the display data request processing section 70 in such a manner that the respective sections of the display data request processing section 70 starts generating the display data request message 6 in response to this detection.

The following are exemplary predetermined operational statuses of the television 2 that are to be detected by the status detecting section 71: when a power source of the television 2 is given; when the photo application program is activated; when a particular operational button of the operational section 15 is pressed while a predetermined display screen is displayed; and when an instruction signal is received. The operation statuses to be detected by the status detecting section 71, however, are not limited to those discussed above. The status detecting section 71 detects any operation statuses or events that are triggers to generate the display data request message 6.

The display-target ID determining section 72 determines the display target data to be requested to the album managing server 1, and obtains the display-target ID for the display target data. Concretely, the display-target ID determining section 72 obtains, from the album ID storage section 81, the album IDs to be stored in the data D1 to D3 of the display data request message 6 shown in FIG. 5.

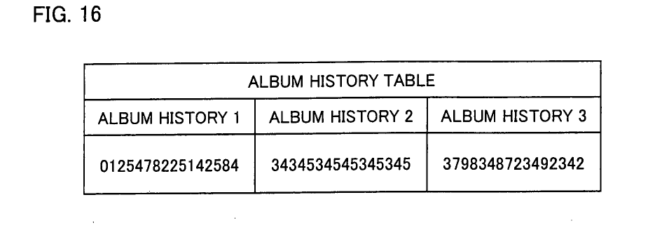

FIG. 16 shows an exemplary album history table to be stored in the album ID storage section 81. In the album history table, the album IDs of the albums accessed in the past via the television 2 are stored.

In the present embodiment, the history information of a maximum of three albums can be displayed on the album history screen (FIG. 4(a)). Accordingly, three album IDs are to be stored in the album history table shown in FIG. 16, in an order in which the albums are browsed recently.

When receiving an instruction from the status detecting section 71, the display-target ID determining section 72 obtains the album ID stored in the album ID storage section 81. If, in terms of the status detected by the status detecting section 71, the display data to request is irrelevant to the display data to display the album, the display-target ID determining section 72 does not necessarily have to obtain the album ID from the album ID storage section 81.

The album IDs determined by the display-target ID determining section 72 constitute the data D1 to data D3 of the display data request message 6 shown in FIG. 5.

When detecting, on the basis of the status detected by the status detecting section 71, that the display data to be requested is the display screen C (album-picture display screen), the display-target ID determining section 72 generates target information that indicates which one of the album IDs obtained by the above method is the album ID to be targeted.

The display-target ID determining section 72 determines the album ID to be targeted, in a manner responsive to the operation status detected by the status detecting section 71. For example, if the user manually enters the album ID with the operational section 15 while the display screen B (album ID input screen) is being displayed, the album ID entered via the operation accepting section 61 is transmitted to the display-target ID determining section 72. The display-target ID determining section 72 determines this entered album ID as the album ID to be targeted.

The target information determined by the display-target ID determining section 72 constitutes the data D4 of the display data request message 6 shown in FIG. 5.

The designated display screen determining section 73 determines the type of the display screen that is to be designated by the display data request message 6, among the display screens shown in FIGS. 4(a) to 4(c). The designated display screen determining section 73 determines which display screen is to be requested, in a manner responsive to the operation status detected by the status detecting section 71.

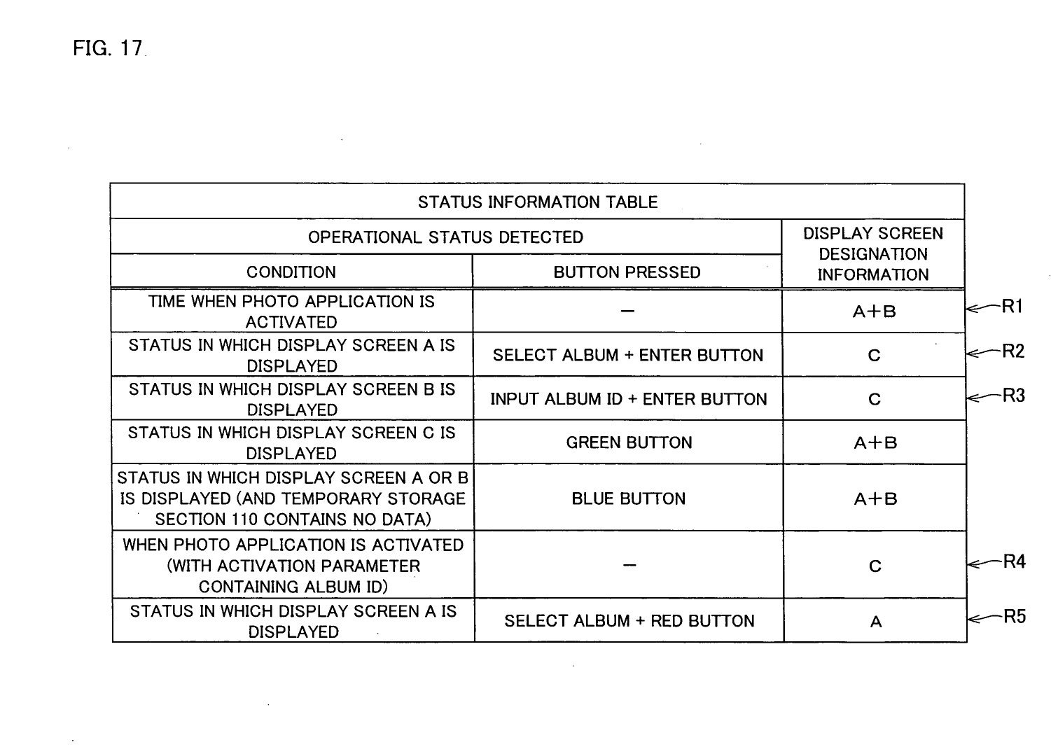

FIG. 17 shows an exemplary status information table to be stored in the status information storage section 82. In the status information table, the operational statuses of the television 2, which operational statuses are to be detected by the status detecting section 71, are associated with the display screens to be requested at those statuses, respectively.

For example, when the status detecting section 71 detects that a photo application executing section (not illustrated) of the control section 90 activates a photo application program, the designated display screen determining section 73 determines the display screens A and B as the display screen designation information.

The display screen designation information determined by the designated display screen determining section 73 constitutes the data D5 of the display data request message 6 shown in FIG. 5.

The attribute information extracting section 74 obtains, from the attribute information storage section 83, information that is necessary to generate the display data request message 6, among various attribute information on the television 2, which attribute information is registered in advance. Exemplary attribute information to be stored in the attribute information storage section 83 includes: information on the devices of the television 2 (e.g. specification information of the television 2); information on the users of the television 2 (e.g. age and address of user); and information on the settings of the operations of the television 2 (e.g. intervals between displays in slideshow, with or without repeat reproduction).

For example, the apparatus ID extracted from T6 of the attribute information storage section 83 by the attribute information extracting section 74 constitutes the data D6 of the display data request message 6 shown in FIG. 5. The audience residence extracted from T7 constitutes the data D7. The audience age extracted from T8 constitutes the data D8.

The message generating section 75 generates the display data request message 6 containing various information to request the display data, which various information is obtained by the display-target ID determining section 72, the designated display screen determining section 73, and the attribute information extracting section 74 in accordance with instructions from the status detecting section 71. The display data request message 6 (FIG. 5) generated by the message generating section 75 is transmitted from the transmitting section 16a to the album managing server 1 via the message transmission control section 62.

[Processes in Television]

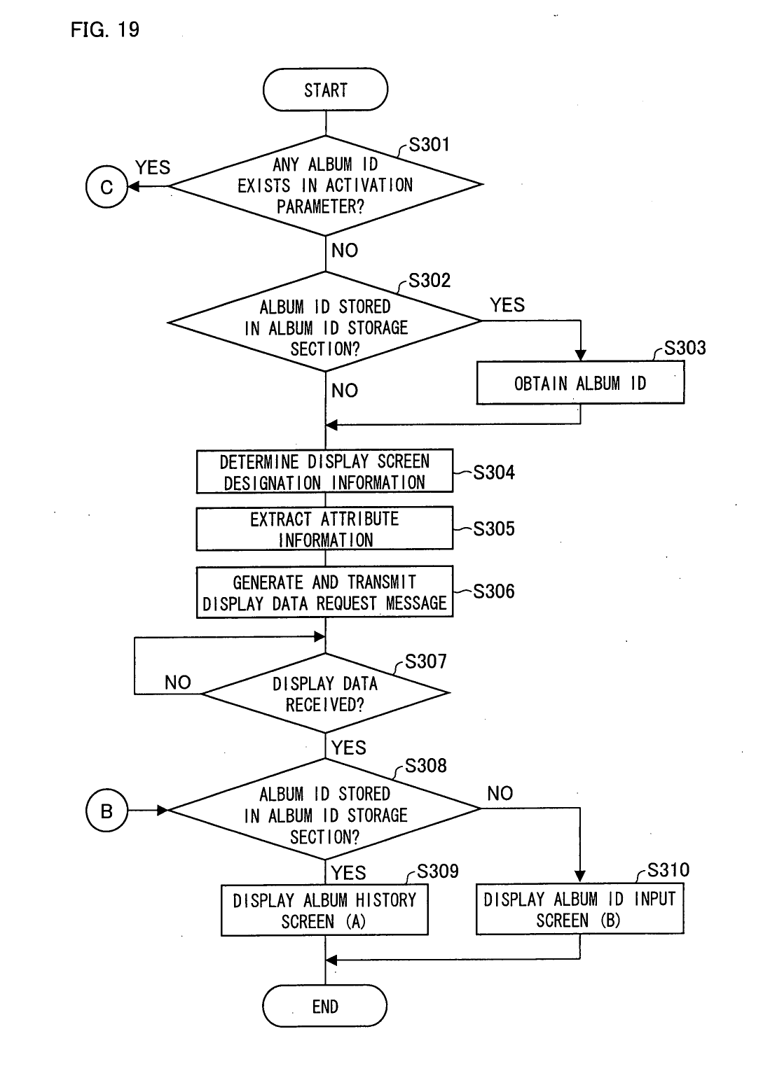

FIG. 19 is a flowchart showing a flow of processes in requesting and displaying the display data in the television 2. With FIG. 19, a case is discussed in which, when a photo application of the television 2 is activated (status of R1 shown in FIG. 17), the display screens A and B are requested, and one of the display screens A and B is displayed.

When a photo application executing section (not illustrated) of the control section 90 (FIG. 15) executes a photo application program, the status detecting section 71 sends an instruction to the respective sections of the display data request processing section 70 to generate the display data request message 6. At this time, the status detecting section 71 may determine presence or absence of an activation parameter at the time of activation of the photo application (S301). The step of S301 and the activation parameter will be discussed later.

The display-target ID determining section 72 refers to the album ID storage section 81 and determines whether the album ID is stored or not (S302). If determining that the album ID is stored (YES in S302), the display-target ID determining section 72, for example, obtains, in the order in the history, the album IDs from the album history table shown in FIG. 16 or the like (S303). If the album ID is not stored in the album ID storage section 81, the display-target ID determining section 72 does not obtain the album ID and determines the values to be filled into the data D1 to data D3 at NULL values (or value to indicate that the album ID is empty).

The designated display screen determining section 73 refers to the status information storage section 82 and determines which display screen is to be requested, on the basis of the operational status detected by the status detecting section 71 (S304). For example, the designated display screen determining section 73 refers to the status information table stored in the status information storage section 82 shown in FIG. 17. Here, the status detecting section 71 detects in S301 activation of the photo application program, so that, as shown in R1, the designated display screen determining section 73 determines the display screens A and B as the display screen designation information.

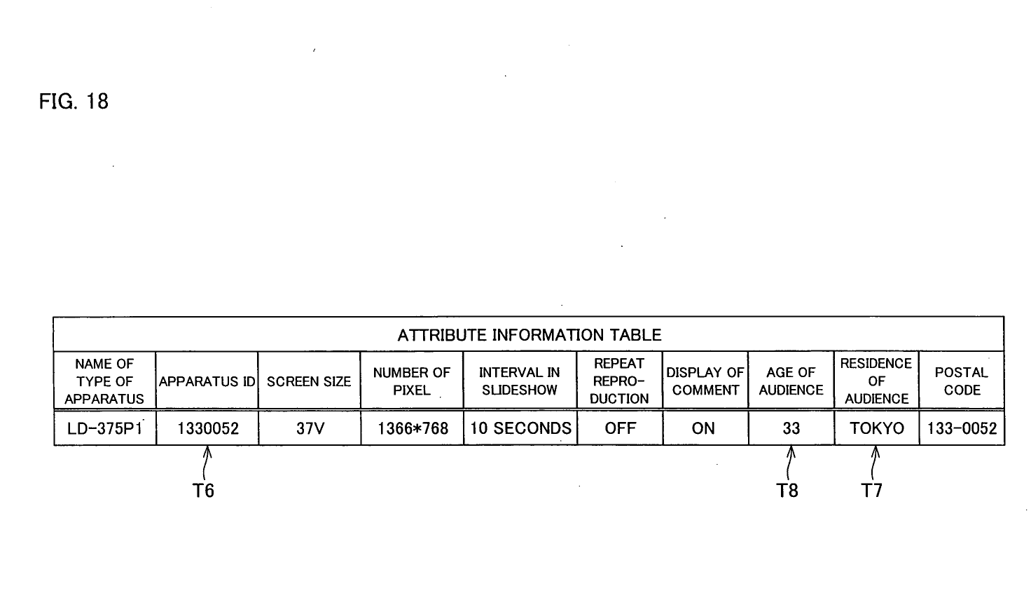

Then, if any attribute information needs to be added to the display data request message 6, the attribute information extracting section 74 may extract necessary attribute information from the attribute information storage section 83 (FIG. 18), when necessary (S305).

Lastly, the message generating section 75 generates the display data request message 6 (FIG. 5) that contains the above-described various information determined or extracted by the respective sections. The message transmission control section 62 controls the transmitting section 16a so that the display data request message 6 generated by the message generating section 75 is transmitted to the album managing server 1 (S306).

When the receiving section 16b receives the display data 7 in response to the display data request message 6 transmitted (YES in S307), the display data 7 thus received is temporarily stored in the temporary storage section 110 via the display data receipt control section 63. The display data 7 received by the television 2 is the display data 7 that is generated by the album managing server 1 through the processes shown in FIG. 12 and is to display the display screens A and B.

When the display data 7 is newly stored in the temporary storage section 110, the display data processing section 91 refers to the album ID storage section 81 and determines whether the album ID is stored or not (S308). If determining that the album ID is stored (YES in S308), the display data processing section 91 takes out, from the temporary storage section 110, the display data on the display screen A to display the history information on the album of the album ID stored. Then, the display data processing section 91 provides the display data on the display screen A to the display control section 64. The display control section 64 controls the display section 17 so that the display screen A is displayed in accordance with the display control information contained in the display data provided (S309).

On the other hand, if determining that the album ID is not stored (NO in S308), the display data processing section 91 takes out the display data on the display screen B. The display control section 64 controls the display section 17 so that the display screen B is displayed (S310).

At this time, if the album IDs determined by the display-target ID determining section 72 include the album ID of the album that the album managing server 1 cannot provide, the status information that indicates the situation in which the album cannot be provided is shown in the album information display area 143 (FIG. 4(a)) for the album ID.

Seeing the status information, the user is notified that the album is not obtainable and why the desired album is not obtainable. This allows the user to carry out an appropriate process. Thus, the convenience of the users improves.

Further, as described above, if receiving the display data 7 for displaying a plurality of display screens, the display data processing section 91 can determine which display screen should be displayed, in a manner responsive to the status of the television 2 (in this case, whether or not the album ID in the history is stored).

Specifically, when the display screens A and B are received, if the album ID in the history is stored, it is convenient for the users if the display screen A, which displays information on the album of the album ID, is displayed first, because the users may select again the album they browsed in the past. If, however, the album ID in the history is not stored, the display screen A merely displays that “THERE IS NO HISTORY”, which provides no useful information to the users. In this case, it is more convenient for the users if the display screen B, with which the album can be designated by manual input, is displayed rather than the display screen A.

Accordingly, a most suitable display screen is selected and displayed in a manner responsive to the status of the television 2, so that the convenience of the users improves.

The display control information contains the status transition definition information for transition from one of the display screens to the other one of the display screens. Therefore, although one of the display screens is displayed, the television 2 can display the other one of the display screens when the users select, with the use of the operational section 15, the operational buttons or the like that are displayed on the first display screen.

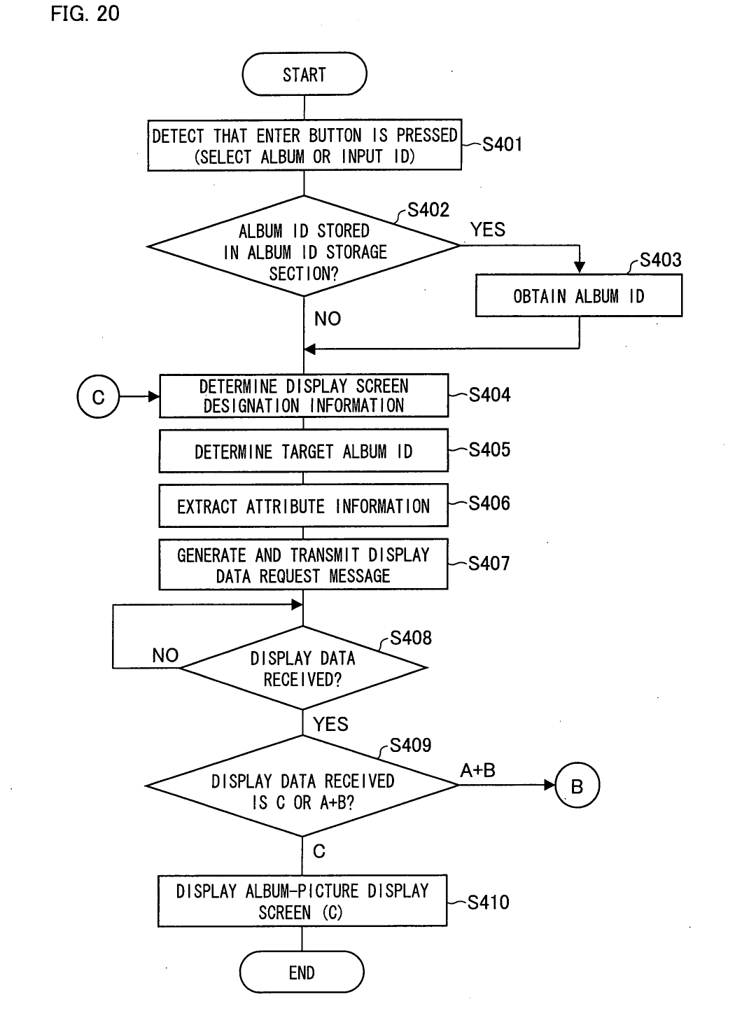

FIG. 20 is a flowchart showing a flow of processes of requesting and displaying the display data in the television 2. FIG. 20 describes a case in which the display screen C is requested and displayed when the enter button provided in the operational section 15 of the television 2 is pressed (status of R2 or R3 shown in FIG. 17).

Note that, by pressing the enter button while the television 2 is in a predetermined operational state, the user can instruct the television 2 to request the display data to display the album designated (or album of an album ID that is manually entered). At this time, the album ID of the album designated is stored on the album history table in the album ID storage section 81, and managed as an album ID designated lately.

The following discusses a case in which, with the display screen A (FIG. 4(a)) being displayed on the display section 17 and one of three album information display areas 143 in the first area 141 being selected, the enter button of the operational section 15 is pressed. The case may be a case in which the enter button is pressed while the display screen B (FIG. 4(b)) is displayed on the display section 17, and while numbers that constitute the album ID are entered in the respective text boxes 148.

The status detecting section 71 detects that the enter button is pressed during the foregoing status, and sends an instruction to respective sections of the display data request processing section 70 to generate the display data request message 6 (S401). The flow of processes S402 to S407 of generating the display data request message 6 by the respective sections of the display data request processing section 70 are same as those in S302 to S306 shown in FIG. 19. Therefore, description thereof is omitted. The following describes only different points from the flow of processes shown in FIG. 19.

On the basis of information on operations (R2 or R3 in FIG. 17) detected by the status detecting section 71, the designated display screen determining section 73 determines to request the display screen C (S404). The display-target ID determining section 72 determines the display screen C of which album (album to be targeted) is to be requested. Alternatively, the album ID of the target is identified (S405).

If the display data 7 is received in response to the display data request message 6 sent by the transmitting section 16a (YES in S408), the display data 7 received is temporarily stored in the temporary storage section 110 via the display data receipt control section 63. Note that the display data 7 received by the television 2 is the display data 7 that is generated through the processes shown in FIG. 13 by the album managing server 1 and is to display the display screen C. Alternatively, the display data 7 is the display data 7 that is generated through the processes shown in FIGS. 13 and 12 and is to display the display screens A and B when the album managing server 1 is unable to provide the target album.

If the display data 7 is newly stored in the temporary storage section 110, the display data processing section 91 determines whether the display data 7 is to display the display screen C or to display the display screens A and B (S409).

If the display data processing section 91 determines that the display data 7 received is to display the display screens A and B (A+B in S409), then the flow of processes moves to S308 in FIG. 19 to execute the processes of displaying the display screens A and B. On the other hand, if the display data processing section 91 determines that the display data 7 received is to display the display screen C (C in S409), then the display data processing section 91 takes out the display data for the display screen C from the temporary storage section 110 to provide the display data to the display control section 64. The display control section 64 controls the display section 17 so that the display screen C is displayed in accordance with the display control information contained in the display data provided (S410).

With the foregoing way, when the album managing server 1 is unable to provide the target album, not only an error is shown to the user in response to the request for the display screen C, but also the display screen A is displayed to show, in the album information display area 143 (FIG. 4(a)) for the album ID, the status information that indicates why the album is not provided.

Seeing the status information, the user is notified that the desired album is not obtainable and why the desired album is not obtainable. This allows the user to carry out an appropriate process. Thus, the convenience of the users improves.

The status detecting section 71 may determine, when the photo application is activated, presence or absence of a content of an activation parameter contained in an activation instruction signal received by the operation accepting section 61 (S301 in FIG. 19). The activation parameter identifies the album ID of the album displayed on an initial display screen immediately after the photo application is activated. The activation parameter is received by the operation accepting section 61 and then forwarded to the display data request processing section 70.

If the status detecting section 71 determines that there is no album ID in the activation parameter received (NO in S301), then the flow moves to the processes in and after S302 (processes of requesting the display screens A and B that are initial display screens in a normal time). On the other hand, if the status detecting section 71 determines that there is the album ID in the activation parameter (YES in S301), then the flow moves to S404 in FIG. 20. Then, on the basis of a result of this determination carried out by the status detecting section 71 (R4 in FIG. 17), the designated display screen determining section 73 determines to make a request for the display screen C. Thereafter, the display target ID determining section 72 identifies, as the target album ID, the album ID indicated by the activation parameter received by the status detecting section 71 (S405). Thereafter, the television 2 carries out the steps above to obtain, as an initial display screen to be displayed immediately after the photo application is activated, the display screen C of the album identified by the activation parameter from the album managing server 1. (267)With this configuration and method, if supplied with an instruction to activate the photo application and the activation parameter identifying any of the albums, the television 2 makes a request for not a normal initial display screen (display screens A and B) but the display screen C for the album, on the basis of the activation parameter, and displays the display screen C as the initial display screen.

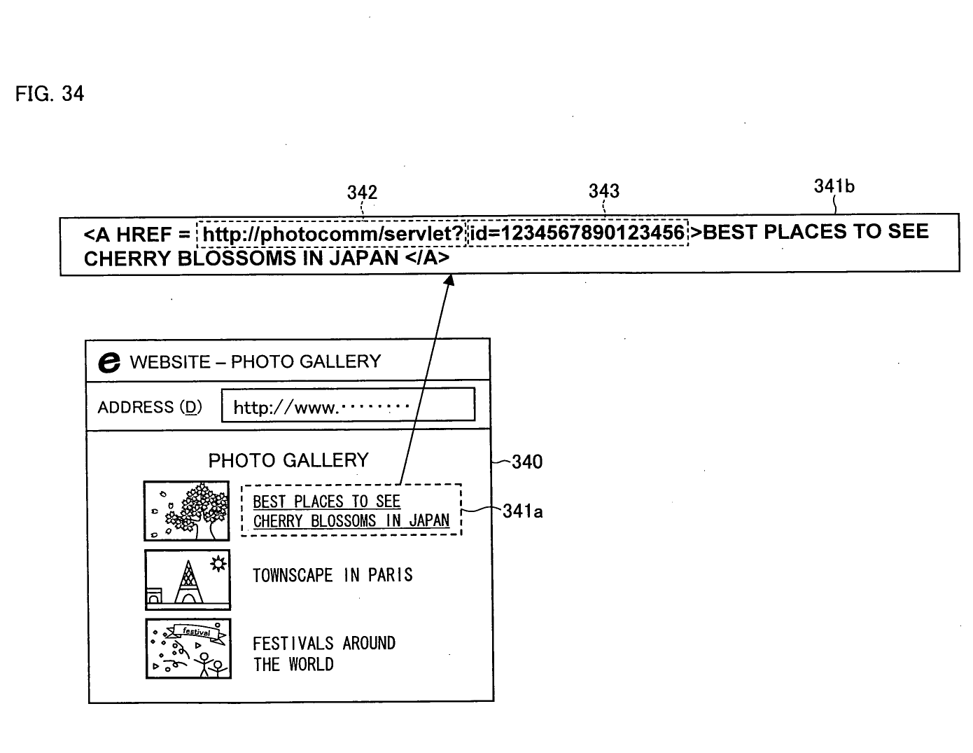

Thus, when specifying the album ID of the desired album and activating the photo application, the user can browse the display screen C of the desired album instantly without making a transition through the unnecessary display screen A (or B).
(269)The following is an exemplary way of user operation to specify the album ID and activate the photo application.
(270) FIG. 34 shows an exemplary Internet browser to be displayed on the display section 17 of the television 2 and an exemplary source of the link information displayed on the browser.

A browser 340 is displayed on the display section 17 of the television 2 connected to the Internet, showing a state in which a website is browsed. This website “Photo gallery” contains link information 341a on the links to the albums 5 uploaded on the album managing server 1 via the network album system 100 (FIG. 2).

A source 341b shows a concrete example of the source of the link information 341a. The link information contains a URL (uniform resource locator) 342, which is a special URL to instruct the television 2 to activate the photo application, and an album ID 343 to designate the album to be displayed on the initial display screen.

If the user operates the operational section 15 to select the link information 341a of the browser 340, the television 2 is supplied with the instruction to activate the photo application and the activation parameter (id=1234567890123456) to specify the album with the title “Best places to see cherry blossoms in Japan”.

### Modified Embodiment 1

### Case in which a Display Data Storage Section 84 is Included

In the foregoing embodiment, the television 2 is discussed that requests new display data 7 to the album managing server 1 each time when an operation to display the display screen is performed, without storing the display data 7 supplied from the album managing server 1 into the storage section 80, which is configured with a nonvolatile memory device. The configuration of the television 2 of the present invention, however, is not limited to that described above.

For example, it is possible that the storage section 80 is configured so as to include the display data storage section 84 to store the display data 7 received, and that the television 2 is configured so as to display the display data 7 stored in the display data storage section 84.

Thus, when performing operations to make a request to obtain a predetermined display screen and to display the predetermined display screen, the television 2 can, if the corresponding display screen is stored in the display data storage section 84, retrieve and display the corresponding display screen, instead of always making a request to the album managing server 1.

As a result, the volume of communications is reduced so that the load on the communication lines is reduced. Furthermore, processes of the album managing server 1 are reduced so that the load on the album managing server 1 is reduced.

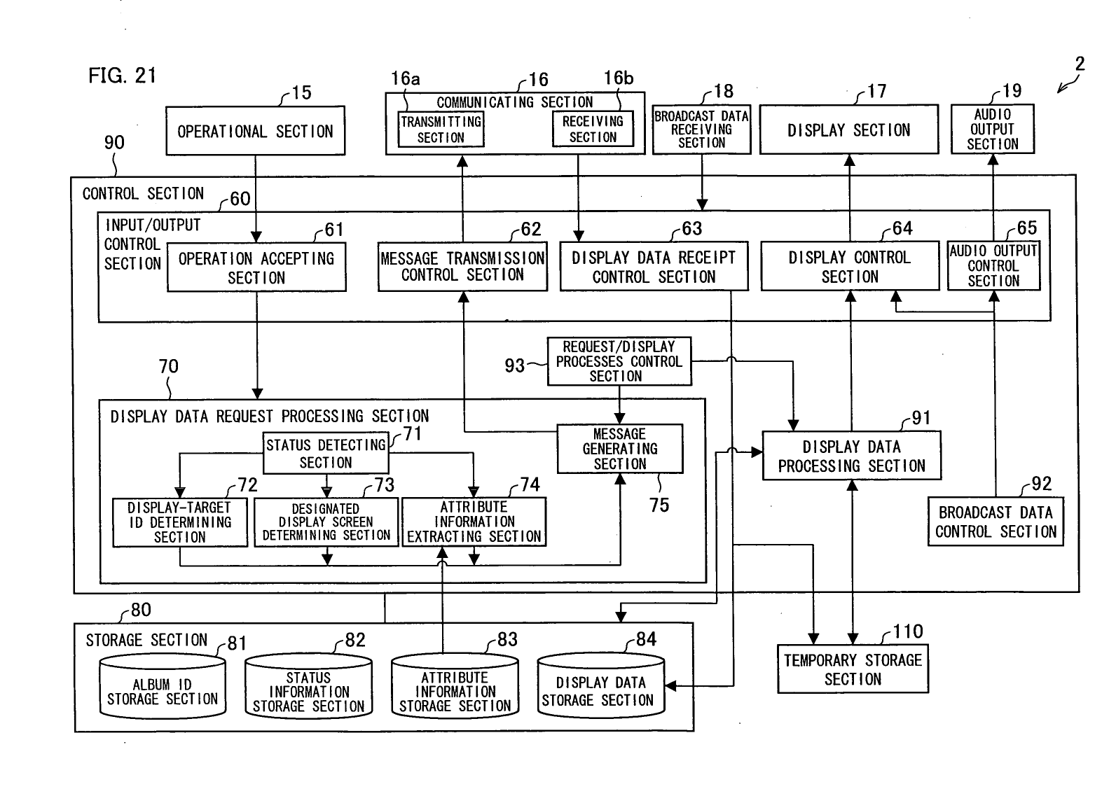

FIG. 21 is a figure showing a configuration of a main pat of the television 2, in a case in which a display data storage section 84 configured with a nonvolatile memory device is included.

The differences between the television 2 shown in FIG. 21 and that in FIG. 15 are: the storage section 80 includes a display data storage section 84 in which the display data 7 supplied from the album managing server 1 is to be stored; and the control section 90 includes the request/display processes control section 93.

The request/display processes control section 93 controls the message generating section 75 and the display data processing section 91 in accordance with the contents of the display data 7 stored in the display data storage section 84.

More specifically, when the display data request processing section 70 generates the display data request message 6 to start the process of requesting a predetermined display screen, the request/display processes control section 93 refers to the display data storage section 84 to determine whether the display screen that the television 2 intends to request is stored in the display data storage section 84. In other words, the request/display processes control section 93 determines whether the display screen determined by the designated display screen determining section 73 is stored in the display data storage section 84.

If the display screen to request is stored in the display data storage section 84, then the request/display processes control section 93 provides an instruction to the display data processing section 91 to display the display screen and provides an instruction to the message generating section 75 not to transmit the display data request message 6.

If the display screen to request is not stored, then the processes of requesting and displaying the display data 7 are carried out with the use of the same method as described above. The display data 7 thus received is temporarily stored in the temporary storage section 110, and at the same time, is stored in the display data storage section 84.

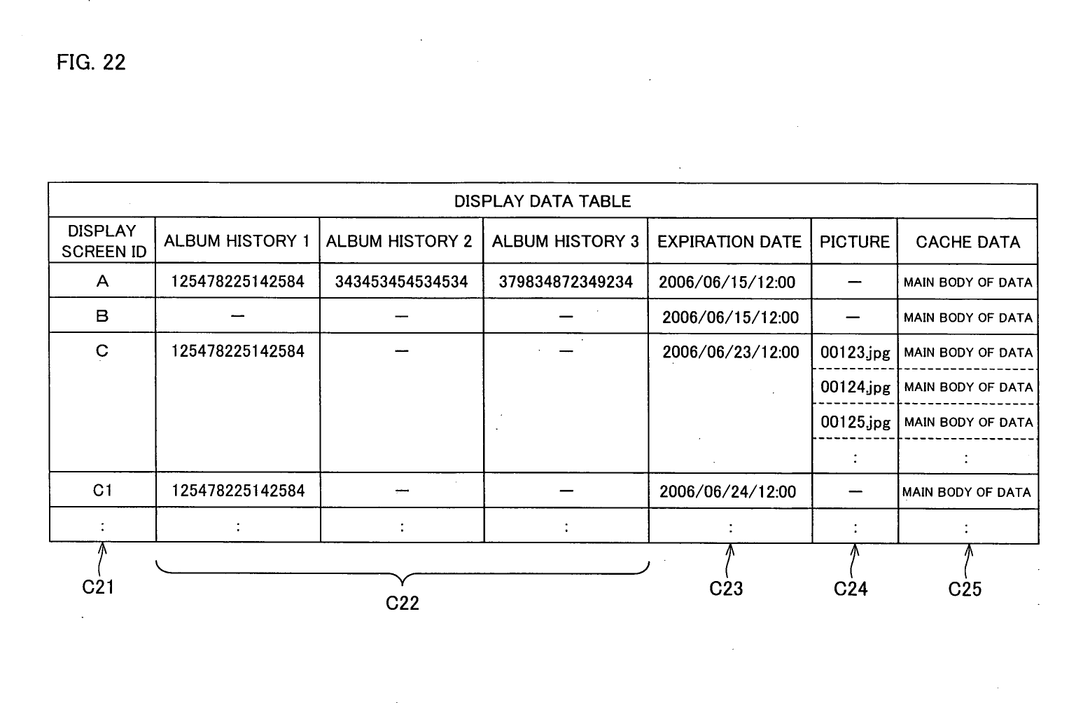

FIG. 22 is a figure showing an exemplary display-data table for managing the display data obtained from the album managing server 1, which display-data table is stored in the display data storage section 84.

As shown in FIG. 22, the display-data table contains, for each display screen ID (column C21) to identify the type of the display screen, information necessary to identify the contents to be displayed on the display screen (album IDs in the history (column C22) and picture IDs (column C24)), expiration date on use of the display screen (column C23), and a main body of the display data 7 for displaying the display screen (column C25).

The album ID in the history are stored in the column C22 because the display screen A is to display the history information on a maximum of three albums, and the contents of display are identified on the basis of the combination and the order of three album IDs. In the display screen C/C1, identification of one target album is sufficient. Therefore, the album ID is stored only in the first item of the column C22 (album history 1).

The picture IDs are stored in the column C24 because the display screen C (slideshow display screen) is to display one picture in one screen, and the contents of display are identified by the pictures contained in the album.

If a display screen to be requested is identified by the display-target ID determining section 72 and the designated display screen determining section 73, the request/display processes control section 93 determines, on the basis of the contents of the display-data table (FIG. 22) of the display data storage section 84, whether or not to make a request to the album managing server 1 for the display data 7 corresponding to the display data identified.

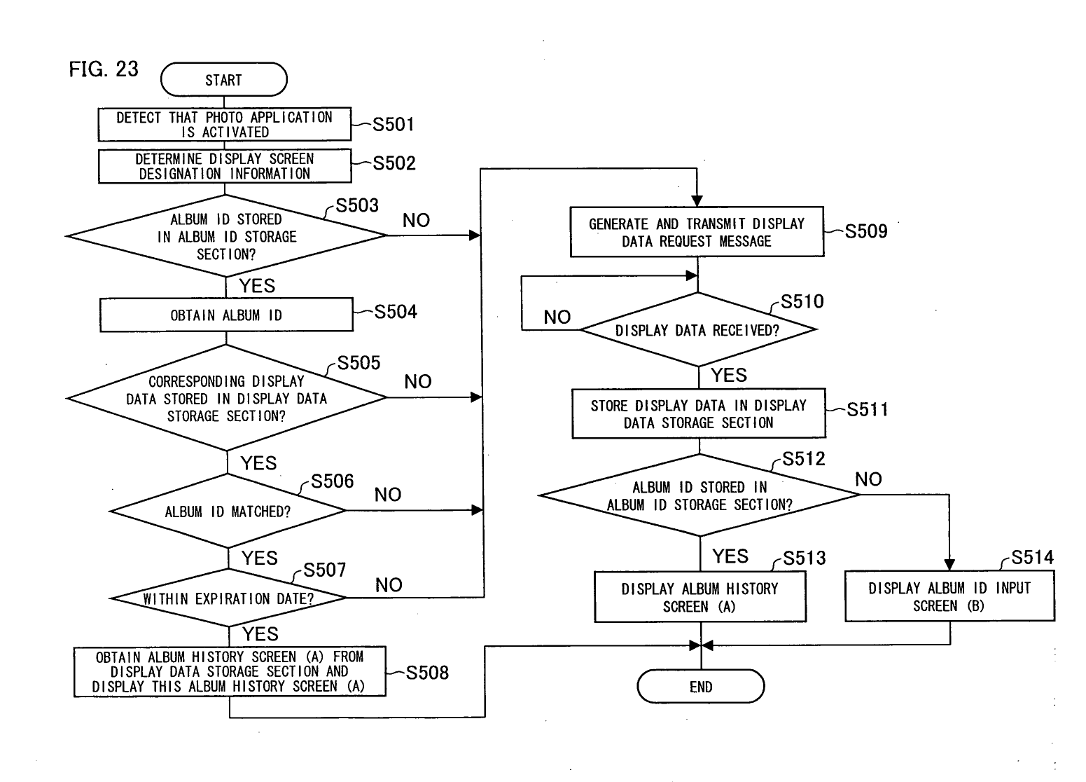

FIG. 23 is a flowchart showing a flow of processes of requesting and displaying the display data in the television 2 shown in FIG. 21.

Differences from the processes shown in FIG. 19 are the following two points. Only those different points from the processes shown in FIG. 19 are described below.

First, on the basis of the album ID stored in the album ID storage section 81, it is determined in the processes of requesting the display data (S501 to S509) whether or not the display data to be requested is stored in the display data storage section 84. If the display data is stored, then the display data is displayed without carrying out the process of requesting. This is one of the differences.

More specifically, if each of the display-target ID determining section 72 and the designated display screen determining section 73 determines necessary information, the request/display processes control section 93 refers to the display-data table, as shown in FIG. 22, stored in the display data storage section 84. Then, on the basis of the display screen ID of the display screen determined to be requested in S502 by the designated display screen determining section 73, it is determined whether or not the display data to be requested (displayed) is stored in the display data storage section 84 (S505).

If it is determined that the corresponding display data is stored (YES in S505), then the request/display processes control section 93 determines whether or not the album ID determined by the display-target ID determining section 72 matches the album ID of the display data determined as being stored (S506).

More specifically, the screens A and B are to be requested in the present case, so that, for example, the request/display processes control section 93 first confirms that the display screens A and B are stored. Then, the request/display processes control section 93 confirms that, in regard to the display screen A, the maximum of three album IDs obtained from the album ID storage section 81 match, including the order in the history, the maximum of three album IDs (FIG. 22) that are stored and associated with the display screen A.

Further, it is determined that the album IDs match (YES in S506), then the request/display processes control section 93 refers to the expiration date (FIG. 22) associated with the corresponding display data in the display data storage section 84, and determines whether or not the display data is currently valid (S507).

If it is determined that the display data is currently valid (YES in S507), then the request/display processes control section 93 transmits, instead of transmitting an instruction to the message generating section 75 to generate the display data request message 6, an instruction to the display data processing section 91 to carry out the process of displaying the display data stored in the display data storage section 84. Thus, the television 2 can display a desired display data stored in the television 2 (S508), without transmitting the display data request message 6 to the album managing server 1 in S509.

On the other hand, if the display data satisfying the conditions is not obtained in S505 to S507 from the display data storage section 84 (NO in S505 to S507), then the process moves to S509 so that the processes of generating and transmitting the display data request message 6 are carried out, because the desired display data is not obtained unless a request for the data is made to the album managing server 1.

The processes of displaying the display data (S510 to S514) as shown in FIG. 23 are different in that there is an additional process (S511) of storing the display data received into the display data storage section 84 in such a manner that the display data is associated with the album ID. Therefore, next time when the process of requesting the same display data is carried out, it is possible to display the desired display data by reading out the data stored in the display data storage section 84 of the television 2, instead of making a request for the data to the album managing server 1. This reduces the load on the communication lines or on the album managing server 1.

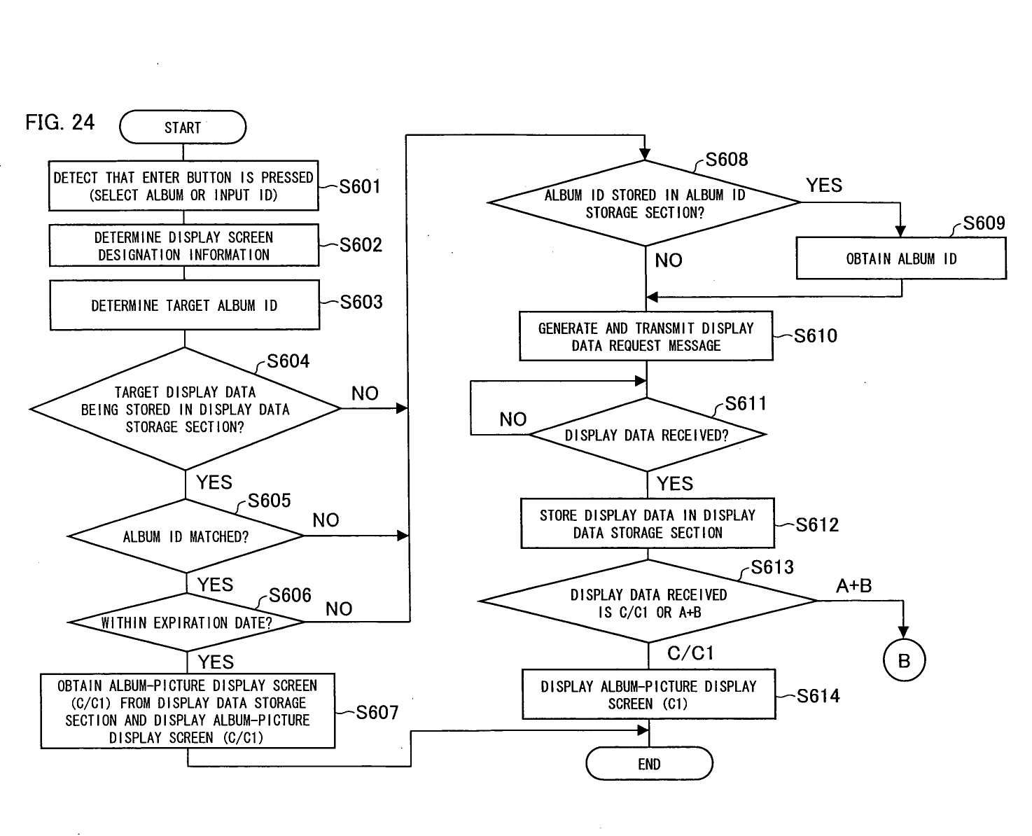

FIG. 24 is a flowchart showing a flow of processes in requesting and displaying the display data in the television 2 shown in FIG. 21.

The differences from the processes shown in FIG. 20 are the following points. One of the differences is that, before the processes of referring to the album ID storage section 81 and obtaining the album ID to generate the display data request message 6 (S608, S609) are carried out, determination is carried out, on the basis of the album ID of the album to be requested (target album), on whether or not the desired display data is stored in the display data storage section 84. Another one of the differences is that there is an additional process of storing the display data received into the display data storage section 84.

In the processes of requesting the display data (S601 to S610), the request/display processes control section 93 first determines, on the basis of the album ID of the target album determined by the display-target ID determining section 72 and the display screen ID of the display screen that the designated display screen determining section 73 determines to request (display), whether the display data satisfying the conditions is stored in the display data storage section 84 (S604 to S606). The processes of determination to be carried out by the request/display processes control section 93 are same as the processes of S505 to S507 described above. Therefore, the description thereof is not repeated. Here, the display screen C is to be requested, so that it is sufficient in S605 that one album ID of the target matches.

If the corresponding display data is stored in the display data storage section 84, then the display data processing section 91 reads out the corresponding display data from the display data storage section 84 and causes the display section 17 to display (S607). On the other hand, it the corresponding display data is not stored in the display data storage section 84, then the display data request message 6 generated by the message generating section 75 is transmitted to the album managing server 1 via the transmitting section 16a (S610).

Thus, when the processes of requesting the display data that is already obtained is carried out again, it is possible to display the desired display data by, instead of making a request to the album managing server 1, reading out the data stored in the display data storage section 84 of the television. This makes it possible to reduce the load on the communication lines and on the album managing server 1.

### Modified Embodiment 2

### Managing Stored Album ID

The display data processing section 91 of the television 2 may include, in addition to the above-described function to transmit the display data received to the display control section 64 so as to cause the display section 17 to display the data, functions of carrying out various processes on the basis of the display data received.

For example the following function may be included. If it is determined as a result of an analysis of the display data that the display data contains the status information indicating that the album requested is not available to be provided, then the album ID associated with the status information is determined as being invalid, and the album ID stored in the album ID storage section 81 is deleted.

More specifically, in an event that the display data processing section 91 determines, on the basis of the status information, that the album requested has not been in the album managing server 1 from the beginning “Sta_{—}001 (FIG. 8)” or that the album has been deleted and will never been restored again “Sta_{—}002”, the album ID is never used again validly. Therefore, the album ID can be deleted from the album ID storage section 81.

Further, the following function to filter the display data may be further included. If plural pieces of display data are provided from the album managing server 1, and if a condition is set in regard to allowed users for browsing, the plural pieces of display data are filtered on the basis of the attribute information stored in the television 2 so that only the display data that satisfies the condition is displayed.

More specifically, for example in an event that “display data for the age under 12” and “display data for the age of 12 or over” are transmitted from the album managing server 1 to the television 2 in regard to one topic, the display data processing section 91 receives both of the display data, refers to information on the age of the user, which information is registered in advance with the television 2, selects one of the display data that is suitable for the age of the user, and sends an instruction to the display control section 64 to display the display data.

### Embodiment 2

In Embodiment 1 described above, the album managing server 1 manages album information by album, and receives, by album, a request for display data 7 from a television 2. Therefore, in Embodiment 1, the album managing server 1 determines by album whether an album requested is available to be provided. If the album is not available to be provided, then the album managing server 1 transmits, by album, status information indicating this status, thereby responding to a request from the television 2.

The album managing server 1 in accordance with the present invention is not limited to the configuration described above. The album managing server 1 of the present invention may be configured in the following manner. The album managing server 1 manages information on the pictures (display target information/image information) by picture, and receives a request for the display data 7 from the television 2 by picture. The album managing server 1 determines, by picture, whether the pictures in the album requested are available to be provided. If the pictures are not available to be provided, then the album managing server 1 transmits, by album (or by picture), the status information indicating this status, in response to the request from the television 2.

The following describes in detail the album managing server 1 to manage the information on the pictures in the album by picture, to determine the status by picture, and to generate the status information.

[Summary of Network Album System 2]

In the present embodiment, the television 2 transmits the display data request message 6 to the album managing server 1 to request the display screen C (slideshow display screen) in which the pictures in the album are displayed one by one in slide. The album managing server 1 provides the display data 7 to display the display screen C in which the album requested by the television 2 is displayed in slideshow.

The display data 7 in accordance with the present embodiment is configured with picture display data prepared by picture. The picture display data is constituted of the display control information for displaying a screen to display one picture, and data on the picture, which data is the display target data. The picture display data is prepared for each picture. The display data request message 6 to be generated by the television 2 is constituted of the picture display data request message (display-target request message) to make a request for the picture display data. The picture display data request message is also generated for each picture. To generate the picture display data request message, the message generating section 75 only needs to include data indicating the picture ID into the display data request message 6 shown in FIG. 5. Thus, basing the operational status detected by the status detecting section 71, the display-target ID determining section 72 determines which picture is requested. In other words, the picture ID of the picture to be targeted is determined.

Accordingly, when receiving, by picture (or collectively), a request from the television 2 for the display screen C of the album, which display screen C is a slideshow display screen, the album managing server 1 generates the picture display data for every picture contained in the album and provides each picture display data individually (or collectively) in the order in which the picture display data request messages are received.

The television 2 sequentially displays the picture display data provided by the album managing server 1 so as to display the album in slideshow.

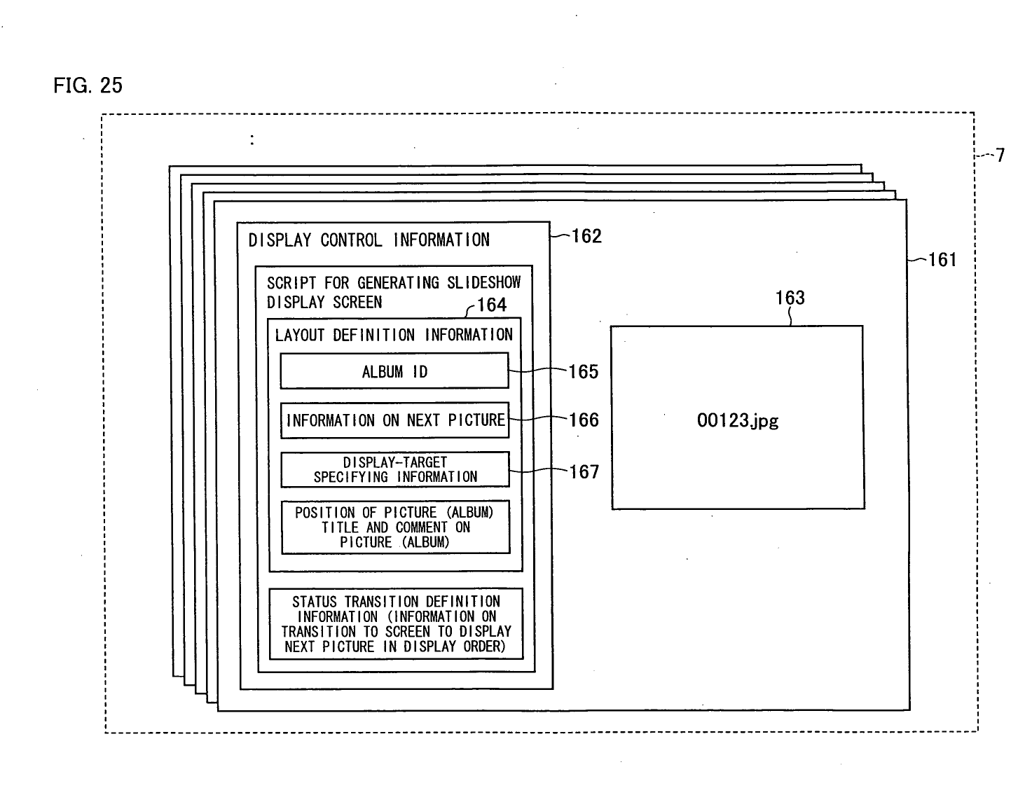

FIG. 25 schematically shows the picture display data to constitute the display data 7 according to the present embodiment. As shown in FIG. 25, the display data 7, which is to be provided to the television 2 by the album managing server 1 and to display a slideshow, is constituted of picture display data 161 on the pictures contained in the album. The picture display data 161 is to display one picture in the album. The picture display data 161 contains a picture 163, which is the display target data, and display control information 162, which is to define a layout of the picture.

The display control information 162 contains the scripts for generating display screens in slideshow. The scripts is constituted of the layout definition information 164 and the status transition definition information. The information contained in the layout definition information 164 at least includes the album ID 165, next picture information 166 on the next picture, and display target specifying information 167 containing information on links to the picture that is defined in the picture display data 161 as a display target.

Following the display control information 162, the television 2 causes the picture 163 to be displayed in defined layout. Further, an operational screen is displayed with which the user operates the television 2 so as to cause the next picture to be displayed. Thus, in the television 2 (FIG. 15, FIG. 21), an input from the user via the operational section 15 is accepted by the operation accepting section 61, and, with the next picture information 166 and the status transition definition information, it is possible to move to an operation to obtain a display screen to display a next picture.

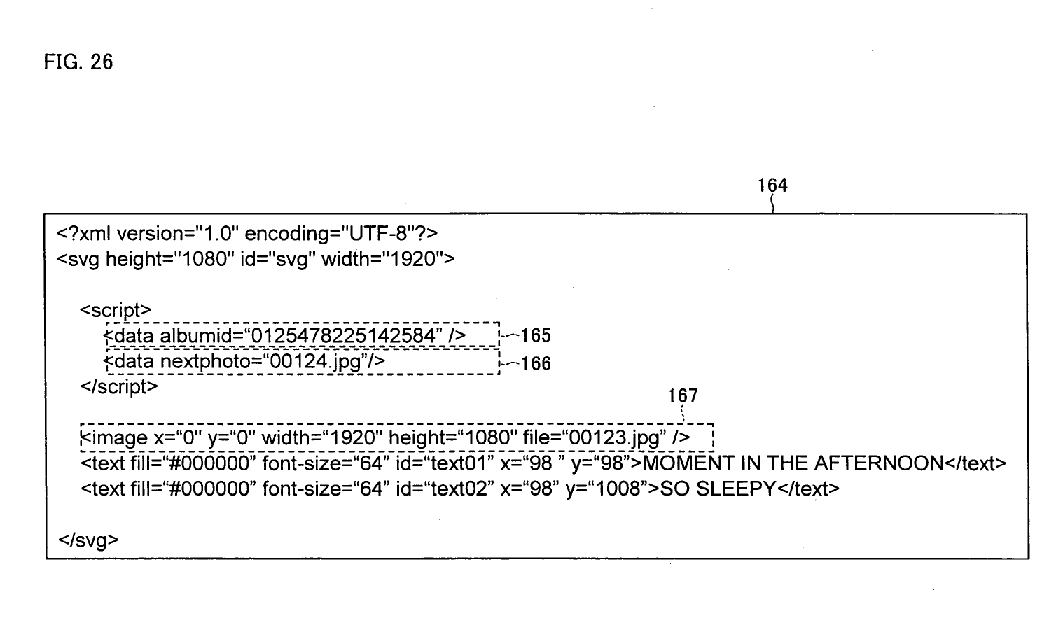

FIG. 26 is a figure showing a concrete example of the layout definition information 164 shown in FIG. 25. As shown in FIG. 26, in the display control information, not only the display target specifying information 167, which is to identify the picture as the display target data, but also the next picture information 166, which is to identify the next picture that is to become the display target data following the picture, are filled. Thus, the display-target ID determining section 72 can identify the picture display data of which picture (picture ID) should be requested, when the television 2 carries out the process of generating the picture display data request message.

[Configuration 2 of Album Managing Server]

The following are differences from the album managing server 1 of Embodiment 1, in the album managing server 1 shown in FIG. 1. One of the differences is that the display target data storage section 52 stores and manages, on the picture table, picture information that indicates the statuses of the pictures, in addition to the data on the pictures that is the display target data. The picture information is stored and managed for every picture contained in the album. Another one of the differences is that the status information storage section 54 stores, on the status table, status information that indicates the statuses of the pictures, in addition to the status information on the statuses of the albums.

The display-target ID obtaining section 21 receives the picture display data request message, obtains not only an album ID but also a picture ID, and identifies the picture requested.

The status determining section 30 determines, in addition to determination on the status of the album, the status of the picture by referring to the display target data storage section 52, on the basis of the picture ID obtained by the display-target ID obtaining section 21.

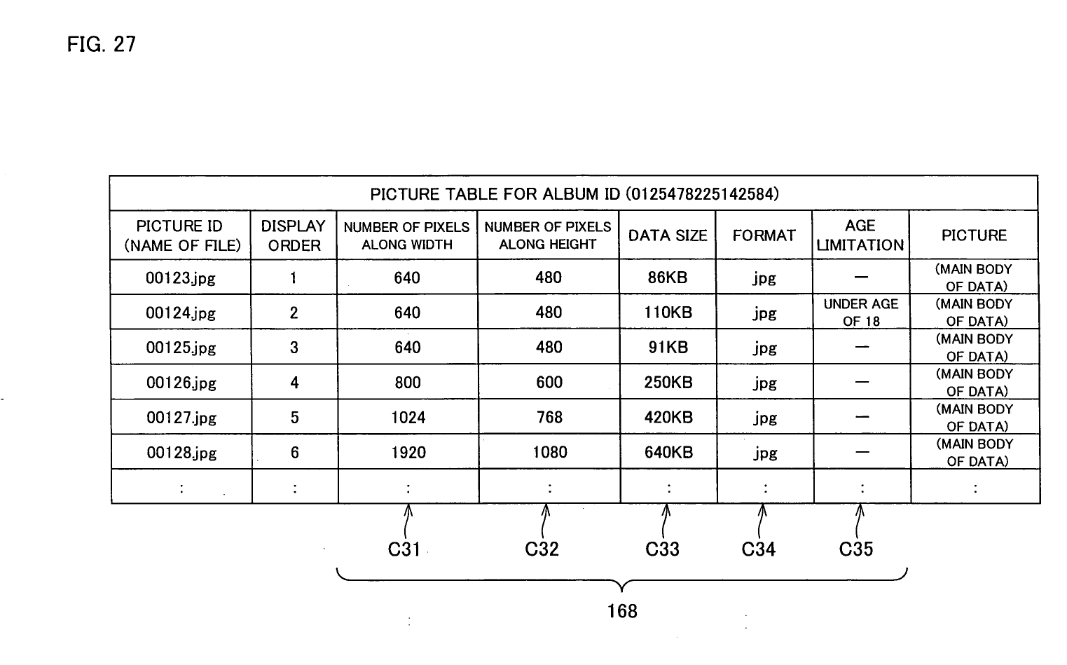

FIG. 27 shows examples of the picture information on the picture table stored in the display target data storage section 52. Although FIG. 27 shows only the picture table for the album of the album ID “0125478225142584”, one picture table is prepared for every album managed by the album managing server 1.

The difference from the picture table of Embodiment 1 that is shown in FIG. 9 is that the picture information 168 is stored for every picture.

The column C31 shows the number of pixels along width in the pictures. The column C32 shows the number of pixels along height in the pictures. The column C33 shows the size of the data on the pictures. The column C34 shows the types of the formats (e.g. jpg, tiff, bmp) of the data on the picture. The column C35 shows the range of age without authorization to browse the pictures, in the event that an age limitation is set in publication of the pictures.

The status determining section 30 refers, when necessary, to various information on the picture information 168 to determine the status of the pictures.

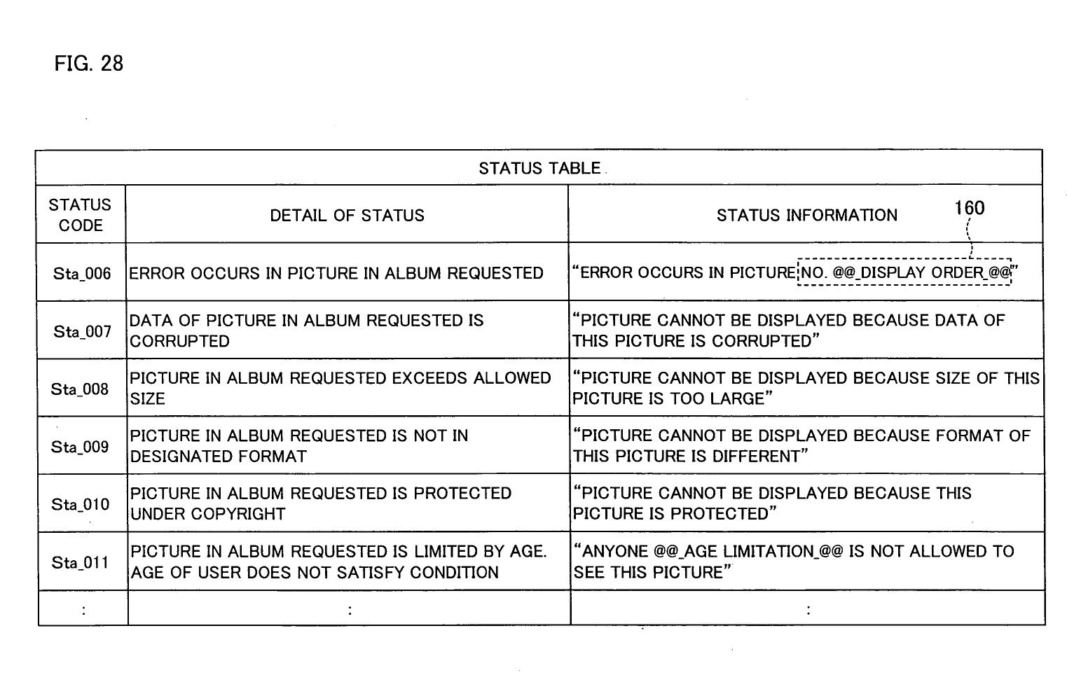

FIG. 28 shows an exemplary status table stored in the status information storage section 54, in which status table the status information is managed. In the status table shown in FIG. 28, the album (or picture) is configured in such a manner that one status is in one record. The status table shown in FIG. 28 does not show the status information “Sta_{—}001, to “Sta_{—}005” in relation to the statuses of the album, but it is certainly possible that the status information shown in FIG. 8 is stored in the status table shown in FIG. 28.

Further, the status information on the status of the pictures may contain, as a parameter 160, information (e.g. display order) to identify the pictures in the album. In this configuration, the status determining section 30 refers to the display target data storage section 52. If detecting that the picture requested is not available to be provided, then the status determining section 30 extracts, from the display target data storage section 52, the display order (e.g. “2”) of the picture and outputs the status code “Sta_{—}006” and the display order “2”.

Basing the status code, the status information extracting section 42 extracts the status information shown in FIG. 28. Then, a parameter “169 @_display order_@@” contained in the status information is replaced by the display order data “2”, whereby the status information is completed.

Thus, in the display control information to be returned to the television 2 having requested the picture, a command for displaying text data “ERROR OCCURS IN PICTURE NO. 2” is written, instead of displaying the picture.

Seeing this text, the user of the television 2 finds out not only does an error occurs in any of the pictures in the album requested, but the error occurs in which picture.

The status determining section 30 refers to various information in the picture information 168 and determines whether the picture requested is available to be provided. If the picture is not available to be provided, then the status determining section 30 determines the status of the picture and outputs, as a status determination result, a status code responsive to a result of this determination.

This allows the status information extracting section 42 to extract, from the status information storage section 54, the picture status information indicating why the picture cannot be provided, and to include the picture status information in the display control information, when the picture is not available to be provided.

Thus, when the picture requested is not obtainable, the television 2 displays, instead of displaying the slideshow display screen of the picture, the status information on the picture so that the situation in which the picture cannot be provided to the user is indicated. Further, if the status information contains the parameter 160 to identify the picture, the details of the error are indicated by picture as well as by album.

Concretely, the user is provided with information on the details of the error by picture. Specifically, “ERROR OF ‘**’ OCCURS IN PICTURE NO.‘*’ in the album” is indicated instead of “ERROR OF ‘**’ OCCURS IN ONE OF THE PICTURES IN ALBUM”. This provides the user with more detailed information on the error, so that the convenience of the users improves.

[Processes in Album Managing Server]

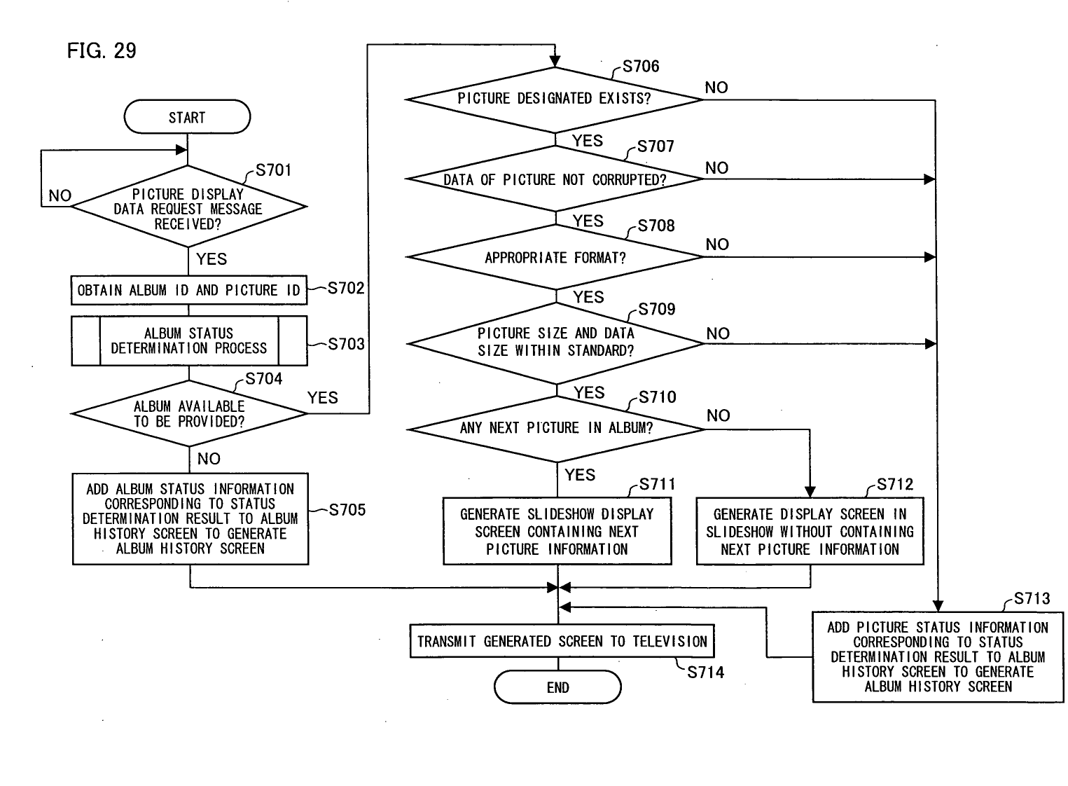

The following describes in detail the status determination process to be carried out by the status determining section 30, using the case shown in FIGS. 27 and 28. In the case shown in FIG. 29, a picture display data request message to request for the picture display data to display a slideshow is received from the television 2. With the slideshow provided by the network album system 100 according to the present embodiment, the picture display data is requested and displayed in accordance with the order in which the pictures are displayed. Further, if an error occurs in the pictures during the slideshow, the display screen A (album history screen) is displayed.

FIG. 29 is a flowchart showing a flow of processes of providing the display data in the album managing server 1 of the present embodiment.

When the receiving section 11a receives the picture display data request message from the television 2 (YES in S701), the display-target ID obtaining section 21 of the message analyzing section 20 obtains the album ID and the picture ID from the picture display data request message to identify the display target data (S702). Thereafter, the status determining section 30 carries out the processes of determining the status of the album. The processes of S703 to S705 are same as the processes of determining the status of the album that are shown in FIGS. 12 and 13. Therefore, description thereof is not repeated. If determining that the album requested is available to be provided (YES in S704), the status determining section 30 refers to the display target data storage section 52 and carries out the processes of determining the status to determine the information on the pictures.

Concretely, the status determining section 30 first refers to the picture table for the album, and determines whether the picture information (and data of the picture) on the picture ID obtained by the display-target ID obtaining section 21 is stored (S706).

If determining that the picture is stored (YES in S706), then the status determining section 30 determines, by referring to the main body of the data on the picture identified by the picture ID, whether or not the data is corrupted (S707).

If it is determined that the data is not corrupted (YES in S707), then the status determining section 30 refers to the format in the column C.34, which format is associated with the picture ID, and determines whether the picture requested is in a format that can be handled in the network album system 100 (S708). In the present embodiment, information on the formats (e.g. jpg format) that can be handled is stored in advance in the album managing server 1. The status determining section 30 determines only the pictures matching the information on the formats defined in advance, as pictures that can be handled.

If it is determined that the pictures are stored in the format that can be handled (YES in S708), then the status determining section 30 determines, on the basis of the number of pixels and the data size of the picture requested, whether the size of the picture is within a standard size for displaying on the television 2 (S709).

In the present embodiment, the following three conditions are predetermined as a displayable standard: the number of pixels along width is 1920 or fewer (condition 1); the number of pixels along height is 1080 or fewer (condition 2); and the data size is 650 KB or below (condition 3). Information on the foregoing standards are preset and stored in advance in the storage section 80. The status determining section 30 refers to the information and determines a picture satisfying all of those three conditions, as being displayable on the television 2.

If it is determined that the picture is displayable on the television 2 (i.e. YES in all of S706 to S709), then the status determining section 30 determines that the picture identified by the picture ID is available to be provided. The status determining section 30 transmits this result of determination to the display data generating section 40.

The display data generating section 40 refers to the display target data storage section 52 and determines whether the next picture in the display order to the picture is stored (S710). If there is the next picture to be displayed following the picture requested (YES in S710), then the display control information containing the next picture information 166 as shown in FIG. 25 is generated, whereby the picture display data on the picture is generated (S711). On the other hand, if there is no picture to be displayed next, this implies the end of the slideshow display screen of the album. Therefore, the display control information is generated without containing the next picture information 166, whereby the picture display data is generated (S712).

On the other hand, if determining as a result of the process in S706 to S709 of determining the status of the picture that the picture is not available to be provided (NO in at least one of S706 to S709), then the status determining section 30 outputs, as the status determination result, a status code (e.g. FIG. 28) to indicate that the picture is not available to be provided. The display data generating section 40 generates the display data to display the album history screen containing the status information on the picture, which status information is responsive to the status determination result (S713). How the display data is generated is already described in Embodiment 1, so that description thereof is omitted.

Lastly, the transmitting section 11b transmits the display data generated in any one of S705 and S711-S713 to the television 2, in response to the picture display data request message from the television 2 (S714).

In the foregoing configuration and method, the status determining section 30 of the album managing server 1 manages the picture information for each picture, and determines for each picture requested whether the picture is available to be provided or not. The display data generating section 40 generates, in a manner responsive to the status determination result, the display data containing the status information that indicates the status of the picture.

Accordingly, if it is determined that the picture requested is not available to be provided, then the display data containing the status information is provided to the television 2, which status information indicates, in a manner responsive to the status determination result of the status determining section 30, the status of the picture and why the picture is not available to be provided.

Thus, when the picture requested is not obtained, the television 2 obtains the display data and displays the status information on the errors in the picture so as to provide the status information to the users. This allows the users to know, when a desired picture cannot be browsed, why the picture cannot be browsed, so that the users can take a suitable action. Thus, the convenience of the users improves.

The way in which the status determining section 30 determines the status of the picture is not limited to the example shown in the flowchart in FIG. 29. For example, if determining, on the basis of the information in the column C35 on age limitation as shown in FIG. 27, that the age of the user of the television 2 does not satisfy the conditions of ages of people who are allowed to see, then the status determining section 30 outputs a status code “Sta_{—}011” (FIG. 28) to send an instruction to the display data generating section 40 to generate the display control information containing the status information indicating that the user has not reached the ages of people who are allowed to see.

In this case, the display data request message 6 transmitted from the television 2 is to contain the user information that indicates the age of the user.

Further, if the picture table shown in FIG. 27 manages information, for every picture, to block publications of pictures protected under the copyright laws, it becomes possible for the status determining section 30 to determine this status. Accordingly, it is also possible to generate the status information indicating that the picture requested cannot be displayed due to protection under the Copyright Law, and shows the status information to the users of the television 2.

[Processes in Television]

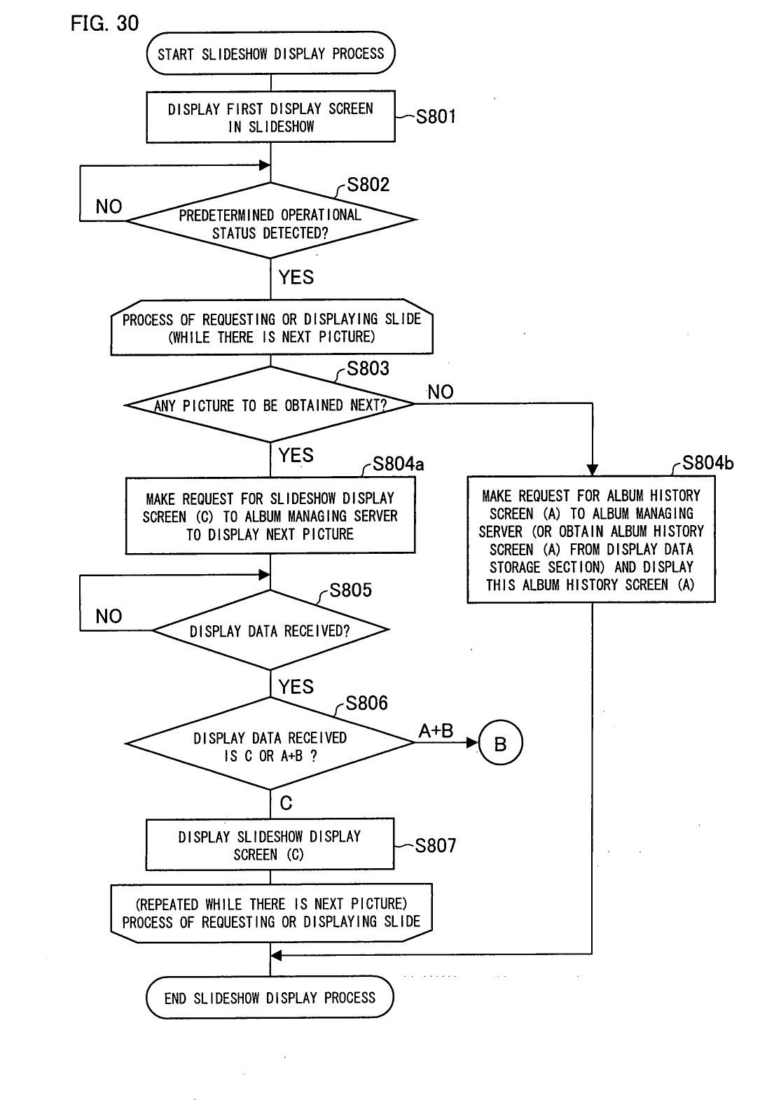

FIG. 30 is a flowchart showing a flow of processes of requesting and displaying the display data in the television 2 of the present embodiment. The television 2 requests the album-picture display screen shown in FIG. 4(c), and receives a slideshow display screen C to display a first picture in the album that the television 2 has requested.

A display data processing section 91 (FIG. 15 or FIG. 21) makes the display section 17 display the picture display data of the slideshow display screen C_1 (FIG. 4(c)) that a display data receipt control section 63 receives (S801).

With the slideshow display screen C_1 being displayed, when the status detecting section 71 detects a predetermined operational status of the television 2 (S802), the control section 90 starts requesting slides and carrying out display process. Possible predetermined operational status that the status detecting section 71 detects include: a state in which a predetermined time period has passed since the slideshow display screen C_1 is displayed in S801; a state in which, with the slideshow display screen C_1 being displayed, a “go to next” button is selected, or a cross key is pressed, which means going to next, so that a predetermined signal is received; and the like.

The display-target ID determining section 72 extracts the next picture information 166 (FIG. 25, FIG. 26) contained in the picture display data on which the display process is currently being executed, and determines that there is picture display data to be requested next (YES in S803). The message generating section 75 generates the picture display data request message to request the picture display data to display a next picture identified by the display-target ID determining section 72, and the message generating section 75 transmits the picture display data request message (S804a).

If the receiving section 16b receives any display data from the album managing server 1 in response to the request message (YES in S805), the display data processing section 91 analyzes the display data received, and determines whether the display data is the picture display data of the slideshow display screen C to display the picture requested, or the display data is to display the album history screen A (and album ID input screen B) because the picture requested does not exist (S806). If the display screen received is the slideshow display screen C (C in S806), then the display data processing section 91 makes the slideshow display screen C be displayed (S807). On the other hand, if the display screen received is the album history screen A (and album ID input screen B), then the flow moves to the processes S308 to 310 to display the display screen A or the display screen B.

Further, in S803, if the display-target ID determining section 72 determines that there is no picture to be requested next because no next picture information 166 is contained in the picture display data that is currently in operation of display processing (NO in S803), then the display data request processing section 70 makes a request for the album history screen A to the album managing server 1 (or the display data processing section 91 obtains the album history screen A from the display data storage section 84) and causes the display section 17 to display the album history screen (S804b).

Thereafter, the television 2 repeats the processes S803-S807 of requesting and displaying slides until there is no more picture to be displayed.

With this method, when there arises a situation (error) in which the picture requested becomes unavailable to be provided, the television 2 receives the album history screen A in S806. The album history screen A thus receives contains the status information on the picture, which status information is associated with the album containing the picture in which the error occurs.

This allows the television 2 to display the status information indicating the status of the picture that is not obtained. Thus, the user ascertains the status information and why the desired picture cannot be browsed.

### Modified Embodiment 3

### To Provide Error Dialog Display Data

The foregoing embodiments describe the album managing server 1 and the television 2 that are configured in such a manner that, when a next picture is to be displayed, the album history screen (screen that displays, for each album, the status information on the pictures) is displayed if an error is detected in the picture.

The album managing server 1 and the television 2 of the present invention, however, are not limited to the foregoing configurations. For example when an error is detected in the pictures, first the album managing server 1 may provide the error dialog display data so as to cause the television 2 to display the error dialog display data. On the error dialog display screen, an operational screen is displayed to make a transition to a next screen, whereby the transition to the next screen is made at a timing the user desires (and to the display screen that the user intends) so that the user interface is enriched to improve the convenience of the users.

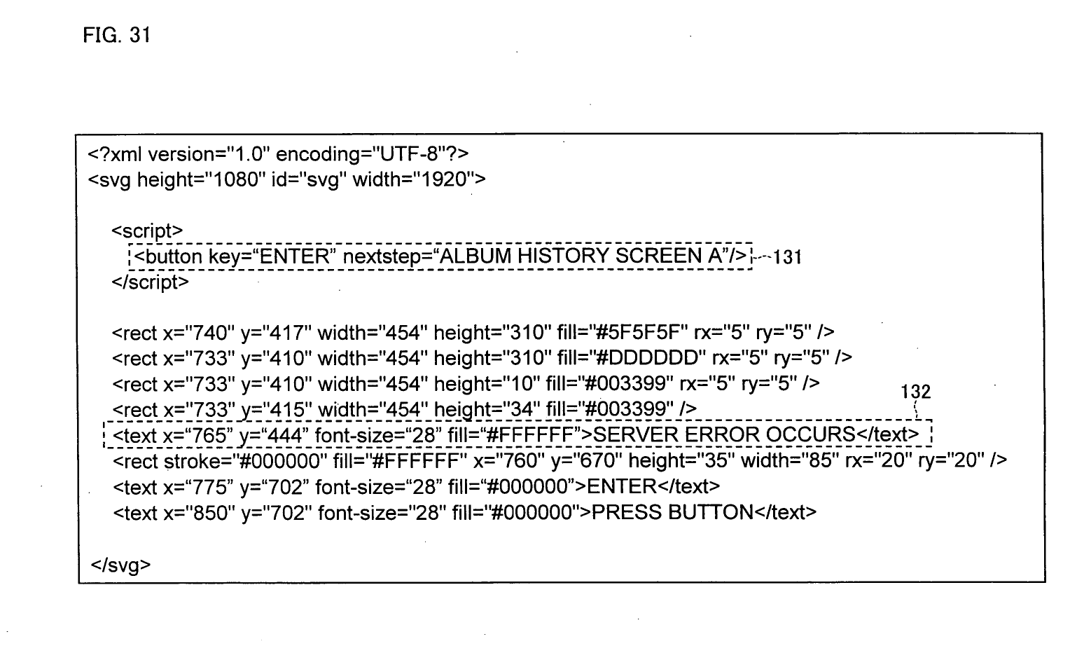

FIG. 31 is a figure showing a concrete example of the display control information contained in the error dialog display data to be returned to where the request comes from, when the album managing server 1 detects an error in the display target data that is requested.

In a script 131, commands with respect to the television 2 are written so that, when an enter button of the operational section 15 is pressed, a transition is made to the album history screen A. In a script 132, commands are written to display a message indicating that an error occurs in the album managing server 1. This message is displayed so that the user learns there arises an error owing to the album managing server 1.

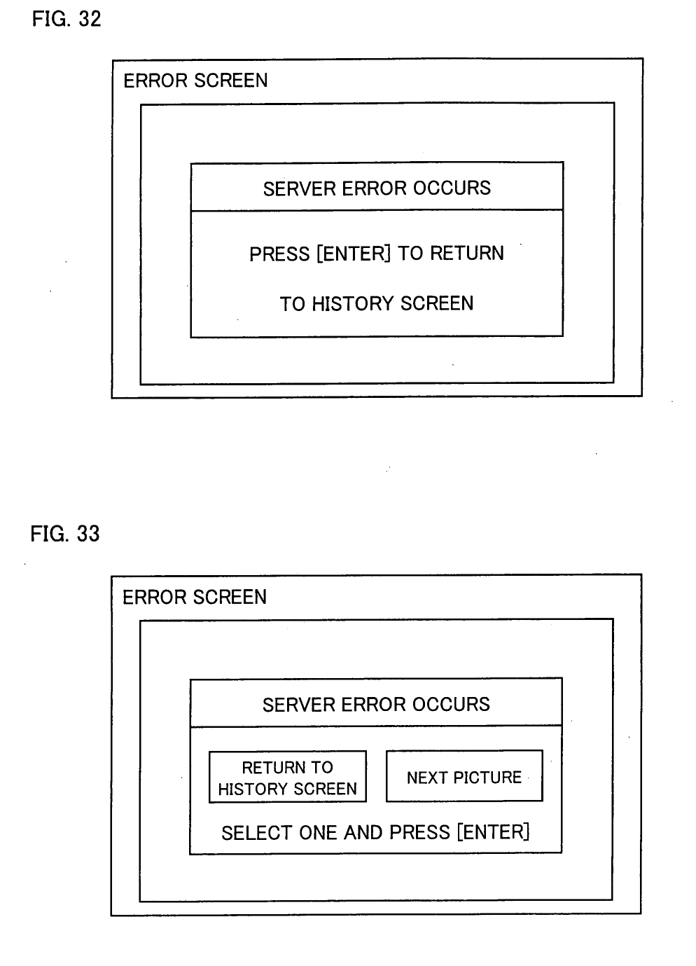

FIG. 32 shows a concrete example of the error dialog display screen displayed on the display section 17 by the display data processing section 91 of the television 2 in accordance with the display control information shown in FIG. 31.

If the enter button of the operational section 15 is pressed while the error dialog display screen shown in FIG. 32 is displayed, the status detecting section 71 detects, via the operation accepting section 61, that a signal is fed, and respective sections of the display data request processing section 70 begin the processes of requesting/displaying the album history screen.

This makes it possible to make the television 2 operate in such a manner that the album history screen is displayed at a suitable timing desired by the user in accordance with a user instruction, without making a compulsory transition to the album history screen. Thus, the convenience of the user improves.

Examples of the error dialog display screen to be provided to the television 2 by the album managing server 1 are not limited to those described above. For example, the album managing server 1 may generate error dialog display data that contains a GUI screen for the user to select whether to make a transition to the album history screen or skip the picture containing the error and make a transition to a next slideshow display screen to see the rest of the slideshow, and may provide the error dialog display data to the television 2.

FIG. 33 shows an exemplary error dialog display screen including a GUI screen for the user to select where the user desires to make a transition to. When finding out from the error dialog display screen that an error occurs in the picture, the user merely needs to select a button for a screen to which the user desires to make a transition.

This allows the television 2 to operate in such a manner that, instead of a compulsory transition to the album history screen, a transition is made, at an appropriate timing, to a display screen desired by the user, in accordance with an instruction of the user. Thus, the convenience of the users further improves.

As shown in FIG. 33, to make a transition from the error dialog display screen to a next slideshow display screen by skipping this one picture containing the error, the album managing server 1 may include, when generating the display data on the error dialog display screen, the next picture information 166 (FIGS. 25, 26) on a picture that is to be displayed following the picture containing the error, into the display control information.

The timings of generating and providing the display data (error dialog display data) on the error dialog display screen are not particularly limited. For example, a step of generating and transmitting the error dialog display data may replace S713 in the flowchart shown in FIG. 29. The album managing server 1 may then receive a message requesting the album history screen from the television 2 having received the error dialog display data, and perform the step of S713.

Alternatively, further error dialog display data may be generated in S713 and transmitted together with the display data on the album history screen. In this case, the display control information is generated so as to contain the status transition definition information for making a transition from the error dialog display screen to the album history screen.

Alternatively, the contents of the error dialog display data may be constant and may not be changed dynamically, and may be provided together with the picture display data provided in a normal manner in S711 or in S712. In this case, the television 2 detects errors in the pictures and determines whether or not to display the error dialog display data.

### Embodiment 3

The foregoing embodiments describe the case in which history information on latest three albums among the albums accessed in the past is displayed on the album history screen displayed on a television 2, in such a manner that the three albums are displayed in order, starting from the latest album. A network album system 100 of the present invention is not limited to the case described in the foregoing embodiments. The television 2 may manage an album history of three or more albums in an album history table, and make a request to the album managing server 1 for the album history screen to display the history information on three or more albums. Further, the television 2 may transmit, to the album managing server 1, a display data request message 6 requesting the album history screen, and at the same time, information on the album of priority display so that an album that the user desires, among three or more pieces of history information displayed on the album history screen, is always displayed with priority.

The following describes in detail respective configurations of the television 2 and the album managing server 1 to determine a display order of the album history information in accordance with user designation and to cause the television 2 to display three or more pieces of album history information.

[Configuration of Television]

The television of the present embodiment is different from the televisions 2 shown in FIGS. 15 and 21 in that the control section 90 of the television 2 includes an album history managing section 120, which is a function block. The album history managing section 120 manages the album history table stored in the album ID storage section 81, in accordance with user operation and/or description of the display control information received.

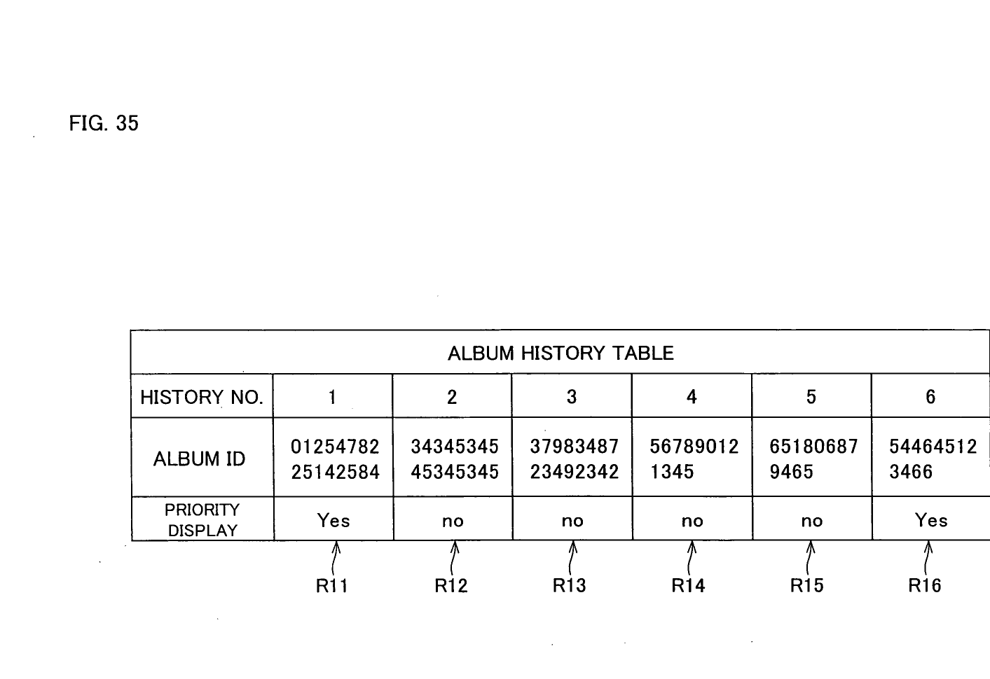

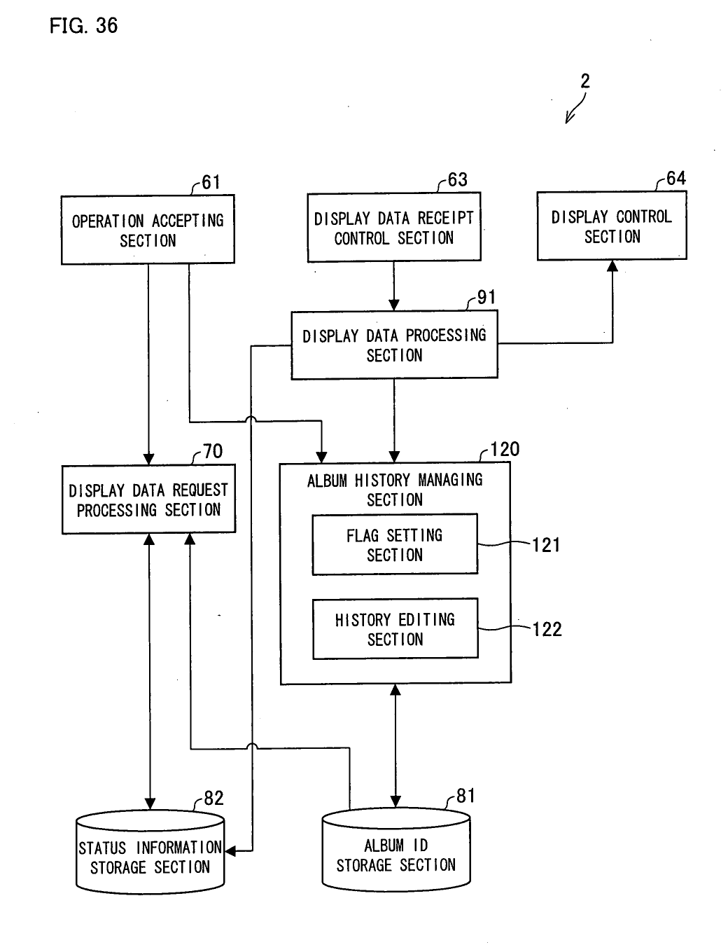

The following describes more in detail functions of the album history managing section 120 of the television 2, with reference to FIGS. 35 and 36. FIG. 35 shows an exemplary album history table stored in the album ID storage section 81, in accordance with the present embodiment.

As shown in FIG. 35, in the present embodiment, the album history table contains six records. Therefore, it is possible to store history information on six albums. Further, each history information has three fields. Pieces of information on “history No.”, “album ID”, and “priority display” are stored in the three fields, respectively. The “history No.”, “album ID”, and “priority display” are names of the data.

The “history No.” indicates a display order of the six pieces of history information. In the present embodiment, it implies that those six pieces of history information are displayed in ascending numerical order from the top of the album history screen. The “album ID” is to identify the albums. The “priority display” is a flag that indicates whether or not the user desires this album history information to be displayed with priority (displayed at a top). In the present embodiment, the priority display flag indicating “yes” implies that the user desires the album history information to be displayed with priority. On the other hand, the priority display flag indicating “no” implies the opposite. In the present embodiment, the records of the history information are stored in the album history table in ascending order of the “history No.”, with the record of the smallest “history No.” being at the top.

In the present embodiment, the display order of the history information on the album history screen is determined on the basis of the album history table shown in FIG. 35. Concretely, for example, the display order may be determined in such a manner that the records with the “priority display” indicating “yes” are displayed first in the order of the “history No.”, and then the rest of the records are displayed in the order of the “history No.”. Accordingly, when generating the display data 7 for the album history screen, the album managing server 1 writes layout definition information 171 in display control information in such a manner that the history information is displayed in the following order shown in FIG. 35: R11, R16, R12, R13, R14, R15. The foregoing way of determining the display order, however, is an example and is not to limit the way the display order is determined. Further, the display order may be determined either by the television 2 on the basis of the information of the album history table or by the album managing server 1 by obtaining the information from the television 2. In the following description, the album managing server 1 determines the display order. The album managing server 1 will be described later.

FIG. 36 is a block diagram showing a configuration of a main part of the television 2, in accordance with the present embodiment. As shown in FIG. 36, the album history managing section 120 includes a flag setting section 121 and a history editing section 122.

The flag setting section 121 updates a flag (priority display flag) of “priority display” shown in FIG. 35. If the user selects an album and designates priority display, then the flag setting section 121 updates the priority display flag associated with the album ID of the album selected so that the priority display flag changes from “no” to “yes”. If the same operation is performed again on the album with the priority display flag of “yes”, the priority display flag may be updated in an opposite manner so as to change from “yes” to “no”.

The history editing section 122 detects that the album is browsed in the television 2, and carries out sorting, adding, and deleting the records in such a manner that six most recently browsed albums are properly stored sequentially in the order of the “history No.”, starting with the most recently browsed album. That status in which the album is browsed implies a status in which the display data 7 on the slideshow display screen shown in FIG. 4(c) is processed in the television 2 so that the slideshow display screen of the album is displayed on the display section 17. The status in which the album is browsed also implies a status in which a thumbnail display screen is displayed.

On the basis of the album history table managed by the album history managing section 120 in the manner described above, the display data request processing section 70 generates the display data request message 6. The details of the display data request processing section 70 are already described in the foregoing embodiments.

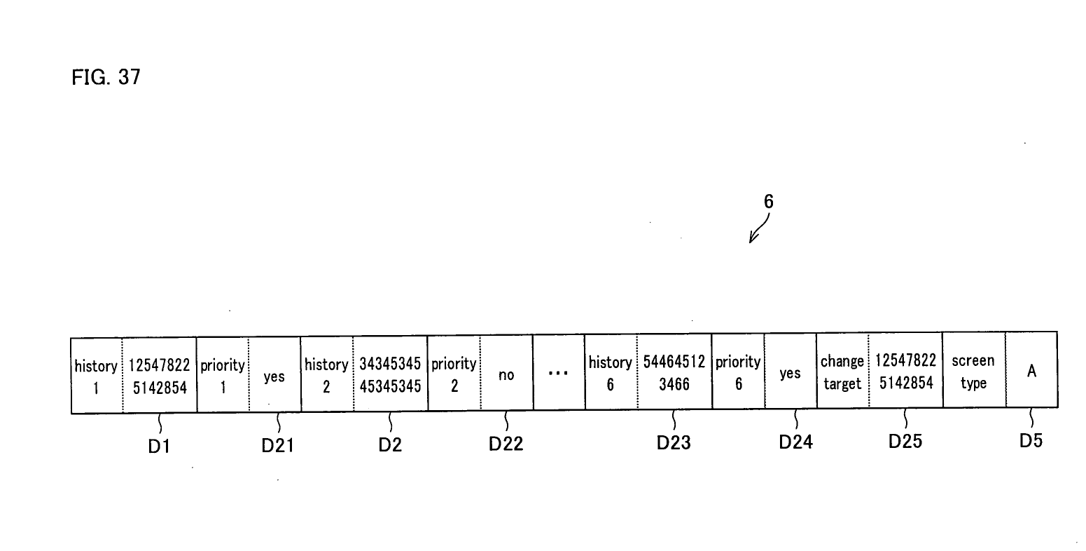

FIG. 37 schematically shows a configuration of data of the display data request message 6 generated by the display data request processing section 70 on the basis of the album history table, in accordance with the present embodiment.

As shown in FIG. 37, in the present embodiment, the display data request message 6 contains three album IDs (data D1 to D3) and album IDs stored in the fourth to the sixth ( . . . data D23). At this time, the six album IDs are stored sequentially in corresponding blocks “history 1”, “history 2”, . . . , starting with the record of the smallest “history No.”. Further, information on the priority display flag is associated with each of the album IDs and contained in the display data request message 6 (data D21, D22, . . . , D24). The display data request message 6 contains information on the type of the display screen (data D5), which information indicates that the message requests the display screen A. Further, although not shown in the figures, the user information D6 to D8 shown in FIG. 5 may be contained.

If the six albums include an album in which the setting of the priority display is changed, the display data request processing section 70 includes, in the display data request message 6, information (data D25) on a display target to indicate the priority display flag of which album needs to be updated. This allows the album managing server 1 to identify the album with the priority display flag that needs to be updated.

As the foregoing describes, the display data request processing section 70 generates the display data request message 6 on the basis of the album history table of the album ID storage section 81 to make a request to the album managing server 1 for the display data 7 on the album history screen.

On the basis of the display data request message 6, the album managing server 1 determines the display order of the album history information in such a manner that the albums with the priority display and the albums recently browsed come to the top, and generates the display data 7 to define the positions of the albums accordingly.

Regarding how the television 2 should update the album history table when what even occurs, and how the television 2 should re-obtain the album history screen when what event occurs, the television 2 may comply with: a program (status information table in FIG. 17) stored in advance in the storage section 80 (status information storage section 82); the detailed operation definition information 280 provided by the album managing server 1 when necessary; or both the program and the detailed operation definition information 280.

[Configuration of Album Managing Server]

In response to the request from the television 2, the album managing server 1 determines a display order of six pieces of album history information, and generates layout definition information 181. Further, the album managing server 1 generates detailed operation definition information 280 so that the album history is suitably managed in the television 2.

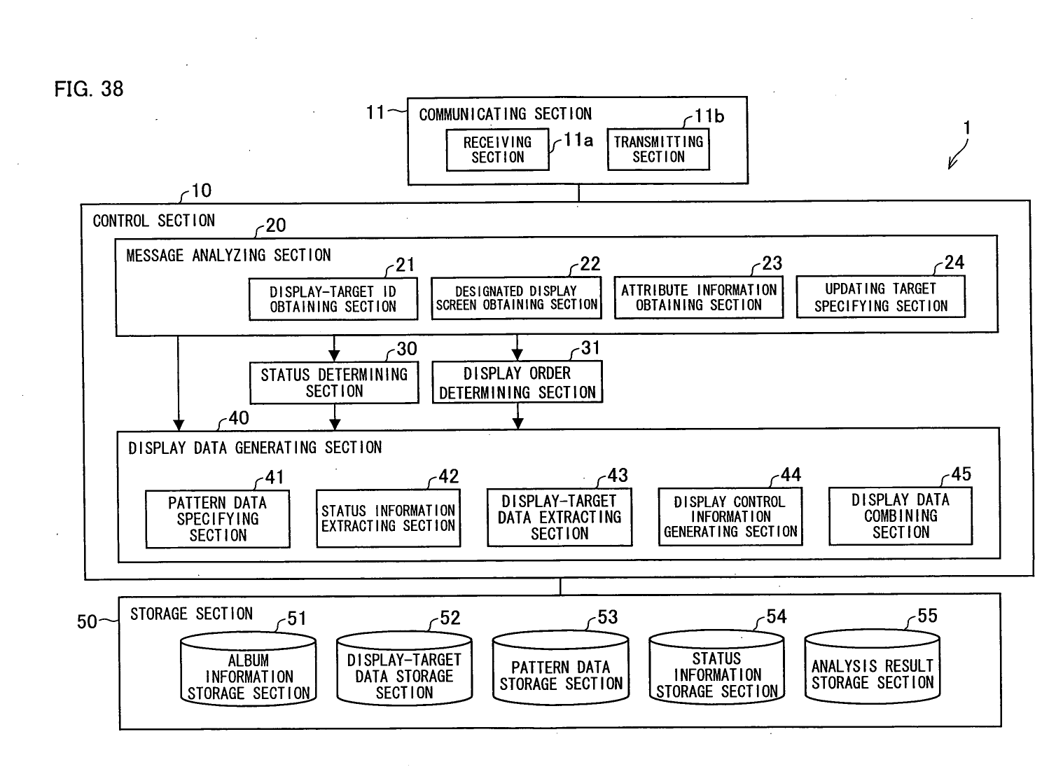

FIG. 38 is a block diagram showing a configuration of a main part of the album managing server 1, in accordance with the present embodiment. The album managing server 1 shown in FIG. 38 is different from that of FIG. 1 in that a control section 10 includes a display order determining section 31, which is a function block, and that a message analyzing section 20 includes an updating target specifying section 24.

The display order determining section 31 determines, on the basis of a result of an analysis performed by the message analyzing section 20 on the display data request message 6, the display order of the album history information to be displayed on the display screen A (album history screen).

The updating target specifying section 24 identifies, when the display data request message 6 contains information on target to be updated as shown in data D25 in FIG. 37, the album in which the priority display flag need to be updated.

In the present embodiment, as described above, the display order of the pieces of history information on the six albums is determined in accordance with the display data request message 6 shown in FIG. 37 as follows. First, it is determined that the records with the “priority display” indicating “yes” are displayed at the top. Then, the records are sorted in such a manner that the more recently the records are browsed, the higher the records are displayed. Thereafter, the rest of the records are sorted in such a manner that the more recently the records are browsed, the higher the records are displayed.

In accordance with the display order determined by the display order determining section 31, the sections of the display data generating section 40 generate the display data 7. Concretely, the display control information generating section 44 writes the layout definition information 181 in such a manner that the pieces of history information are displayed sequentially from the top in the display order determined by the display order determining section 31.

The display data 7 containing the layout definition information 181 generated in the manner described above is supplied to the television 2. The television 2 displays the album history screen in accordance with the layout definition information 181. Thus, the history information on the album requested by the display data request message 6 is displayed in a predetermined display order that the user desires. The predetermined display order implies an order arranged by possibility that the user is more likely to select. Concretely, the albums with the priority display by the user are displayed higher. Further, the albums are displayed in such a manner that the more recently the albums are browsed, the higher the records are displayed.

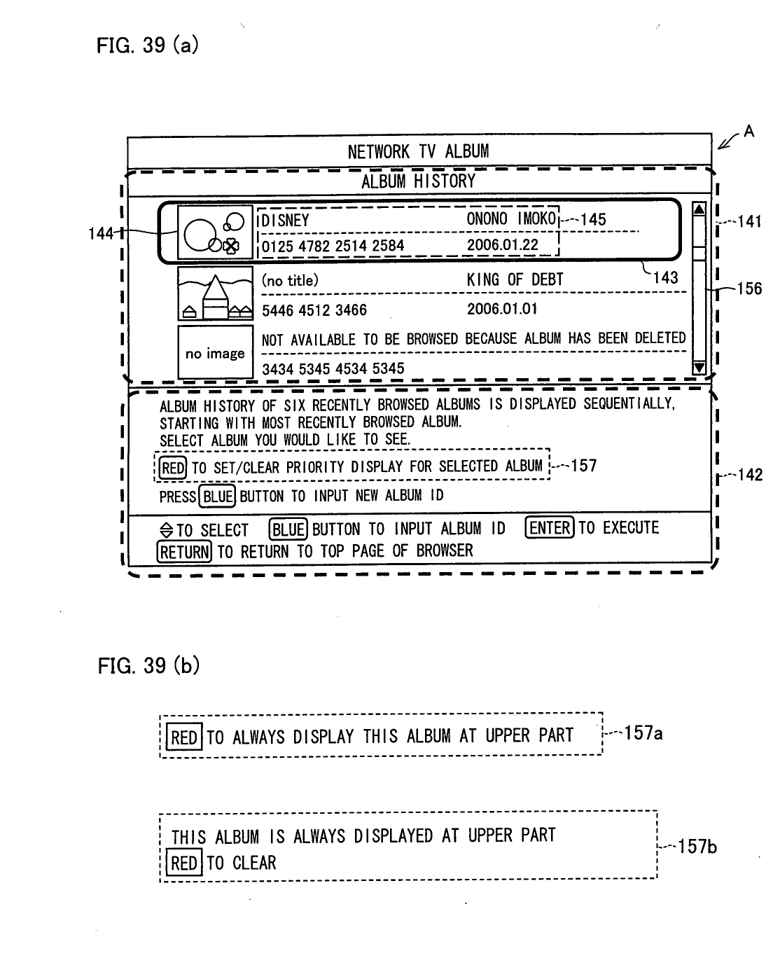

FIG. 39(a) shows an exemplary album history screen displayed on the display section 17 after the television 2 re-obtains the display data 7 containing the layout definition information 181. In a first area 141 where the history information on the albums is to be displayed, the history information on the six albums are displayed in the display order determined by the display order determining section 31 of the album managing server 1. If the first area 141 is not spacious enough to display the history information on all of the six albums, a scroll bar 156 is provided so that the history information on the rest of the three albums is displayed. Further, in the present embodiment, the television 2 is configured in such a manner that the user can designate the priority display of the history information by operating the operational section 15 while the album history screen is displayed. Therefore, operation guidance 157 of the buttons provided to the operational section 15 may be displayed in a second area 142.

In the case shown in FIG. 39(a), the operation guidance 157 indicates that it is possible to set or clear the priority display of the selected album by pressing a red button provided in the operational section 15.

Further, details of the operation guidance may be changed in a manner that depends on whether or not the priority display is set to the album selected. For example, as shown in FIG. 39(b), If the album without the priority display being set is selected, the operation guidance 157a is displayed. If the cursor is moved to the album with the priority display being set, the operation guidance 157a is switched to the operation guidance 157b.

This switch in displaying the operation guidance is realizable if the television 2 re-obtains the display data 7 each time when the cursor is moved. This, however, is a partial change of the text data. Therefore, it is preferable that the operational function definition information 188, which defines operation to switch the display of the operation guidance 157 in a manner responsive to the priority display flag of the album when the cursor is moved, be contained in advance in initial display data 7. This allows the display data processing section 91 to perform the operation above in accordance with the operational function definition information 188, without communicating with the album managing server 1 each time when the cursor is moved.

[Processes in Television]

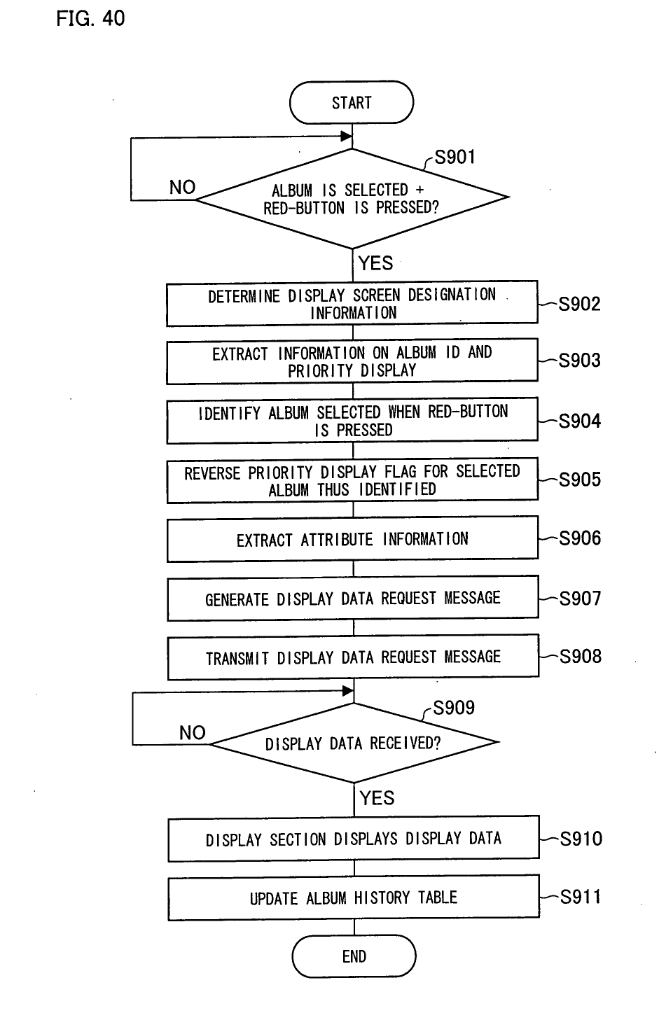

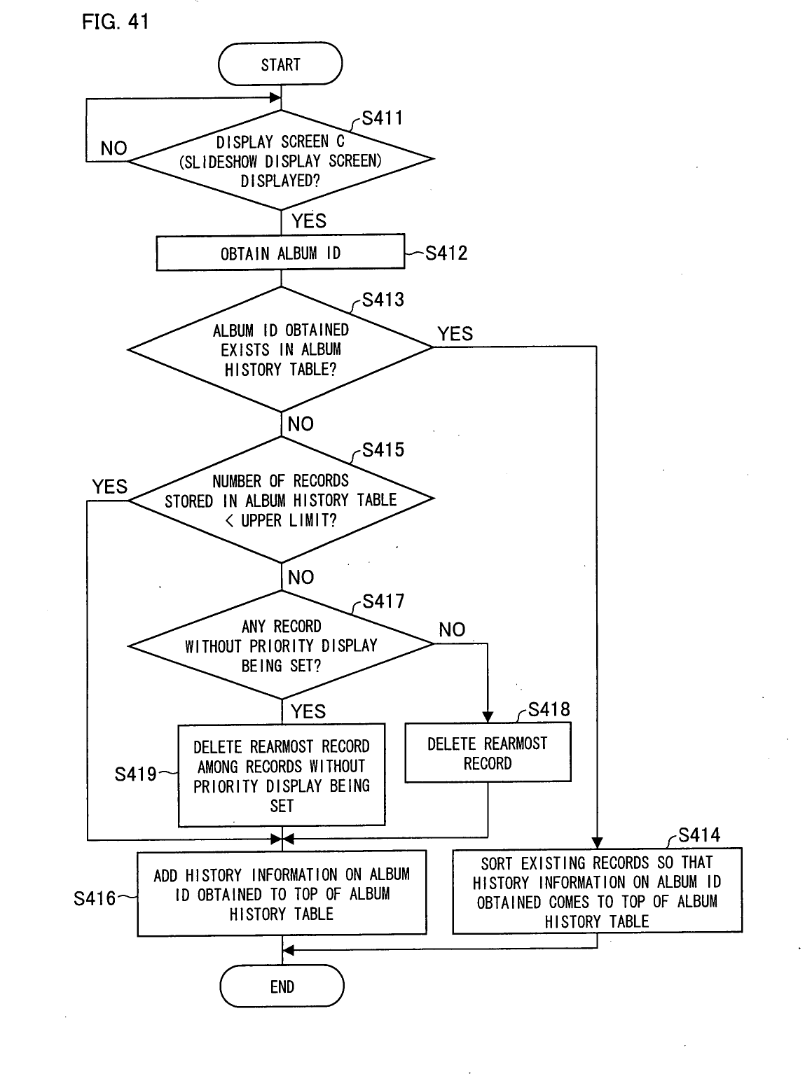

The following describes a flow of album history updating processes in the album history managing section 120 of the television 2, with reference to FIGS. 40 and 41.

In the present embodiment, the status information table shown in FIG. 17 is stored in the status information storage section 82 of the television 2. As shown in FIG. 40, if the red button is pressed while the album is selected and the display screen A (album history screen in FIG. 4(a)) is displayed, the display data 7 on the album history screen, in which the display order is switched in accordance with the status information R5 shown in FIG. 17, is re-obtained. At the same time, the album history table is updated.

If the red button of the operational section 15 is pressed while the album is selected and the album history screen of FIG. 4(a) is displayed (YES in S901), the designated display screen determining section 73 in the display data request processing section 70 of the television 2 refers, on the basis of a signal detected by the status detecting section 71, to the status information R5 (FIG. 17) stored in the status information storage section 82. Then, the display screen A (album history screen) is determined as the display screen designation information (S902).

Then, the display target ID determining section 72 extracts the album ID stored in the album history table of the album ID storage section 81 and the priority display flag associated with the album ID (S903) (in the present embodiment, the album ID and the priority display flag are extracted from the six records shown in FIG. 35). At this time, the display target ID determining section 72 identifies, on the basis of the signal detected by the status detecting section 71, the record of the album being selected at the time when the red button is pressed (S904).

Then, the display target ID determining section 72 reverses the priority display flag of the record of the selected album thus identified (S905). In other words, in regard only to the album selected with the red button, the priority display flag with the opposite setting to the prior setting is included in the display data request message 6.

If attribute information such as user information and information on setting is stored in an attribute information storage section 83, the attribute information extracting section 74 may extract necessary attribute information from the attribute information storage section 83 (S906).

Lastly, the message generating section 75 generates the display data request message 6 containing various information determined or extracted by the sections above (S907). At this time, the records of the album history information are contained in the display data request message 6 in ascending order based on the “history No.”. Further, the album ID (data D25 in FIG. 37) of the album identified in S904 and selected at the time when the red button is pressed is included in the display data request message 6. For example, the display data request message 6 shown in FIG. 37 is generated and transmitted to the album managing server 1 (S908).

If the display data receipt control section 63 receives, from the album managing server 1, the requested display data on the album history screen (YES in S909), the display data processing section 91 processes the display data. The display control section 64 provides this processed display data to the display section 17 (S910). As a result, the album history screen (e.g. FIG. 39(a)) in which the display order is changed due to the change in setting of the priority display is displayed on the display section 17.

Further, in the present embodiment, the display data that the television 2 re-obtains from the album managing server 1 contains the operational function definition information 188 defining the operation to update the history information on the album being selected at the time when the red button is pressed.

In other words, receiving the display data request message 6 generated through the flow described above, the album managing server 1 determines the display order and defines the layout. Further, the album managing server 1 defines the operation in the processes of updating the flag, in order to allow the television 2 to update the priority display flag of the album identified by the updating target specifying section 24 as an updating target. Then, the album managing server 1 includes the definition information (layout definition information 181 and the operational function definition information 188) into the display data 7 and then provides the display data 7 to the television 2.

In accordance with the operational function definition information 188, the flag setting section 121 of the album history managing section 120 updates the priority display flag of the album identified in S904.

With the foregoing way, if operation to set/clear the priority display is carried out while the album history screen is displayed and the album is selected, the album history screen in which the display order is based on a new setting of the priority display is re-obtained (re-displayed). At the same time, the flag setting section 121 carries out the processes of updating the album history table of the album ID storage section 81.

Then, in the present embodiment, if the television 2 makes a request for the display screen C (album in slideshow display screen) in accordance with the flow show in FIG. 20 and displays the display screen C (S410), or in other words, if the album is browsed, then the processes shown in FIG. 41 of updating the album history table are carried out so that the history information on the album is stored as a recently browsed album.

If the display control section 64 causes the display screen C to be displayed (YES in S411), then the history editing section 122 obtains, from the display data on the display screen C, the album ID of the album being displayed (S412).

Thereafter, if determining that the album ID thus obtained is already stored in the album history table (YES in S413), then the history editing section 122 re-orders existing records in such a manner that the history information on the album ID thus obtained comes at a top of the album history table (S414), and finish the processes of updating.

On the other hand, if determining that the album ID obtained is a new ID and is not stored in the album history table (NO in S413), then the history editing section 122 determines whether the number of records stored has reached the upper limit (six in the present embodiment) in the number of records that can be stored (S415). If the number of records stored has not reached the upper limit (YES in S415), then the history editing section 122 adds, to the top of the album history table, the record of the album ID obtained (S416) and finishes the processes of updating. On the other hand, if the number of records stored has reached the upper limit (NO in S415), then the process of deleting the existing record is carried out so as to allow a record to be added.

Concretely, first, the history editing section 122 determines whether or not the priority display flag “no” is set for the any of the records of the album history table (S417). If there is no record for which the priority display is not set (NO in S417), then the last record (i.e. album that the longest time has passed since the last time the album was browsed) in the album history table is deleted (S418), and the record of the album ID obtained is added to the top (S416). Then, the processes of updating are finished.

On the other hand, if there is a record for which the priority display is not set (YES in S417), then the rearmost record among the records with the priority display flag “no” is deleted (S419), and the record of the album ID obtained is added to the top (S416). Then, the processes of updating are finished.

With the foregoing way, each time the album is browsed, the album history table is updated or sorted in sequential order, starting with the most recently browsed album. Thus, the album history table is maintained in such a manner that the albums are stored in sequential order, starting with the most recently browsed album. Therefore, the display order of the history information on the album history screen is properly determined on the basis of the information in the album history table.

The operation of the history editing section 122 in the respective steps described above may be defined in the operational function definition information 188 and provided, together with the display data for displaying the display screen C in S411, from the album managing server 1.

The foregoing describes the configuration in which the display order determining section 31, which determines the display order of the history information, is provided to the album managing server 1. The configuration, however, is not limited to that described above. The display order determining section 31 may be provided to the television 2, and information on the display order determined by the display order determining section 31 may be transmitted, together with the display data request message 6, to the album managing server 1.

Further, the display order determining section 31 of the album managing server 1 may utilize the result of the determination by the status determining section 30 when determining the display order of the history information. If the status determining section 30 determines that the album requested cannot be displayed, the display order determining section 31 may determine the display order in a manner such that the album requested is displayed at a bottom of the album history screen, even if the album is with the priority display flag “yes” or if the album is recently browsed. This makes it possible to determine the display order in such a manner that the albums that are more likely to be selected by the user are displayed at a top. The albums that cannot be browsed are less likely to be selected by the user. Therefore, if the history information on the albums that can be browsed are more likely to be selected by the user is displayed at a top, the convenience and operability of the user consequently improve.

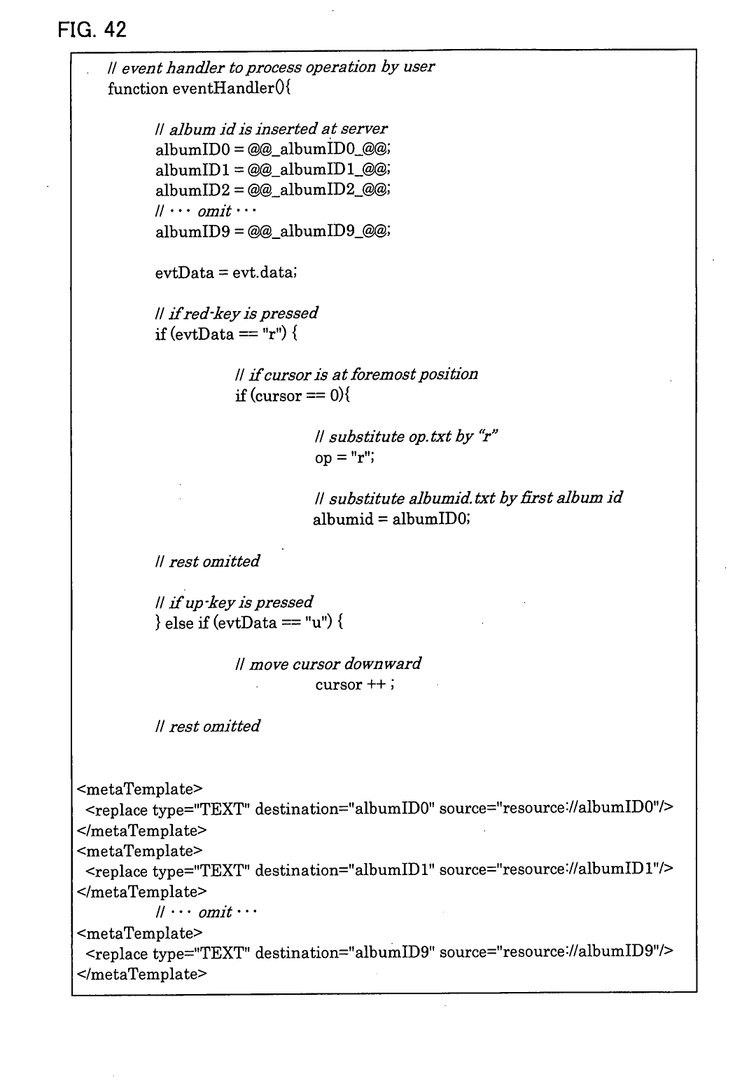

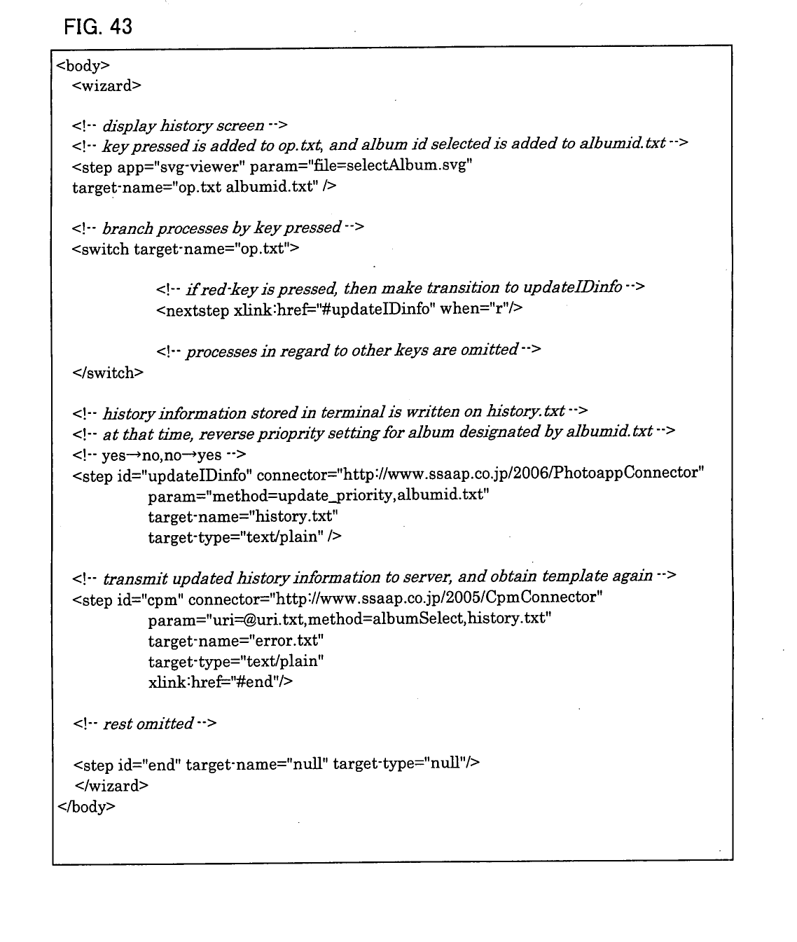

The operation of the television 2 as shown in FIG. 40 may be defined in the operational function definition information 188 included in the display data 7 for displaying the display screen A (album history screen) of FIG. 39(a) and then provided from the album managing server 1. For example, the operational function definition information 188 shown in FIGS. 42 and 43 may be provided together with the display data 7. FIG. 42 shows description indicating that, when the red button is pressed while the display screen A is displayed, the album ID of the album selected with the cursor is obtained. FIG. 43 shows definition of operation of re-obtaining the display screen A in the television 2 (FIG. 40).

### Embodiment 4

The foregoing embodiments describe the case in which the album ID to identify the album is only one type, a 16-digit album ID. The network album system 100 of the present invention, however, is not limited to the case. For example, the album managing server 1 can manage the albums with the use of plural types of album IDs differing in the number of digits.

The following describes, as an example, a network album system 100 managing the albums with the use of two types of album IDs differing in the number of digits. Concretely, the album managing server 1 manages an album given a 12-digit album ID and an album given a 16-digit album ID.

In the present embodiment, the television 2 displays the display screen B (album ID input screen) to provide the user with a user interface via which two types of album IDs, a 12-digit album ID and a 16-digit album ID, are input.

[Configuration of Television]

The configuration of the television 2 of the present embodiment differs from the television 2 shown in FIGS. 15 and 21 in that the control section 90 of the television 2 includes an ID input managing section 130 as a function block. The ID input managing section 130 manages the album ID input via the operational section 15 and the operation accepting section 61 while the album ID input screen is displayed. The album ID thus input is temporarily stored in the temporary storage section 110 via the operation accepting section 61.

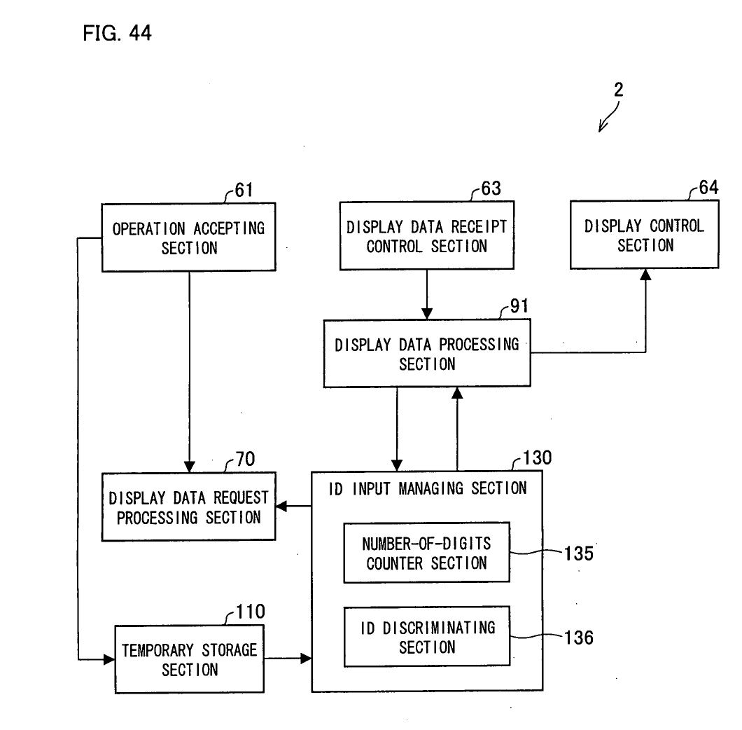

FIG. 44 is a block diagram showing a configuration of a main part of the television 2 in accordance with the present embodiment. As shown in FIG. 44, the ID input managing section 130 includes a number-of-digits counter section 135 and an ID discriminating section 136.

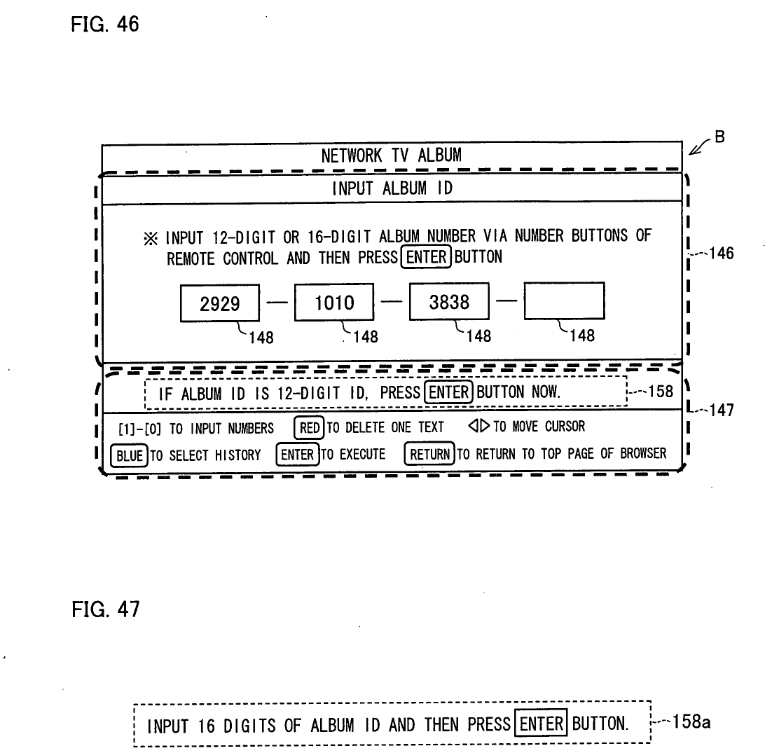

The number-of-digits counter section 135 counts the number of digits of the album ID input by the user via the album ID input screen. The user, for example, presses a ten-key provided to the operational section 15 to input the album ID into the television 2 via the album ID input screen shown in FIG. 46.

The number-of-digits counter section 135 counts the number of characters in a numerical string that is input by the user and stored in the temporary storage section 110, thereby detecting the number of digits currently input.

The ID discriminating section 136 processes, in accordance with a predetermined discrimination algorithm, the numerical string of the album ID stored in the temporary storage section 110, thereby discriminating the type of the album ID.

In the present embodiment, concretely, the discrimination algorithm is to discriminate the type of the album ID by dividing the numerical string that is input up to the 12^{th} digit and then determining whether or not the numerical string is dividable by 12. The ID discriminating section 136 divides the 12-digit numerical string stored in the temporary storage section 110. If the 12-digit numerical string is dividable by 12, the ID discriminating section 136 determines that the album ID is the 12-digit album ID. If the numerical string is not dividable by 12, then the ID discriminating section 136 determines that the album ID is the 16-digit album ID. In the present embodiment, only a numerical string that is not dividable by 12 is allocated in the first 12-digit numerical string of the 16-digit album ID.

In a manner responsive to the type of the album ID, which type is discriminated by the ID discriminating section 136, the display data request processing section 70 and the display data processing section 91 each carry out appropriate operation in accordance with the display control information.

[Processes in Television]

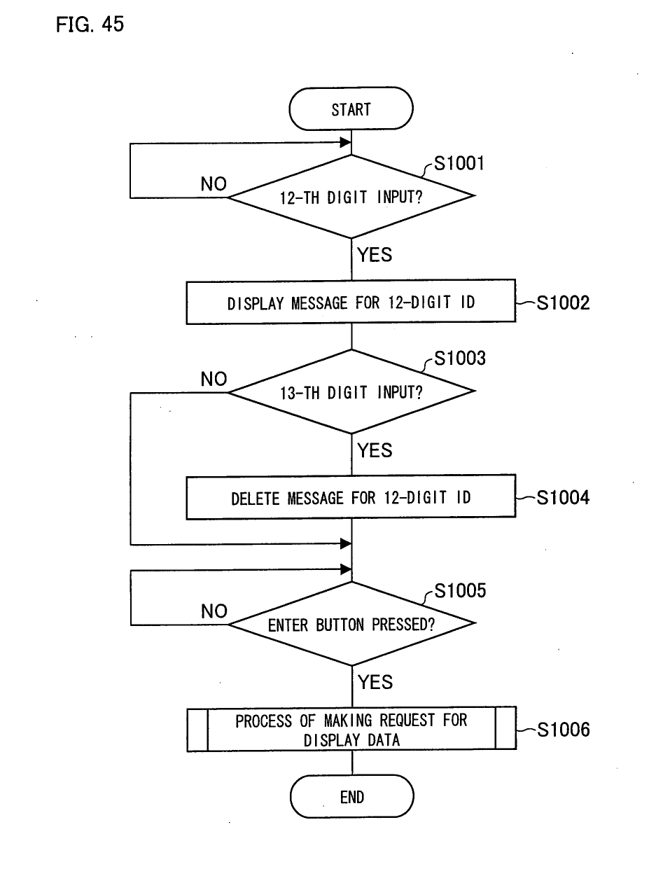

FIG. 45 is a flowchart showing a flow of processes to be performed by the television while the album ID input screen is displayed.

The number-of-digits counter section 135 monitors the temporary storage section 110 and carries out counting until the album ID is input up to the 12^{th} digit (S1001). If the number-of-digits counter section 135 detects that the album ID is input up to the 12^{th} digit (YES in S1001), then the ID input managing section 130 notifies the display data processing section 91 that the album ID is input up to the 12^{th} digit.

In response to this notification, the display data processing section 91 displays, in addition to the album ID input screen, a message that is to be displayed when the album ID is input up to the 12^{th} digit (S1002).

An exemplary message that is to be displayed at this time includes “if the album ID is a 12-digit ID, press the enter button now.” In this manner, it is preferable that the message contain information that lets the user determine the type of the album ID and guides the user which operation needs to be performed in a manner responsive to the type of the album ID determined.

Then, if the number-of-digits counter section 135 detects that the user further inputs a number and the 13^{th} digit is input (YES in S1003), the album ID being input is considered to be the 16-digit ID. Therefore, the display data processing section 91 deletes the message for the 12-digit album ID (S1004). At this time, a message for the 16-digit album ID may be displayed in place of the message deleted.

If the 12-digit album ID or the 16-digit album ID is entered (NO in S1003, or following S1004), and then if the enter button of the operational section 15 is pressed (YES in S1005), the display data request processing section 70 makes a request for the display data 7 for displaying the album of the album ID input (S1006). The details of the process of requesting the display data are already discussed above with reference to FIG. 20.

With the foregoing configuration and method, an appropriate message is displayed in a manner responsive to the number of input digits of the album ID.

FIG. 46 shows an exemplary display screen B (album ID input screen) to be displayed on the display section 17 of the television 2 in S1002. In a second area 147 to provide the user with the operational guidance of the television 2, a message 158 is displayed that is to be displayed at the time when the album ID is input up to the 12^{th}-digit.

Thus, if the user knows that the album ID the user is inputting is the 12-digit ID, the user finds out that the album of the album ID is obtainable by pressing the enter button at that state.

On the other hand, if the user is inputting the 16-digit album ID, the user simply needs to input the 13^{th} digit thereafter. At this time, the message 158 is deleted. Further, the display data processing section 91 may display a message 158a for the 16-digit ID in place of the message 158 if the 13^{th} digit is input, as shown in FIG. 47.

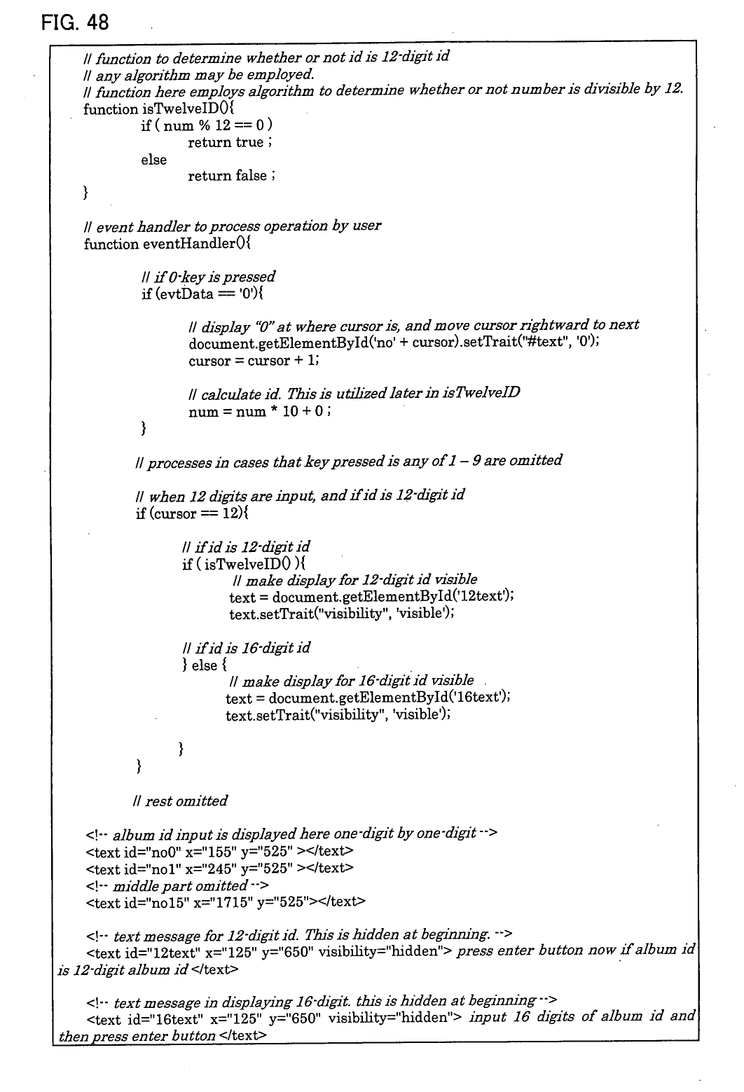

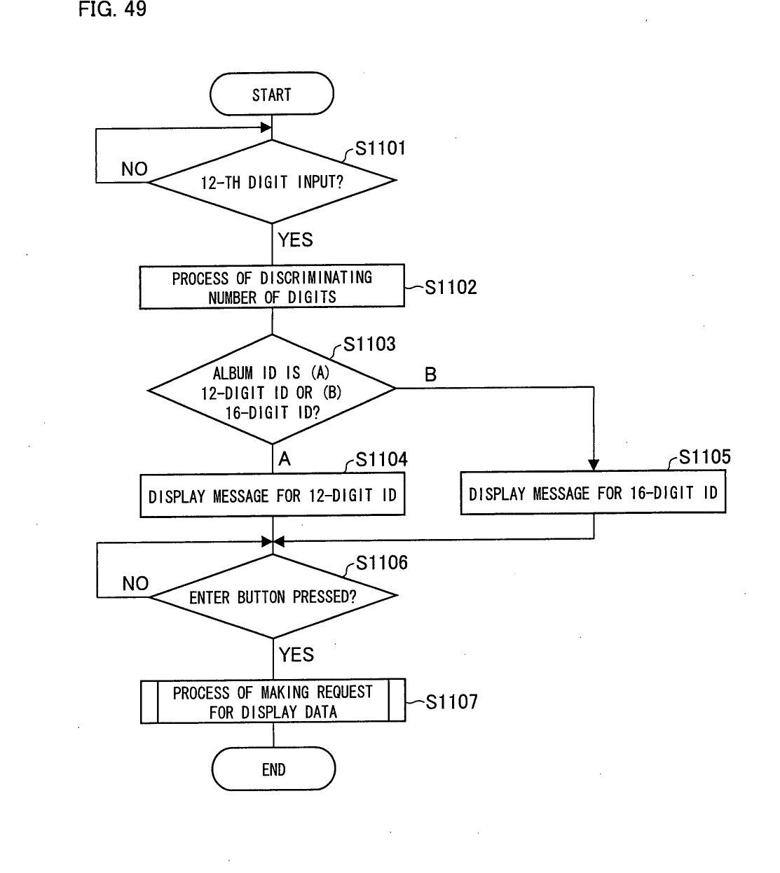

In the present embodiment, the respective sections of the television 2 may perform, in accordance with the display control information shown in FIG. 48, processes of discriminating the number of digits of the album ID, for example. The display control information shown in FIG. 48 is included in the display data 7 on the display screen B of FIG. 46 and provided by the album managing server 1.

The television 2 of the present invention may be configured in such a way as to discriminate the type of the album ID on the basis of the 12-digit numerical string already input and display an appropriate message responsive to the type discriminated.

FIG. 49 is a flowchart showing another exemplary processes to be performed by the television 2 while the album ID input screen is displayed.

If the number-of-digits counter section 135 (FIG. 44) detects that the album ID is input up to the 12^{th} digit, (YES in S1101), then the ID discriminating section 136 carries out, with the user of the 12-digit numerical string stored in the temporary storage section 110, the processes of discriminating the number of digits of the album ID (S1102). Algorithms for the processes of discriminating the number of digits are not particularly limited. For example, the numerical string is divided by 12, and then it is determined whether the remainder is 0 or the remainder is other than 0.

If the remainder is 0, then the ID discriminating section 136 determines that the numerical string dividable by 12 is the 12-digit album ID (A in S1103). Then, on the basis of this result of discrimination, the display data processing section 91 causes the message for the 12-digit ID to be displayed on the album ID input screen additionally (S1104).

An example of the message is “This is a 12-digit album ID. Press the enter button now.” It is preferable that the information clearly indicates the type of the album ID and provides the user with information on necessary operation at this time. As such, the user finds out that it is sufficient to input 12 digits, and at the same time, finds out operation the user needs to carry out next. Thus, the convenience of the user improves.

On the other hand, if the remainder is other than 0, then the ID discriminating section 136 determines that the numerical string that is not dividable by 12 is a part of the 16-digit album ID (B in S1103). Then, on the basis of this result of discrimination, the display data processing section 91 causes the message for the 16-digit ID to be displayed on the album ID input screen additionally (S1105). An example of the message is “This is a 16-digit album ID. Input 16 digits and then press the enter button.”

If the 12-digit album ID or the 16-digit album ID is input, and then if the enter button of the operational section 15 is pressed (YES in S1106), then the display data request processing section 70 makes a request for the display data 7 for displaying the album of the album ID input (S1107).

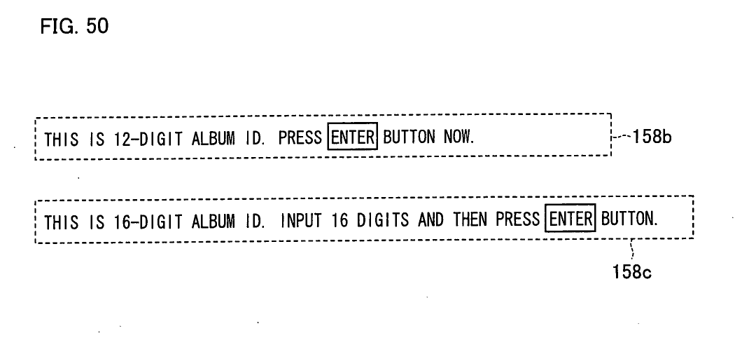

FIG. 50 shows an exemplary message displayed in S1104 or in S1105 in FIG. 49. For example in S1104, the display data processing section 91 may display the message 158b in place of the message 158 shown in FIG. 46. On the other hand, in S1105, the message 158c may be displayed.

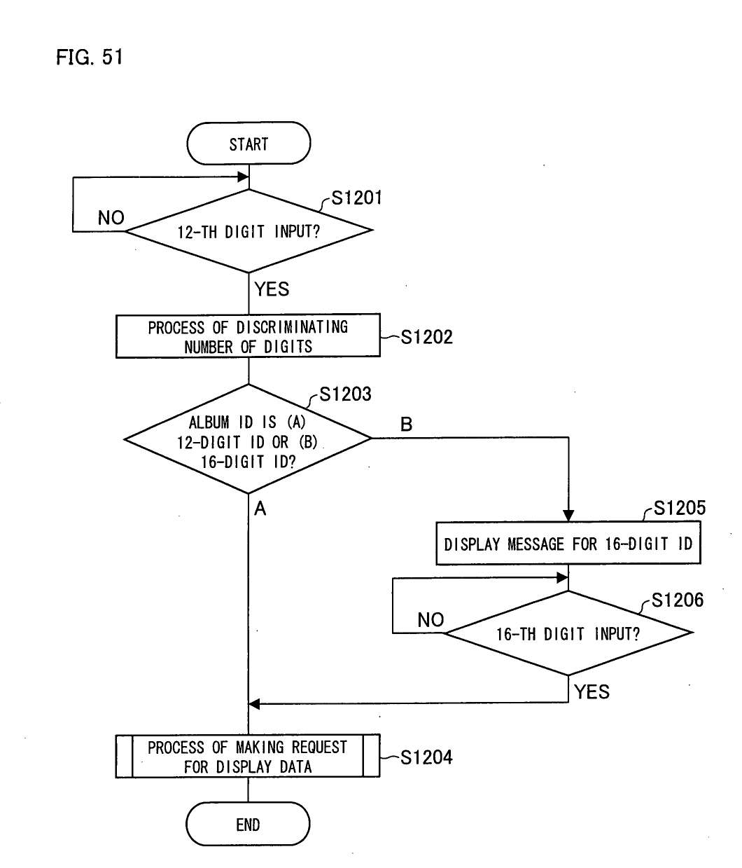

Alternatively, the television 2 of the present embodiment may be configured in such a manner that the display data request processing section 70 may request the display data immediately when the necessary number of digits is input after the type of the album ID is discriminated. FIG. 51 shows the flow of processes in the television 2 in this case.

The processes of discriminating the album ID in S1201 to S1203 are same as those shown in FIG. 49. Therefore, description of the processes is omitted.

If the 12-digit numerical string is discriminated as the 12-digit album ID stored in the temporary storage section 110 (A in S1203), then the display data request processing section 70 immediately generates and transmits the display data request message 6 requesting the album identified by the 12-digit album ID, without waiting for the enter button to be pressed (S1204).

On the other hand, if the numerical string is a part of the 16-digit album ID, then the display data processing section 91 causes the message for the 16-digit ID to be displayed on the album ID input screen additionally (S1205).

Then, if detecting that a numerical string up to the 16th digit is input into the storage section 110 (YES in S1206), then, in the same manner as described above, the display data request processing section 70 immediately generates and transmits the display data request message 6 requesting the album identified by the 16-digit album ID, without waiting for the enter button to be pressed.

With this method, in the television 2, the number of digits of the album ID the user is inputting is discriminated. Further, when the last digit of this discriminated number of digits is input, the flow automatically moves to the process of requesting the display data. This facilitates the user to obtain the display data to browse a target album without either recognizing how many digits the user has input and how many digits the user needs to input or carrying out an additional operation of pressing the enter button, even if there are plural types of album ID.

Accordingly, the user interface is provided in the case in which inputs of plural types of IDs having different numbers of digits are realized with the use of one user interface, which user interface facilitates the user to designate the album ID to browse the album without making the user recognize the difference in the number of digits.

The present invention is not limited to the description of the embodiments above, but may be altered by a skilled person within the scope of the claims. An embodiment based on a proper combination of technical means disclosed in different embodiments is encompassed in the technical scope of the present invention.

Lastly, the respective blocks of the album managing server 1 and the respective blocks of the television 2 may be configured with hardware logic, or with software using a CPU as described below, especially: the message analyzing section 20, the status determining section 30, and the display data generating section 40 of the album managing server 1; and the display data request processing section 70, the display data processing section 91, and the request/display processes control section 93 of the television 2).

Specifically, the album managing server 1 and the television 2 include: a CPU (central processing unit) for executing an instruction of a control program for realizing respective functions; a ROM (read only memory) for storing the program; a RAM (random access memory) for developing the program; and a storage medium, such as a memory, for storing the program and various data. The object of the present invention is also achieved by (i) supplying, to the album managing server 1 and the television 2, a computer-readable storage medium storing a program code (execute form program, intermediate code program, source program) of a control program for the album managing server 1 and the television 2, which are software for realizing the functions described above, and (ii) causing a computer (or CPU or MPU) to read out and carry out the program code stored in the storage medium.

Exemplary storage medium that may be used as the storage medium described above include: tapes such as a magnetic tape and a cassette tape; disks such as an magnetic disk (e.g., floppy (registered trademark) disk, hard disk) and an optical disk (e.g., CD-ROM, MO, MD, DVD, CD-R); cards such as an IC card (including memory card) and an optical card; and semiconductor memories such as a mask ROM, an EPROM, an EEPROM, and a flash ROM.

Further, it is also possible to make a position that the album managing server 1 and the television 2 are allowed to be connected to a communication network, and the program code is supplied via the communication network. The communication network is not particularly limited, and the followings may be used as the communication network, for example: the Internet, intranet, extranet, LAN, ISDN, VAN, CATV communication network, virtual private network, telephone line network, mobile communication network, and satellite communication network. Further, transmission medium that configure the communication network is not particularly limited. For example, a wire transmission medium, such as IEEE 1394, USB, power line, cable TV circuit, telephone line, ADSL circuit, and a wireless transmission medium, such as infrared ray (e.g., IrDA, remote-controller), Bluetooth (registered trademark), IEEE 802.11, HDR, mobile telephone network, satellite circuit, and terrestrial digital network. Note that the present invention may also be realized in the form of a computer data signal that is realized by electrical transmission of the program code and embedded in a carrier.

It is preferable in the above-described image data providing apparatus that: display target information on the display target data be associated with the identification information on the display target data and stored in the display-target information storage section; the status determining section 30 determine, basing on the display target information associated with the identification information on the display target data identified by the identification information obtained by the display target ID obtaining section 21, whether or not the display target data is available to be provided, and determines a detail of a status of the display target data if the display target data is not available to be provided; and the status information extracting section 42 generate, if the status determining section 30 determines that the display target data is not available to be provided, the status information indicating the detail of the status of the display target data that is not available to be provided.

With this configuration, the status determining section 30 determines, on the basis of the display target information on the display target data identified by the identification information, whether the display target data is available or not available. If the display target data is not available, then the status determining section 30 determines a detail of the status of the display target data. The display target information indicates information on the display target data. The display target information is associated with the identification information on the display target data and stored in the display-target information storage section.

If the status determining section 30 determines that the display target data is not available to be provided, then the status information extracting section 42 generates the status information indicating the detail of the status of the display target data that is not available to be provided.

Accordingly, when the display target data that is to be displayed on the image display apparatus is not available and cannot be provided to the image display apparatus, the status information that indicates this detail of the status and the display control information are generated.

This enables the image display apparatus to display, for the user to see, that the display target data to be displayed on the image display apparatus is not available and to display the detail of the status of the display target data.

This allows the user to know that the display target data to be displayed on the image display apparatus is not available. The user is also able to confirm the detail of the status to find out why the display target data is not provided, whereby the convenience of the users of the image display apparatus further improves.

Further, it is preferable that: the display target data be an album that is constituted of one image or plural images and is identifiable by the identification information; image presence/absence information, indicating presence or absence of an image in the album, be associated with the identification information and stored in the display-target information storage section as the display target information; and the status determining section 30 determine, if the image presence/absence information on the album identified by the identification information obtained by the display target ID obtaining section 21 indicates the album contains no image, that the album is not available to be provided.

With this configuration, the display target data to be displayed on the image display apparatus is the album that is constituted of one image or plural images. The status determining section 30 determines, on the basis of the image presence/absence information on the album identified by the identification information to identify the album, whether the album contains the image or not.

When the status determining section 30 determines that the album does not contain even one image, i.e. the album is not available, the status information extracting section 42 generates the status information that indicates this detail of the status of the display target data.

Accordingly, when the album to be displayed on the image display apparatus does not contain even one picture, the status information, indicating this status, and the display control information are generated.

This allows the image display apparatus to display, for the user of the image display apparatus to see, that the album to be displayed on the image display apparatus does not contain even one picture and therefore is not available to be provided.

Thus, the user is able to know that the album to be displayed on the image display apparatus is not available to be provided. The user is also able to fined out the detail of the status and find out that the album is not displayed because the album does not contain even one picture. This allows the user to take appropriate actions against the errors, so that the convenience of the users of the image display apparatus further improves.

The following are other possible details of the statuses, determined by the status determining section 30, in which the album is not provided.

(1) The album that is requested is not stored from the beginning. (2) The album ID of the album is stored, but contents of the album are not stored. Therefore, the album cannot be provided. (3) An expiration data on publication of the album that is requested is already expired. (4) The album that is requested has been set by an album creator in such a manner that the album is not in publication. (5) An error occurs in the picture in the album that is requested.

The details of the statuses in which the album is not provided are not limited to those discussed above, and there are various possible situations.

Alternatively, the display target data may be an image contained in an album, and the album and the image contained in the album each are identifiable by the identification information. Further, image information on the image may be associated with the identification information and stored in the display-target information storage section as the display target information. Further, the status determining section 30 may determine, basing on the image information on the image identified by the identification information obtained by the display target ID obtaining section 21, whether or not the image is available to be provided, and determines a detail of a status of the display target data if the display target data is not available to be provided.

With this configuration, the display target data to be displayed on the image display apparatus is the image contained in the album. Basing on the image information on the image identified by the identification information, which is to identify the image in the album, the status determining section 30 determines the status of the image (i.e. the status determining section 30 determines whether or not the image is available to be provided, and determines a detail of a status of the display target data if the display target data is not available to be provided).

When the status determining section 30 determines that the image is not available to be provided, the status information extracting section 42 generates the status information that indicates the detail of the status of the image.

Thus, when the image to be displayed on the image display apparatus is not available to be provided, the status information, which indicates the detail of the status, and the display control information are generated.

This allows the image display apparatus to display, for the user to see, that the image to be displayed on the image display apparatus is not available to be provided.

Thus, the user is able to know that the image to be displayed on the image display apparatus is not available to be provided. The user is also able to learn the detail of the status and find out why the image is not provided. Therefore, the convenience of the users of the image display apparatus further improves.

The following are concrete situations in the details of the statuses, determined by the status determining section 30, in which the image is not provided.

(1) Data of the image of the album that is requested has corrupted. (2) The image of the album that is requested exceeds an allowed size. (3) The image of the album that is requested is not in specified format. (4) The image of the album that is requested is protected under Copyrights. (5) The image of the album that is requested is given an age limitation, and the age of the user does not satisfy this condition.

The details of the statuses in which the image is not provided are not limited to those discussed above, and there are various possible situations.

It is preferable that the image data providing apparatus include, in addition to the foregoing configuration: a receiving section to receive, from the image display apparatus, the display-target request message that contains the identification information on the display target data requested by the image display apparatus; and a transmitting section to transmit, to the image display apparatus, the status information on the display target data requested by the image display apparatus and the display control information on the display target data requested by the image display apparatus, the status information being generated by the status information extracting section 42, and the display control information being generated by the display control information generating section 44.

This allows the image data providing apparatus to receive the request from the image display apparatus, and, in response to the request from the image display apparatus, transmit the status information on the display target data that is requested, and the display control information for the status information.

This allows the image display apparatus to display, for the user to see, the status of the display target data that the image display apparatus has requested.

Thus, the user is able to know the status of the display target data requested via the image display apparatus. Therefore, the convenience of the users of the image display apparatus further improves.

Thus, the user is able to know that the image to be displayed on the image display apparatus is not available to be provided.

Further, it is preferable in the above-described image display apparatus that the display target data be an album constituted of one image or plural images, and the message generating section 75 generate the display-target request message containing the identification information to identify the album.

This configuration allows the image display apparatus to request the image data providing apparatus to provide the album constituted of one or plural images. Further, the configuration allows the image display apparatus to obtain, from the image data providing apparatus, the status information indicating the status of the album that the image display apparatus has requested.

Alternatively, the display target data may be an image contained in the album, and the message generating section 75 may generate the display-target request message containing the identification information to identify (i) the album and (ii) the image contained in the album.

This configuration allows the image display apparatus to request the image data providing apparatus to provide the image contained in the album. Further, the configuration allows the image display apparatus to obtain, from the image data providing apparatus, the status information indicating the status of the image contained in the album that the image display apparatus has requested.

Further, the receiving section may receive, in response to the display-target request message, plural pieces of display data each containing: at least one of the display target data and the status information; and the display control information to define a position of at least one of the display target data and the status information. Further, the image display apparatus may further include a display data processing section 91 (display data processing means) for selecting, basing on a status of the image display apparatus, display data, among the plural pieces of display data received by the receiving section, that is to be processed by the display control section 64.

With this configuration, the receiving section receives, in response to one display-target request message, the display data generated by the image data providing apparatus. The display data is data for displaying on the image display apparatus. Concretely, the display data is a combination of the display target data, which is the display-target, and/or status information, and the display control information to define the display position of the display target data and the display position of the status information.

When the receiving section receives a plurality of display data in response to the display-target request message, the display data processing section selects, among the plurality of display data received, the display data to be displayed on the display section of the image display apparatus. The display data processing section selects the display data in a manner responsive to the status of the image display apparatus.

Accordingly, even when the receiving section receives a plurality of display data at one time, most suitable display data responsive to the status of the image display apparatus is selected and displayed. It is thus possible to control the display section in such a manner that a most suitable content is displayed in accordance with intentions of the users or the image data providing apparatus. Therefore, the convenience of the users further improves.

The following is an exemplary function to display a most suitable display data in a manner responsive to the status of the image display apparatus.

For example in a case in which display data for an album history screen A for the albums and display data for an album ID input screen B are transmitted at the same time, the display data processing section processes in such a manner that the album history screen A is displayed if history information is stored in the storage section in which album browse history of the image display apparatus is to be stored, while the album ID input screen B is displayed if there is no history information.

In the case in which there is no history information, displaying the album history screen A does not provide the users with useful information. On the other hand, in the case in which there is the history information, it is easier for the users to operate to select a desired album from the album history screen A than from the album ID input screen B.

In such cases, a most suitable display data is selected and displayed in a manner responsive to the status of the image display apparatus. Therefore, the convenience of the users of the image display apparatus further improves.

The following is another exemplary case.

For example in a case in which display data of a screen for the age under 12 years old and display data of a screen for the age of 12 or above are transmitted at the same time, the display data processing section executes the following processes. The display data processing section refers to the user information (information on the age of the user) that is set in advance to the image display apparatus and stored in the image display apparatus. Then, the display data processing section selects display data with contents that match the user information, and causes the display data to be displayed.

The foregoing allows the image display apparatus to select and display the display data with the contents that are most suitable for the users, in a manner responsive to the user information set to the image display apparatus. Therefore, the convenience of the users further improves.

In the above-described image display system, the status information and the display control information may be handled as separate pieces of data and transmitted from the image data providing apparatus to the image display apparatus individually. Alternatively, the status information and the display control information may be transmitted collectively at the same time. If the status information and the display control information are to be transmitted individually, the status information and the display control information are linked by providing identification information or the like. The status information may be filled in the display control information and then provided as one data from the image data providing apparatus to the image display apparatus.

The image data providing apparatus and the image display apparatus may be realized with a computer. In this case, the scope of the present invention includes: a program to control the image data providing apparatus to cause a computer to operate as the respective sections the computer to realize the image data providing apparatus and the image display apparatus; a program to control the image display apparatus; and a computer-readable recording medium in which the programs are stored.

An image data providing apparatus of the present invention provides an image display apparatus with status information that indicates a status of an image requested (especially a status in relation to obtainability). Therefore, the image data providing apparatus is applicable to an image display system in which the image data providing apparatus provides an image responsive to a request from the image display apparatus.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An image data providing apparatus, comprising:
identification information obtaining means for obtaining, from a display-target request message, identification information on display target data requested, the display-target request message requesting the display target data that is to be displayed on an image display apparatus;
status determining means for determining a status of the display target data that is stored in a display-target information storage section and identified by the identification information obtained by the identification information obtaining means;
status information generating means for generating status information for displaying, on the image display apparatus, the status of the display target data, which status is determined by the status determining means; and
display control information generating means for generating display control information to define a position, on the image display apparatus, of the status information generated by the status information generating means.

2. The image data providing apparatus of claim 1, wherein:
display target information on the display target data is associated with the identification information on the display target data and stored in the display-target information storage section;
the status determining means determines, basing on the display target information associated with the identification information on the display target data identified by the identification information obtained by the identification information obtaining means, whether or not the display target data is available to be provided, and determines a detail of a status of the display target data if the display target data is not available to be provided; and
the status information generating means generates, if the status determining means determines that the display target data is not available to be provided, the status information indicating the detail of the status of the display target data that is not available to be provided.

3. The image data providing apparatus of claim 2, wherein:
the display target data is an album that is constituted of one image or plural images and is identifiable by the identification information;
image presence/absence information, indicating presence or absence of an image in the album, is associated with the identification information and stored in the display-target information storage section as the display target information; and
the status determining means determines, if the image presence/absence information on the album identified by the identification information obtained by the identification information obtaining means indicates the album contains no image, that the album is not available to be provided.

4. The image data providing apparatus of claim 2, wherein:
the display target data is an image contained in an album, and the album and the image contained in the album each are identifiable by the identification information;
image information on the image is associated with the identification information and stored in the display-target information storage section as the display target information; and
the status determining means determines, basing on the image information on the image identified by the identification information obtained by the identification information obtaining means, whether or not the image is available to be provided, and determines a detail of a status of the image if the image is not available to be provided.

5. The image data providing apparatus of claim 1, comprising:
a receiving section to receive, from the image display apparatus, the display-target request message that contains the identification information on the display target data requested by the image display apparatus; and
a transmitting section to transmit, to the image display apparatus, the status information on the display target data requested by the image display apparatus and the display control information on the display target data requested by the image display apparatus, the status information being generated by the status information generating means, and the display control information being generated by the display control information generating means.

6. An image display apparatus, comprising:
message generating means for generating a display-target request message that requests display target data and contains identification information on the display target data that is to be displayed on the image display apparatus;
a transmitting section to transmit the display-target request message to an image data providing apparatus;
a receiving section to receive, from the image data providing apparatus in response to the display-target request message,: status information for displaying, on the image display apparatus, a status of the display target data; and display control information to define a position, on the image display apparatus, of the status information; and
display control means for controlling a display section so that the display section displays the status information in accordance with the display control information.

7. The image display apparatus of claim 6, wherein:
the display target data is an album constituted of one image or plural images; and
the message generating means generates the display-target request message containing the identification information to identify the album.

8. The image display apparatus of claim 7, wherein:
the display target data is an image contained in the album; and
the message generating means generates the display-target request message containing the identification information to identify (i) the album and (ii) the image contained in the album.

9. The image display apparatus of claim 6, wherein:
the receiving section receives, in response to the display-target request message, plural pieces of display data each containing: at least one of the display target data and the status information; and the display control information to define a position of at least one of the display target data and the status information; and
the image display apparatus further comprises display data processing means for selecting, basing on a status of the image display apparatus, display data, among the plural pieces of display data received by the receiving section, that is to be processed by the display control means.

10. An image display system, comprising:
(a) the image data providing apparatus, including:
identification information obtaining means for obtaining, from a display-target request message, identification information on display target data requested, the display-target request message requesting the display target data that is to be displayed on an image display apparatus;
status determining means for determining a status of the display target data that is stored in a display-target information storage section and identified by the identification information obtained by the identification information obtaining means;
status information generating means for generating status information for displaying, on the image display apparatus, the status of the display target data, which status is determined by the status determining means; and
display control information generating means for generating display control information to define a position, on the image display apparatus, of the status information generated by the status information generating means; and
(b) the image display apparatus, including:
message generating means for generating a display-target request message that requests display target data and contains identification information on the display target data that is to be displayed on the image display apparatus;
a transmitting section to transmit the display-target request message to an image data providing apparatus;
a receiving section to receive, from the image data providing apparatus in response to the display-target request message,: status information for displaying, on the image display apparatus, a status of the display target data; and display control information to define a position, on the image display apparatus, of the status information; and
display control means for controlling a display section so that the display section displays the status information in accordance with the display control information.

11. A method for controlling an image data providing apparatus, the method comprising:
a first step of obtaining, from a display-target request message, identification information on display target data requested, the display-target request message requesting the display target data that is to be displayed on an image display apparatus;
a second step of determining a status of the display target data identified by the identification information obtained in the first step;
a third step of generating status information for displaying, on the image display apparatus, the status of the display target data, which status is determined in the second step; and
a fourth step of generating display control information to define a position, on the image display apparatus, of the status information generated in the third step.

12. A method for controlling an image display apparatus, the method comprising:
a first step of generating a display-target request message that requests display target data and contains identification information on the display target data that is to be displayed on the image display apparatus;
a second step of transmitting, to an image data providing apparatus, the display target request message generated in the first step;
a third step of receiving, from the image data providing apparatus in response to the display-target request message,: status information for displaying, on the image display apparatus, a status of the display target data; and display control information to define a position, on the image display apparatus, of the status information; and
a fourth step of controlling a display section so that the display section displays the status information in accordance with the display control information.

13. A control program of an image data providing apparatus, the control program causing a computer to execute:
a first step of obtaining, from a display-target request message, identification information on display target data requested, the display-target request message requesting the display target data that is to be displayed on an image display apparatus;
a second step of determining a status of the display target data identified by the identification information obtained in the first step;
a third step of generating status information for displaying, on the image display apparatus, the status of the display target data, which status is determined in the second step; and
a fourth step of generating display control information to define a position, on the image display apparatus, of the status information generated in the third step.

14. A control program of an image display apparatus, the control program causing a computer to execute:
a first step of generating a display-target request message that requests display target data and contains identification information on the display target data that is to be displayed on the image display apparatus;
a second step of transmitting, to an image data providing apparatus, the display-target request message generated in the first step;
a third step of receiving, from the image data providing apparatus in response to the display-target request message,: status information for displaying, on the image display apparatus, a status of the display target data; and display control information to define a position, on the image display apparatus, of the status information; and
a fourth step of controlling a display section so that the display section displays the status information in accordance with the display control information.

15. A computer-readable recording medium, storing a control program of an image data providing apparatus, the control program causing a computer to execute:
a first step of obtaining, from a display-target request message, identification information on display target data requested, the display-target request message requesting the display target data that is to be displayed on an image display apparatus;
a second step of determining a status of the display target data identified by the identification information obtained in the first step;
a third step of generating status information for displaying, on the image display apparatus, the status of the display target data, which status is determined in the second step; and
a fourth step of generating display control information to define a position, on the image display apparatus, of the status information generated in the third step.

16. A computer-readable recording medium, storing a control program of an image display apparatus, the control program causing a computer to execute:
a first step of generating a display-target request message that requests display target data and contains identification information on the display target data that is to be displayed on the image display apparatus;
a second step of transmitting, to an image data providing apparatus, the display-target request message generated in the first step;
a third step of receiving, from the image data providing apparatus in response to the display-target request message,: status information for displaying, on the image display apparatus, a status of the display target data; and display control information to define a position, on the image display apparatus, of the status information; and
a fourth step of controlling a display section so that the display section displays the status information in accordance with the display control information.
